(19) United States
(12) Patent Application Publication
(10) Pub. No.: US 2025/0383564 A1
(43) Pub. Date: Dec. 18, 2025

(54) WAVELENGTH SELECTIVE PHASE DIFFERENCE PLATE AND OPTICAL ELEMENT

(71) Applicant: FUJIFILM Corporation, Tokyo (JP)

(72) Inventor: Hiroshi SATO, Minamiashigara-shi (JP)

(73) Assignee: FUJIFILM Corporation, Tokyo (JP)

(21) Appl. No.: 19/317,181

(22) Filed: Sep. 3, 2025

Related U.S. Application Data
(63) Continuation of application No. PCT/JP2024/011895, filed on Mar. 26, 2024.

(30) Foreign Application Priority Data
Mar. 30, 2023 (JP) 2023-055272

(51) Int. Cl. G02F 1/13363; G02B 27/01; G02F 1/139

(52) U.S. Cl. CPC G02F 1/133637; G02F 1/1398; G02B 27/0172; G02B 2027/0178

(57) ABSTRACT

An object of the present invention is to provide a wavelength selective phase difference plate in which a difference between a phase difference generated in a case where light is incident from a front direction and a phase difference generated in a case where light is incident from an oblique direction is small. The wavelength selective phase difference plate of the present invention includes a plurality of wavelength plates, in which the wavelength selective phase difference plate changes a phase of polarized light in a first wavelength range and does not change a phase of polarized light in a second wavelength range which is different from the first wavelength range, slow axis orientations of the plurality of wavelength plates are different from each other, and Nz factors of the plurality of wavelength plates are each more than 0.3 and less than 0.7.

### CROSS-REFERENCE TO RELATED APPLICATIONS

This application is a Continuation of PCT International Application No. PCT/JP2024/011895 filed on Mar. 26, 2024, which claims priority under 35 U.S.C. § 119(a) to Japanese Patent Application No. 2023-055272 filed on Mar. 30, 2023. The above applications are hereby expressly incorporated by reference, in their entirety, into the present application.

### BACKGROUND OF THE INVENTION

### 1. Field of the Invention

The present invention relates to a wavelength selective phase difference plate and an optical element.

### 2. Description of the Related Art

An optical element which controls a direction of light has been used in various optical devices and optical systems.

For example, an optical element which controls a direction of light has been used in various optical devices such as a head mounted display (HMD) including augmented reality (AR) glasses, virtual reality (VR) glasses, mixed reality (MR) glasses, or the like, which display a virtual image, various information, or the like in a superimposed manner on a scene actually being seen, a head up display (HUD), a backlight of a liquid crystal display device, a projector, beam steering, and a sensor for performing detection of a thing and measurement of a distance to the thing.

In the VR glasses, for example, a virtual image is visually recognized by a user by condensing light emitted from a display (optical engine) at a position of the eyes of the user by a magnifying optical system using a lens.

It has been known that a diffraction element (including a hologram) is used as the magnifying optical system using a lens in the VR glasses, and light emitted from the display can be diffracted by the diffraction element to be condensed toward the eyes of the user (WO2021/150510A and WO2022/045167A).

In addition, in the AR glasses, for example, an image displayed by a display (optical engine) is incident into one end of a light guide plate, propagates in the light guide plate, and is emitted from the other end of the light guide plate such that a virtual image is displayed to be superimposed on a scene that a user actually sees.

In the AR glasses, light (projection light) projected from the display is diffracted (refracted) using a diffraction element to be incident into one end part of the light guide plate. As a result, light is introduced into the light guide plate at an angle such that the light propagates in the light guide plate. The light propagated in the light guide plate is also diffracted by the diffraction element in the other end part of the light guide plate, and is emitted from the light guide plate to an observation position of the user.

Here, the diffraction angle of light by the diffraction element changes depending on a wavelength of the light. That is, a traveling direction of the light diffracted by the diffraction element varies depending on the wavelength of the light.

Therefore, in a case where light having different wavelengths is diffracted by one diffraction element, for example, in a case of a color image consisting of a red image, a green image, and a blue image, so-called color shift occurs in which positions of the red image, the green image, and the blue image are different.

In order to eliminate the color shift, for example, it is considered to use a wavelength selective phase difference plate as disclosed in G. D. Sharp, J. R. Birge, Retarder stack Technology for Color Manipulation, SID 1999 DIGEST, pp. 1072 to 1075 so as to adjust a traveling direction of light depending on the wavelength. In G. D. Sharp, J. R. Birge, Retarder stack Technology for Color Manipulation, SID 1999 DIGEST, pp. 1072 to 1075, it is shown that a λ plate and a 2λ plate are laminated such that slow axes thereof have a specific angle, and thus the film functions as the wavelength selective phase difference plate. In addition, in G. D. Sharp, J. R. Birge, Retarder stack Technology for Color Manipulation, SID 1999 DIGEST, pp. 1072 to 1075, it is disclosed that the wavelength selective phase difference plate is used in a wavelength selective beam splitter or a beam combiner.

### SUMMARY OF THE INVENTION

In recent years, further miniaturization and thinning have been required for VR glasses and AR glasses. In order to further reduce the size and thickness, an optical path design may be performed such that light is incident from a direction (oblique direction) inclined from a front direction of a diffraction element and is diffracted. In such an optical path design, light incident on the diffraction element from the front direction and light incident on the diffraction element from an oblique direction need to be diffracted in a desired direction. In addition, in order to further reduce the size and thickness, a region where a diffraction angle of light in the diffraction element is large may be provided. In such an optical path design, since diffracted light travels in an oblique direction inside the diffraction element, in a case where the above-described wavelength selective phase difference plate is used, light is incident from the oblique direction of the wavelength selective phase difference plate.

As a result of studying the wavelength selective phase difference plate disclosed in G. D. Sharp, J. R. Birge, Retarder stack Technology for Color Manipulation, SID 1999 DIGEST, pp. 1072 to 1075, the present inventors have found that a difference between a phase difference generated in a case where light is incident from the front direction and a phase difference generated in a case where light is incident from an oblique direction is large. In a case where the above-described difference between the phase difference is large, the desired diffraction direction may not be obtained in a case where the wavelength selective phase difference plate is used in combination with the diffraction element. Therefore, it is required to reduce the above-described difference between the phase difference.

Therefore, an object of the present invention is to provide a wavelength selective phase difference plate in which a difference between a phase difference generated in a case where light is incident from a front direction and a phase difference generated in a case where light is incident from an oblique direction is small.

Another object of the present invention is to provide an optical element using the above-described wavelength selective phase difference plate.

The present inventors have completed the present invention as a result of intensive studies to solve the above-described problems. That is, the present inventors have found that the above-described objects can be achieved by the following configuration.
[1] A wavelength selective phase difference plate comprising:
a plurality of wavelength plates,
in which the wavelength selective phase difference plate changes a phase of polarized light in a first wavelength range and does not change a phase of polarized light in a second wavelength range which is different from the first wavelength range,
slow axis orientations of the plurality of wavelength plates are different from each other, and
Nz factors of the plurality of wavelength plates are each more than 0.3 and less than 0.7.
[2] The wavelength selective phase difference plate according to [1],
in which each of the plurality of wavelength plates includes at least an optically anisotropic layer A having an Nz factor of more than 0.5 and an optically anisotropic layer B having an Nz factor of less than 0.5, and
an angle formed between a slow axis of the optically anisotropic layer A in an in-plane direction and a slow axis of the optically anisotropic layer B in an in-plane direction is 45° or less.
[3] The wavelength selective phase difference plate according to [2],
in which the optically anisotropic layer A is formed of a composition containing a rod-like liquid crystal compound, and
the optically anisotropic layer B is formed of a composition containing a disk-like liquid crystal compound.
[4] The wavelength selective phase difference plate according to [2] or [3],
in which at least one of the optically anisotropic layer A or the optically anisotropic layer B is a layer formed by fixing an alignment direction of a liquid crystal compound twist-aligned.
[5] An optical element comprising:
a plurality of optically anisotropic layers which are formed of a composition containing a liquid crystal compound and have a liquid crystal alignment pattern in which an orientation of an optical axis derived from the liquid crystal compound changes while continuously rotating in at least one in-plane direction; and
the wavelength selective phase difference plate according to any one of [1] to [4], which is disposed between at least one pair of the plurality of optically anisotropic layers,
in which rotation directions of orientations of optical axes in the two adjacent optically anisotropic layers are opposite to each other,
the first wavelength region includes a wavelength longer than a wavelength in the second wavelength range,
the wavelength selective phase difference plate converts circularly polarized light in the first wavelength range into circularly polarized light having an opposite turning direction and does not change a phase of circularly polarized light in the second wavelength range, and
in a case where a length over which the orientation of the optical axis rotates by 180° in the one direction in which the orientation of the optical axis changes while continuously rotating in the liquid crystal alignment pattern is set as a single period, at least one of the optically anisotropic layers has a length of the single period different from lengths of the single periods of the other optically anisotropic layers.

According to the present invention, it is possible to provide a wavelength selective phase difference plate in which a difference between a phase difference generated in a case where light is incident from a front direction and a phase difference generated in a case where light is incident from an oblique direction is small. In addition, the present invention can also provide an optical element using the wavelength selective phase difference plate.

### BRIEF DESCRIPTION OF THE DRAWINGS

FIG. 1 is a schematic view of a wavelength selective phase difference plate according to the embodiment of the present invention.

FIG. 2 is a view showing a relationship between slow axis orientations of wavelength plates in the wavelength selective phase difference plate according to the embodiment of the present invention.

FIG. 3 is a view conceptually showing an example of the optical element according to the embodiment of the present invention.

FIG. 4 is a view conceptually showing an optically anisotropic layer of the optical element shown in FIG. 3.

FIG. 5 is a plan view showing the optically anisotropic layer of the optical element shown in FIG. 3.

FIG. 6 is a conceptual diagram showing the action of the optically anisotropic layer of the optical element shown in FIG. 3.

FIG. 7 is a conceptual diagram showing the action of the optically anisotropic layer of the optical element shown in FIG. 3.

FIG. 8 is a conceptual diagram showing an action of the optical element shown in FIG. 3.

FIG. 9 is a conceptual diagram showing an action of the optical element shown in FIG. 3.

FIG. 10 is a view conceptually showing another example of the optical element according to the embodiment of the present invention.

FIG. 11 is a conceptual diagram showing an action of the optical element shown in FIG. 10.

FIG. 12 is a conceptual diagram showing an action of the optical element shown in FIG. 10.

FIG. 13 is a view conceptually showing an example of an exposure device which exposes an alignment film of the optical element shown in FIG. 3.

FIG. 14 is a plan view showing another example of the optically anisotropic layer of the optical element according to the embodiment of the present invention.

FIG. 15 is a view conceptually showing an example of an exposure device which exposes an alignment film forming the optically anisotropic layer shown in FIG. 14.

FIG. 16 is a view conceptually showing an example of AR glasses using an example of a light guide element according to the present invention.

FIG. 17 is a view conceptually showing another example of an optically anisotropic layer of the optical element according to the embodiment of the present invention.

### DESCRIPTION OF THE PREFERRED EMBODIMENTS

Hereinafter, the present invention will be described in detail.

The description of the configuration requirements described below is made on the basis of representative embodiments of the present invention, but it should not be construed that the present invention is limited to those embodiments.

Hereinafter, meaning of each description in the present specification will be explained.

In the present specification, a numerical range represented by “to” means a range including numerical values before and after “to” as a lower limit value and an upper limit value.

In the present specification, “same” includes an error range generally accepted in the technical field. In addition, in the present specification, the meaning of “all”, “entire”, or “entire surface” includes not only 100% but also a case in which an error range is generally allowable in the technical field, for example, 99% or more, 95% or more, or 90% or more.

In the present specification, visible light is light having a wavelength which can be seen by human eyes among electromagnetic waves, and refers to light in a wavelength range of 380 to 780 nm. Non-visible light refers to light in a wavelength range of less than 380 nm or more than 780 nm.

In addition, among the visible light, although not limited thereto, light in a wavelength range of 420 to 490 nm is blue light, light in a wavelength range of 495 to 570 nm is green light, and light in a wavelength range of 620 to 750 nm is red light.

In the present specification, Re(λ) represents an in-plane retardation at a wavelength λ. Unless otherwise specified, the wavelength λ is 550 nm.

In the present specification, Re(λ) is a value measured at the wavelength λ using AxoScan (manufactured by Axometrics, Inc.). By inputting an average refractive index ((nx+ny+nz)/3) and a film thickness (d (μm)) in AxoScan, a slow axis direction (°), Re(λ)=R0(λ), and Rth(λ)=((nx+ny)/2−nz)×d are calculated.

Although R0(λ) is described as a numerical value calculated by AxoScan, it means Re(λ). In addition, nx represents a refractive index in an in-plane slow axis direction, ny represents a refractive index in a direction orthogonal to the in-plane slow axis in a plane, and nz represents a refractive index in a thickness direction.

In addition, in the present specification, an Nz factor is a value represented by Nz=(nx−nz)/(nx−ny) using the refractive index nx in an in-plane slow axis direction, the refractive index ny in a direction orthogonal to the in-plane slow axis, and the refractive index nz in a thickness direction, which are measured by AxoScan.

### Wavelength Selective Phase Difference Plate

The wavelength selective phase difference plate according to the embodiment of the present invention includes a plurality of wavelength plates.

Slow axis orientations of the plurality of wavelength plates are different from each other, and Nz factors of the plurality of wavelength plates are each more than 0.3 and less than 0.7.

The wavelength selective phase difference plate according to the embodiment of the present invention changes a phase of polarized light in a first wavelength range and does not change a phase of polarized light in a second wavelength range which is different from the first wavelength range. Hereinafter, this principle will be described.

In a substance used for a wavelength plate, a refractive index usually changes depending on a wavelength. Therefore, since a phase difference provided by the wavelength plate is obtained by a product of a difference in refractive index and a thickness of the wavelength plate, in the wavelength plate, a difference occurs in the phase difference provided for light of each wavelength depending on a wavelength of the incident light. That is, in a case where polarized light (white light) having a specific phase is incident on the wavelength plate, it is understood that the wavelength plate can be used as an optical component which changes polarized light of the white light into a polarization state having a different phase depending on the wavelength. In this case, using the wavelength plate as an optical component (tap), in a case where a plurality of wavelength plates are laminated such that slow axis orientations are different from each other, the laminate of the wavelength plates can function as a finite impulse response filter. That is, the laminate of the wavelength plates can function as a wavelength selective phase difference plate which changes the phase of polarized light in a specific wavelength range and does not change a phase of polarized light in the other wavelength ranges, in a case where polarized light (white light) having a specific phase is incident on the laminate of the wavelength plates.

It can be understood by those skilled in the art that the finite impulse response filter can function as a filter which exhibits a desired response in a case where response characteristics (optical characteristics) of the taps (optical components) are adjusted and combined. Details of the above-described principle are also disclosed in G. D. Sharp, J. R. Birge, Retarder stack Technology for Color Manipulation, SID 1999 DIGEST, pp. 1072 to 1075. Specific examples and modification examples of the wavelength selective phase difference plate will be described in detail later.

In addition, the mechanism of the wavelength selective phase difference plate according to the embodiment of the present invention, that reduces the difference between the phase difference generated in a case where light is incident from a front direction and the phase difference generated in a case where light is incident from an oblique direction, is not necessarily clear, but the present inventor supposes as follows.

In a case where light is incident from a direction (front direction) perpendicular to a surface of the wavelength plate, the incident light causes a phase difference due to a difference in refractive index in an in-plane direction. On the other hand, in a case where light is incident from a direction (oblique direction) inclined with respect to the direction perpendicular to the surface of the wavelength plate, the difference in refractive index in the in-plane direction may change depending on an azimuthal angle of the incident light.

Here, the Nz factors of the plurality of wavelength plates used in the wavelength selective phase difference plate according to the embodiment of the present invention are each more than 0.3 and less than 0.7. In a case where the Nz factors of the wavelength plates are within the above-described range, it is possible to compensate for a change in the difference in refractive index in the in-plane direction even with the light incident from the oblique direction and to provide the same difference in refractive index as in the case where light is incident from the front direction.

As a result, it is considered that the difference between the phase difference generated in a case where light is incident from the front direction and the phase difference generated in a case where light is incident from the oblique direction is small.

An example of the wavelength selective phase difference plate according to the embodiment of the present invention will be described with reference to the drawings.

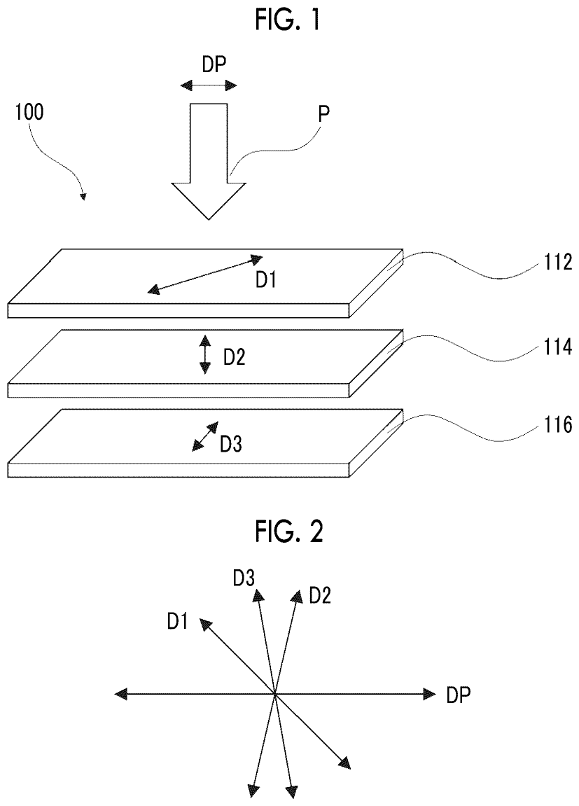

FIG. 1 is a schematic view showing a wavelength selective phase difference plate 100 which is an example of the wavelength selective phase difference plate according to the embodiment of the present invention. The wavelength selective phase difference plate 100 includes a first wavelength plate 112, a second wavelength plate 114, and a third wavelength plate 116 in this order. An in-plane slow axis direction of the first wavelength plate 112 is referred to as a first in-plane slow axis direction D1, an in-plane slow axis direction of the second wavelength plate 114 is referred to as a second in-plane slow axis direction D2, and an in-plane slow axis direction of the third wavelength plate 116 is referred to as a third in-plane slow axis direction D3.

Here, Re(725) of the first wavelength plate 112 at a wavelength of 725 nm is 725 nm, Re(725) of the second wavelength plate 114 at a wavelength of 725 nm is 1,450 nm, and Re(725) of the third wavelength plate 116 at a wavelength of 725 nm is 1,450 nm. In addition, Nz factors of the first wavelength plate 112, the second wavelength plate 114, and the third wavelength plate 116 are each 0.5 at a wavelength of 550 nm. The first wavelength plate 112, the second wavelength plate 114, and the third wavelength plate 116 are each formed of a material having normal dispersion, in which Re(450)/Re(550) is 1.09.

For a linearly polarized light P incident from the first wavelength plate 112 side, the wavelength selective phase difference plate 100 changes a phase of polarized light in a first wavelength range and does not change a phase of polarized light in a second wavelength range which is different from the first wavelength range. A vibration direction DP of the incident linearly polarized light P is a left-right direction of the paper plane.

FIG. 2 shows an orientation relationship between the first in-plane slow axis direction D1, the second in-plane slow axis direction D2, the third in-plane slow axis direction D3, and the vibration direction DP in a case where the wavelength selective phase difference plate 100 is viewed from the third wavelength plate 116 side. The first in-plane slow axis direction D1 is rotated clockwise by 45° with respect to the vibration direction DP. The second in-plane slow axis direction D2 is rotated counterclockwise by 77° with respect to the vibration direction DP. The third in-plane slow axis direction D3 is rotated clockwise by 80° with respect to the vibration direction DP.

By laminating the wavelength plates formed of the above-described materials having the optical characteristics such that the above-described orientation relationship is obtained, a wavelength selective phase difference plate which changes a phase of polarized light in a first wavelength range (a wavelength range of green light in the example shown in the drawing) and does not change a phase of polarized light in a second wavelength range (wavelength ranges of red light and blue light in the example shown in the drawing) different from the first wavelength range can be achieved for the linearly polarized light P incident from the first wavelength plate 112 side by the above-described principle.

In addition, since the Nz factors of the first wavelength plate 112, the second wavelength plate 114, and the third wavelength plate 116 are each 0.5, the change in the phase difference of the light incident from the oblique direction can be compensated. As a result, it is considered that, by the above-described principle, the difference between the phase difference generated in a case where light is incident from the front direction and the phase difference generated in a case where light is incident from the oblique direction is small.

The wavelength selective phase difference plate 100 shown in FIG. 1 is an example of the wavelength selective phase difference plate according to the embodiment of the present invention, and the wavelength selective phase difference plate according to the embodiment of the present invention may have an aspect shown in the following description.

Hereinafter, characteristics of the wavelength selective phase difference plate according to the embodiment of the present invention and a configuration used in the wavelength selective phase difference plate according to the embodiment of the present invention will be described.

### <First Wavelength Range and Second Wavelength Range>

The wavelength selective phase difference plate according to the embodiment of the present invention changes the phase of polarized light in the first wavelength range and does not change the phase of polarized light in the second wavelength range which is different from the first wavelength range.

The first wavelength range in which the phase of polarized light is changed can be appropriately adjusted depending on the application of the wavelength selective phase difference plate. Among these, it is preferable that at least a part of the first wavelength range is included in a visible light range (380 to 780 nm). The first wavelength range can be adjusted depending on the optical characteristics of the wavelength plate used, which will be described later.

In addition, the phase difference of polarized light to be changed in the first wavelength range can be appropriately adjusted depending on the application of the wavelength selective phase difference plate. Among these, the phase difference of polarized light to be changed in the first wavelength range is preferably λ/2. That is, in a case where incident light is linearly polarized light, it is preferable that the first wavelength range converts the incident light into linearly polarized light in a direction orthogonal to a polarization direction of the incident linearly polarized light, and the second wavelength range does not convert the polarization direction of the incident linearly polarized light.

In the present specification, the first wavelength range and the second wavelength range are defined as follows.

A method of determining the first wavelength range and the second wavelength range in a case where the phase difference of polarized light to be changed in the first wavelength range is λ/2 is described below.

A laminate in which one set of linearly polarizing plates is disposed in crossed nicols and the wavelength selective phase difference plate according to the embodiment of the present invention is disposed between the linearly polarizing plates is produced. The laminate is irradiated with unpolarized white light (wavelength range: 420 to 670 nm) from a direction perpendicular to a surface of the linearly polarizing plate. In a case of producing the laminate, an angle between a transmission axis direction of the linearly polarizing plate on the side to be irradiated with the white light and an in-plane slow axis direction of the wavelength selective phase difference plate on the side to be irradiated with the white light is adjusted to have an orientation relationship of 45°.

In a case where the in-plane slow axis direction of the wavelength selective phase difference plate on the side to be irradiated with the white light is known in advance, the direction thereof may be used.

In this case, a transmission spectrum of the laminate is acquired using a spectrophotometer on a side of the laminate opposite to the side on which the laminate is irradiated with the white light. In addition, a transmission spectrum in a case where the above-described white light is irradiated is acquired for the above-described two linearly polarizing plates arranged such that absorption axes are parallel to each other. Here, in a case where an intensity of light of each wavelength in the transmission spectrum of the two linearly polarizing plates arranged such that the absorption axes are parallel to each other is set to 100%, a wavelength range in which a transmittance at each wavelength in the transmission spectrum of the laminate is 80% or more is defined as the first wavelength range. In addition, a wavelength range different from the first wavelength range is defined as the second wavelength range.

Even in a case where the in-plane slow axis direction of the wavelength selective phase difference plate on the side to be irradiated with the white light is not clear, in the above-described laminate, in a case where the transmission spectrum is obtained by gradually rotating only the lamination direction of the wavelength selective phase difference plate, a transmission spectrum showing a minimal value and a maximal value of the transmittance is obtained, and the transmission spectrum measurement of the laminate may be performed in the lamination direction in which the difference between the maximum value and the minimum value of the transmittance in the transmission spectrum is the largest.

In the above-described aspect, the phase difference of polarized light to be changed in the first wavelength range is λ/2; but the phase difference can be appropriately adjusted depending on the application, and the phase difference of polarized light to be changed in the first wavelength range may be λ/4. That is, in a case where the incident light is linearly polarized light, the first wavelength range may convert the incident linearly polarized light into circularly polarized light, and the second wavelength range may not change the polarization state of the incident linearly polarized light.

In a case where the phase difference of polarized light to be changed in the first wavelength range is λ/4, the first wavelength range is determined by the same method as the above-described method. In a case where the phase difference of polarized light to be changed in the first wavelength range is λ/4, and an intensity of light of each wavelength in the transmission spectrum of the two linearly polarizing plates arranged such that the absorption axes are parallel to each other is set to 100%, a wavelength range in which a transmittance at each wavelength in the transmission spectrum of the laminate is 40% to 60% is defined as the first wavelength range.

### <Wavelength Plate>

The slow axis orientations of the plurality of wavelength plates used in the wavelength selective phase difference plate according to the embodiment of the present invention are different from each other, and the Nz factors of the plurality of wavelength plates are each more than 0.3 and less than 0.7. That is, the plurality of wavelength plates according to the present invention are laminated such that the slow axis orientations of the wavelength plates are different from each other.

Here, the Nz factor of each of the wavelength plates is a value at an average wavelength, between the upper limit wavelength and the lower limit wavelength of the above-described first wavelength range. For example, in a case where the first wavelength range is λa to λb nm, the Nz factor of each of the wavelength plates is a value of (λa+λb)/2.

The Nz factors of the plurality of wavelength plates are each preferably more than 0.4 and less than 0.6.

In a case where a plurality of the first wavelength ranges are observed, first, an average wavelength of each of the observed first wavelength ranges is obtained, and for a wavelength at which each of the average wavelengths is in the visible light range, the Nz factor of the wavelength plate is obtained at each of the average wavelengths. In a case where a plurality of the first wavelength ranges are observed, the expression “Nz factor of the wavelength plate is more than 0.3 and less than 0.7” means that at least one Nz factor in the average wavelength of each of the observed first wavelength ranges is more than 0.3 and less than 0.7. It is preferable that the Nz factor at the average wavelength of each of the observed first wavelength ranges is more than 0.3 and less than 0.7.

The wavelength plate is not particularly limited as long as it has the above-described Nz factor and exhibits the function of the wavelength selective phase difference plate in a case where the wavelength plates are combined with each other.

The wavelength plate may consist of a single layer or a plurality of layers. Among these, from the viewpoint that the Nz factor is easily adjusted, it is preferable that the wavelength plate includes an optically anisotropic layer A having an Nz factor of more than 0.5 and an optically anisotropic layer B having an Nz factor of less than 0.5. In a case where the wavelength plate consists of a plurality of layers, the Nz factor of the wavelength plate may be calculated by obtaining the refractive index in each direction of the entire wavelength plate, or may be calculated from the Nz factor of each layer constituting the wavelength plate and the thickness of each layer constituting the wavelength plate. For example, in a case where the wavelength plate consists of a layer X having an Nz factor of z1 and a layer Y having an Nz factor of z2, and a thickness of the layer X is d1 and a thickness of the layer Y is d2, an Nz factor Nza of the wavelength plate is obtained by the following expression.

$$Nza = z 1 \times d 1 / ( d 1 + d 2 ) + z 2 \times d 2 / ( d 1 + d 2 ) \qquad ( Expression )$$

That is, in a case where the wavelength plate includes the optically anisotropic layer A and the optically anisotropic layer B, the Nz factors of the optically anisotropic layer A and the optically anisotropic layer B and the thicknesses of the respective layers may be adjusted such that the Nz factor of the wavelength plate is more than 0.3 and less than 0.7.

In the above-described preferred aspect, an angle formed between a slow axis of the optically anisotropic layer A in an in-plane direction and a slow axis of the optically anisotropic layer B in an in-plane direction is preferably 45° or less, more preferably 20° or less, and still more preferably 5° or less. In the above-described preferred aspect, the angle formed between the slow axis of the optically anisotropic layer A in the in-plane direction and the slow axis of the optically anisotropic layer B in the in-plane direction may be 0°.

In addition, it is preferable that at least one of the plurality of wavelength plates used in the wavelength selective phase difference plate according to the embodiment of the present invention exhibits a forward wavelength dispersion (normal dispersion) property, which is a property in which a refractive index increases as a wavelength decreases. Among these, it is preferable that all of the plurality of wavelength plates used in the wavelength selective phase difference plate according to the embodiment of the present invention exhibit the forward wavelength dispersion property.

In the above-described aspect, the forward wavelength dispersion property is preferably exhibited in the visible light range.

A width of the first wavelength range and the second wavelength range described above can be controlled by, for example, the optical characteristics of the wavelength plate (for example, dispersion characteristics of the wavelength plate).

A thickness of the wavelength plate can be appropriately adjusted, but is preferably 0.5 to 1,000 μm and more preferably 1 to 100 μm.

Hereinafter, the optically anisotropic layer A and the optically anisotropic layer B will be described. In addition, in the latter part, an aspect in which the wavelength plate consists of a single layer (optically anisotropic layer C) will also be described.

### (Optically Anisotropic Layer A)

The optically anisotropic layer A used in the preferred aspect of the phase difference plate is an optically anisotropic layer having an Nz factor of more than 0.5.

Examples of the optically anisotropic layer having an Nz factor of more than 0.5 include a stretching film and a layer formed of a composition containing a rod-like liquid crystal compound, and a layer formed of a composition containing a rod-like liquid crystal compound is preferable.

The layer formed of a composition containing a rod-like liquid crystal compound is preferably, for example, a layer formed by immobilizing the rod-like liquid crystal compound in a horizontal alignment. The layer formed by immobilizing the rod-like liquid crystal compound in a horizontal alignment generally corresponds to a so-called positive A-plate.

The state in which the rod-like liquid crystal compound is horizontally aligned means that a major axis of the rod-like liquid crystal compound and a main surface of the optically anisotropic layer A are parallel to each other. It is not required to be strictly parallel, but an angle formed by the major axis of the rod-like liquid crystal compound and the main surface of the optically anisotropic layer A is preferably in a range of 0°±20° and more preferably in a range of 0°±10°.

In the present specification, the “fixed” state is a state in which alignment of a liquid crystal compound is maintained. Specifically, the “immobilized” state is preferably a state in which, in a temperature range of usually 0° C. to 50° C. or in a temperature range of −30° C. to 70° C. under more severe conditions, the layer has no fluidity and a fixed alignment morphology can be stably maintained without causing a change in the alignment morphology due to an external field or an external force.

In addition, in a case where a refractive index in the in-plane slow axis direction is defined as nx, a refractive index in a direction orthogonal to the in-plane slow axis in a plane is defined as ny, and a refractive index in the thickness direction is defined as nz, the positive A-plate satisfies a relationship of Expression (A1).

$$n x > ny \approx nz \qquad Expression ( A 1 )$$

The symbol “≈” encompasses not only a case where both sides are completely the same as each other but also a case where the both sides are substantially the same as each other. The expression “substantially the same” means that, for example, a case where (ny−nz)×d is −10 to 10 nm and preferably −5 to 5 nm is also included in “ny˜nz”; and a case where (nx−nz)×d is −10 to 10 nm and preferably −5 to 5 nm is also included in “nx˜nz”. In (ny−nz)×d, d represents a thickness of the layer.

In addition, the optically anisotropic layer A may be a layer formed by fixing an alignment direction of a rod-like liquid crystal compound twist-aligned with a certain direction as an axis.

Even in the optically anisotropic layer A with the above-described aspect, nx, ny, and nz can be obtained by the above-described method.

A known compound can be used as the rod-like liquid crystal compound.

Examples of the rod-like liquid crystal compound include compounds described in claim 1 of JP1999-513019A (JP-H11-513019A) and paragraphs to of JP2005-289980A.

In addition, a rod-like liquid crystal compound mentioned in the section of the optical element described later may be used.

The rod-like liquid crystal compound may have a polymerizable group.

In the present specification, the type of the polymerizable group is not particularly limited, but is preferably a functional group capable of an addition polymerization reaction, more preferably a polymerizable ethylenically unsaturated group or a ring-polymerizable group, and still more preferably a (meth) acryloyl group, a vinyl group, a styryl group, or an allyl group.

The Nz factor of the optically anisotropic layer A is more than 0.5, preferably 0.8 or more. The upper limit of the Nz factor of the optically anisotropic layer A is not particularly limited, but is usually 10 or less and is often 5 or less. In a case where the optically anisotropic layer A contains a rod-like liquid crystal compound, the Nz factor of the optically anisotropic layer A is often 0.8 to 1.2.

### (Optically Anisotropic Layer B)

The optically anisotropic layer B used in the preferred aspect of the phase difference plate is an optically anisotropic layer having an Nz factor of less than 0.5.

Examples of the optically anisotropic layer having an Nz factor of less than 0.5 include a layer formed of a composition containing a disk-like liquid crystal compound, and a layer formed by immobilizing a disk-like liquid crystal compound in a homeotropic alignment is preferable. The layer formed by immobilizing a disk-like liquid crystal compound in a homeotropic alignment usually corresponds to a so-called negative A-plate.

The state in which the disk-like liquid crystal compound is vertically aligned means that a disc plane of the disk-like liquid crystal compound is perpendicular to a main surface of the optically anisotropic layer B. It is not required to be strictly perpendicular, but an angle formed by the disc plane of the disk-like liquid crystal compound and the main surface of the optically anisotropic layer B is preferably in a range of 90°±20° and more preferably in a range of 90°±10°.

In addition, in a case where a refractive index in the in-plane slow axis direction is defined as nx, a refractive index in a direction orthogonal to the in-plane slow axis in a plane is defined as ny, and a refractive index in the thickness direction is defined as nz, the negative A-plate satisfies a relationship of Expression (A2).

$$n y < nx \approx nz \qquad Expression ( A 2 )$$

The symbol “≈” encompasses not only a case where both sides are completely the same as each other but also a case where the both sides are substantially the same as each other. The expression “substantially the same” means that, for example, a case where (ny−nz)×d is −10 to 10 nm and preferably −5 to 5 nm is also included in “ny˜nz”; and a case where (nx−nz)×d is −10 to 10 nm and preferably −5 to 5 nm is also included in “nx˜nz”. In (ny−nz)×d, d represents a thickness of the layer.

In addition, the optically anisotropic layer B may be a layer formed by fixing an alignment direction of a disk-like liquid crystal compound twist-aligned with a certain direction as an axis.

Even in the optically anisotropic layer B with the above-described aspect, nx, ny, and nz can be obtained by the above-described method.

A known compound can be used as the disk-like liquid crystal compound.

Examples of the disk-like liquid crystal compound include compounds described in

paragraphs to of JP2007-108732A and paragraphs to of JP2010-244038A.

In addition, a disk-like liquid crystal compound mentioned in the section of the optical element described later may be used.

The disk-like liquid crystal compound may have a polymerizable group. Preferred examples of the polymerizable group include the same polymerizable group as in the rod-like liquid crystal compound.

The Nz factor of the optically anisotropic layer B is less than 0.5, preferably 0.2 or less. The lower limit of the Nz factor of the optically anisotropic layer B is not particularly limited, but is usually −10 or more and is often-5 or more. In a case where the optically anisotropic layer B contains a disk-like liquid crystal compound, the Nz factor of the optically anisotropic layer B is often −0.2 to 0.2.

### (Optically Anisotropic Layer C)

As described above, the wavelength plate may consist of a single layer.

It is preferable that such a wavelength plate consists of an optically anisotropic layer C which is a B-plate in which Rth is positive. An Nz factor of the optically anisotropic layer C is more than 0.3 and less than 0.7.

In addition, in a case where a refractive index in the in-plane slow axis direction is defined as nx, a refractive index in a direction orthogonal to the in-plane slow axis in a plane is defined as ny, and a refractive index in the thickness direction is defined as nz, the B-plate in which Rth is positive satisfies a relationship of Expression (B2).

$$( nx + ny ) / 2 < nz \qquad Expression ( B2 )$$

The B-plate in which Rth is positive is obtained by a known method, and is obtained, for example, by stretching a film.

For example, the B-plate in which Rth is positive can be produced by a method of bonding a shrinkable film to one or both surfaces of the polymer film and heating and stretching the film to be stretched in the thickness (nz) direction, as described in JP1993-157911A (JP-H5-157911A), JP2006-072309A, or JP2007-298960A.

### <Combination of Wavelength Plates>

The wavelength selective phase difference plate according to the embodiment of the present invention is obtained by laminating the above-described wavelength plates such that the slow axis orientations of the wavelength plates are different from each other.

The optical characteristics of the wavelength plate and the method of laminating the wavelength plates can be appropriately selected such that the phase of polarized light in the first wavelength range is changed and the phase of polarized light in the second wavelength range different from the first wavelength range is not changed, and those skilled in the art can design the optical characteristics of the wavelength plate and the method of laminating the wavelength plates according to the above-described principle.

For example, in a case where an average wavelength between the upper limit wavelength and the lower limit wavelength of a desired second wavelength range is λ2, an in-plane phase difference of the wavelength plate is preferably λ2±200 nm, more preferably λ2±100 nm, and still more preferably λ2±50 nm at the average wavelength λ2.

In addition, for example, regarding a combination of in-plane slow axes of the preferred wavelength plates, it is preferable to combine wavelength plates shown in Table 1 below such that the in-plane slow axis direction thereof is the angle shown in Table 1. In Table 1, λ2 represents a value of the average wavelength between the upper limit wavelength and the lower limit wavelength of a desired second wavelength range.

The angles shown in Table 1 are angles of the slow axis orientation with respect to the vibration direction of the incident linearly polarized light, and in a case of being viewed from a side opposite to the incident side of the incident linearly polarized light, clockwise rotation is indicated as a negative value and counterclockwise rotation is indicated as a positive value. In addition, in a case where the angle shown in Table 1 is denoted by θn, the angle may be θn ±5°, preferably θn±3°. In addition, a configuration of an orientation relationship in which the positive and negative signs of the values of the angles described in the table are reversed is also preferably used. Furthermore, a configuration of an orientation relationship in which an angle obtained by adding 90° to each of the angles described in the table is also preferably used.

In addition, in Table 1, a wavelength plate on the side where the linearly polarized light is incident is listed as the first wavelength plate.

TABLE 1

| Wavelength plate | | Preferred angle of slow axis orientation (°) | | | |
|---|---|---|---|---|---|
| | Preferred phase | Three-layer | Five-layer | Seven-layer | Nine-layer |
| Sheet number | difference (nm) | configuration | configuration | configuration | configuration |
| First sheet | λ2 | 45 | 45 | 45 | 45 |
| Second sheet | 2 × λ2 | −13 | −15 | −16 | −16 |
| Third sheet | 2 × λ2 | 10 | 13 | 14 | 15 |
| Fourth sheet | 2 × λ2 | — | −2 | −3 | −4 |
| Fifth sheet | 2 × λ2 | — | 6 | 8 | 9 |
| Sixth sheet | 2 × λ2 | — | — | 0 | 0 |
| Seventh sheet | 2 × λ2 | — | — | 5 | 6 |
| Eighth sheet | 2 × λ2 | — | — | — | 2 |
| Ninth sheet | 2 × λ2 | — | — | — | 5 |

The average wavelength of the first wavelength range can be adjusted by adjusting the average wavelength (λ2) of the second wavelength range.

In addition, the wavelength range of the second wavelength range and the wavelength range of the first wavelength range can be adjusted by adjusting the optical characteristics of the wavelength plate used and the angle of the slow axis orientation.

### <Other Layers>

In addition to the above-described configuration, the wavelength selective phase difference plate according to the embodiment of the present invention may include other layers.

Examples of the other layers include a λ4 plate, a support, and a bonding layer.

In a case where the wavelength selective phase difference plate according to the embodiment of the present invention is applied as a wavelength selective phase difference plate of circularly polarized light, it is preferable that the wavelength selective phase difference plate includes a λ/4 plate as the other layers. In the above-described aspect, it is preferable that the λ/4 plate is provided on both one surface and the other surface of the wavelength selective phase difference plate.

As the λ/4 plate, a known λ/4 plate can be adopted.

As the λ/4 plate, various phase difference plates, for example, a cured layer, a structural birefringence layer, or the like of a polymer or a liquid crystal compound can be used.

It is preferable that the N/4 plate has reverse dispersibility. In a case where the λ/4 plate has reverse dispersibility, incidence light in a wide wavelength range can be handled.

As the λ/4 plate, a retardation layer in which a plurality of phase difference plates are laminated to actually function as a λ/4 plate are preferably used. For example, a broadband λ/4 plate described in WO2013/137464A, in which a λ/2 plate and a λ/4 plate are used in combination, can handle with incidence light in a wide wavelength range and can be preferably used.

In a case where the wavelength selective phase difference plate according to the embodiment of the present invention includes the λ/4 plate, it is preferable that an orientation of the λ/4 plate and an orientation of the wavelength selective phase difference plate are adjusted such that the vibration direction of the linearly polarized light after the polarization conversion is the same as the vibration direction of the linearly polarized light to be incident as described above.

The support is not particularly limited as long as it can support the wavelength selective phase difference plate, and a known support can be used. As the support, various sheet-like materials (films and plate-like materials) can be used.

The support is preferably a transparent support. As the transparent support, an inorganic transparent support such as glass or an organic transparent support such as a resin film may be used.

Examples of the resin film include a polyacrylic resin film such as polymethyl methacrylate, a cellulose resin film such as cellulose triacetate, a cycloolefin polymer film (for example, trade name “ARTON”, manufactured by JSR Corporation; or trade name “ZEONOR”, manufactured by Zeon Corporation), polyethylene terephthalate (PET), polycarbonate, and polyvinyl chloride.

A thickness of the support is preferably 1 to 1,000 μm, more preferably 3 to 250 μm, and still more preferably 5 to 150 μm.

The bonding layer is used in a case where the wavelength plates or the wavelength plate and the other layers (for example, the λ/4 plate and the support) are bonded to each other. The bonding layer may be a layer formed of an adhesive which has fluidity in a case of bonding and then is to be a solid, a layer formed of a pressure sensitive adhesive which is a gel-like (rubber-like) soft solid in a case of bonding and the gel-like state does not change thereafter, or a layer formed of a material having characteristics of both the adhesive and the pressure sensitive adhesive. Accordingly, as the bonding layer, a known layer used for bonding a sheet-like material in an optical device, an optical element, or the like, such as an optical clear adhesive (OCA), an optically transparent double-sided tape, and an ultraviolet curable resin, may be used.

### Optical Element

The optical element according to the embodiment of the present invention includes a plurality of optically anisotropic layers which are formed of a composition containing a liquid crystal compound and have a liquid crystal alignment pattern in which an orientation of an optical axis derived from the liquid crystal compound changes while continuously rotating in at least one in-plane direction. In addition, the optical element according to the embodiment of the present invention includes the above-described wavelength selective phase difference plate disposed between at least one pair of the plurality of optically anisotropic layers.

Here, rotation directions of orientations of optical axes in the two adjacent optically anisotropic layers are opposite to each other.

In addition, the above-described first wavelength region includes a wavelength longer than a wavelength in the above-described second wavelength range, and the above-described wavelength selective phase difference plate converts circularly polarized light in the first wavelength range into circularly polarized light having an opposite turning direction and does not change a phase of circularly polarized light in the second wavelength range.

Furthermore, in a case where a length over which the orientation of the optical axis rotates by 180° in the one direction in which the orientation of the optical axis changes while continuously rotating in the above-described liquid crystal alignment pattern is set as a single period, at least one of the optically anisotropic layers has a length of the single period different from lengths of the single periods of the other optically anisotropic layers.

In the optical element according to the embodiment of the present invention, wavelength dependence of a refraction angle of incident and transmitted light is small, and light components having different wavelengths incident from the same direction can be emitted in almost the same direction.

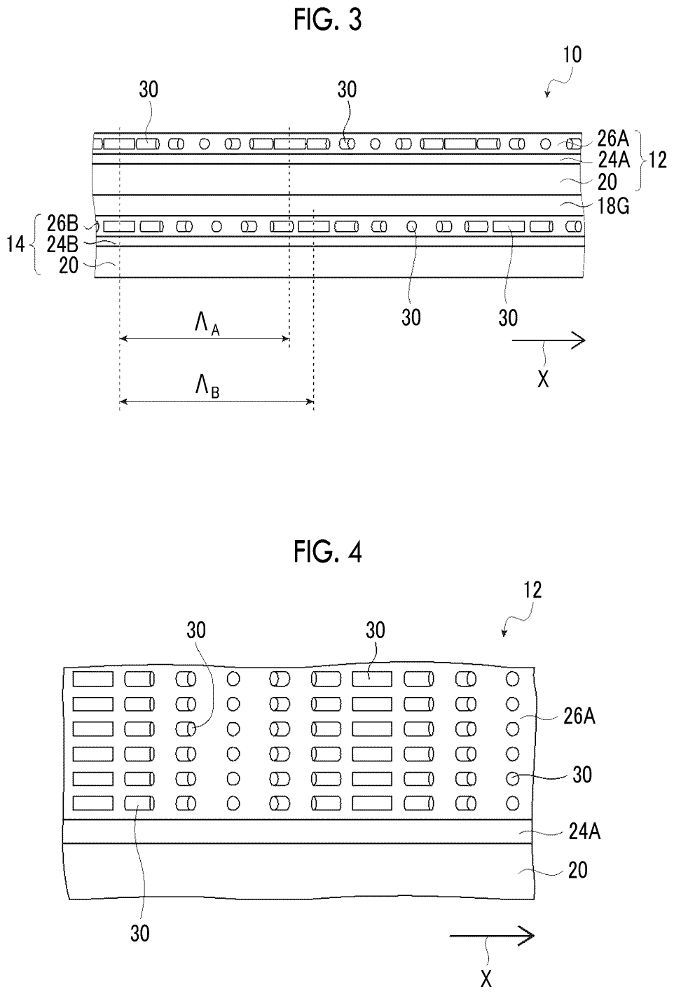

FIG. 3 shows an example of the optical element according to the embodiment of the present invention.

An optical element 10 shown in FIG. 3 includes a first optically anisotropic member 12, a second optically anisotropic member 14, and a wavelength selective phase difference plate 18G which is disposed between the first optically anisotropic member 12 and the second optically anisotropic member 14.

As described above, in the optical element according to the embodiment of the present invention, optically anisotropic layers which are formed of a composition containing a liquid crystal compound and have a predetermined liquid crystal alignment pattern in which an optical axis derived from the liquid crystal compound rotates are arranged in a thickness direction. The first optically anisotropic member 12 includes a support 20, an alignment film 24A, and a first optically anisotropic layer 26A. In addition, the second optically anisotropic member 14 includes a support 20, an alignment film 24B, and a second optically anisotropic layer 26B.

In addition, in the optical element according to the embodiment of the present invention, as described above, the wavelength selective phase difference plate converts circularly polarized light in a specific wavelength range (first wavelength region) into circularly polarized light having an opposite turning direction, and allows transmission (passage) of light in the other second wavelength region. In the optical element 10 of the example shown in the drawing, the wavelength selective phase difference plate 18G converts a turning direction of green circularly polarized light into an opposite turning direction and allows transmission of the other light as circularly polarized light having the same turning direction.

Although not shown in the drawing, the first optically anisotropic member 12 and the wavelength selective phase difference plate 18G, and the wavelength selective phase difference plate 18G and the second optically anisotropic member 14 are bonded to each other through a bonding layer provided therebetween, respectively. As the bonding layer, the same bonding layer as the bonding layer described in the section of the wavelength selective phase difference plate can be used.

The first optically anisotropic member 12, the wavelength selective phase difference plate 18G, and the second optically anisotropic member 14 may be laminated and held by a frame, a holding device, or the like to form the optical element according to the embodiment of the present invention.

In addition, the optical element according to the embodiment of the present invention is not limited to the configuration in which the first optically anisotropic member 12, the wavelength selective phase difference plate 18G, and the second optically anisotropic member 14 are laminated in contact with each other as in the example shown in the drawing, and a configuration in which the members are arranged in a state where one or more members are spaced from each other may be adopted.

In addition, the optical element 10 of the example shown in the drawing includes the support 20 for each of the optically anisotropic members; but the optical element according to the embodiment of the present invention does not necessarily include the support 20 for each of the optically anisotropic members.

For example, the optical element according to the embodiment of the present invention may have a configuration in which the wavelength selective phase difference plate 18G is formed on a surface of the second optically anisotropic member 14 (second optically anisotropic layer 26B), the alignment film 24A is formed on a surface thereon, and the first optically anisotropic layer 26A is formed thereon.

Alternatively, the support 20 of the second optically anisotropic member 14 may be peeled off from the above-described configuration such that the optical element according to the embodiment of the present invention is configured with only the wavelength selective phase difference plate, the alignment film, and the optically anisotropic layers. In addition, the alignment film may be peeled off from the above-described configuration such that the optical element according to the embodiment of the present invention is configured with only the wavelength selective phase difference plate and the optically anisotropic layers.

That is, in the optical element according to the embodiment of the present invention, various layer configurations can be used as long as the plurality of optically anisotropic layers are arranged, the wavelength selective phase difference plate is disposed between at least one pair of two optically anisotropic layers adjacent to each other among the arranged optically anisotropic layers, the optically anisotropic layer has the liquid crystal alignment pattern in which the orientation of the optical axis derived from the liquid crystal compound rotates in one direction, and the liquid crystal alignment pattern of at least one optically anisotropic layer has different single periods described below. <Optically anisotropic member>

In the optical element 10 according to the embodiment of the present invention, the wavelength selective phase difference plate 18G is provided between the first optically anisotropic member 12 and the second optically anisotropic member 14.

As described above, the first optically anisotropic member 12 includes the support 20, the alignment film 24A, and the first optically anisotropic layer 26A. In addition, the second optically anisotropic member 14 includes the support 20, the alignment film 24B, and the second optically anisotropic layer 26B.

### (Support)

In the first optically anisotropic member 12 and the second optically anisotropic member 14, the supports 20 support the alignment films 24A and 24B and the first and second optically anisotropic layers 26A and 26B, respectively.

In the following description, in a case where it is not necessary to distinguish between the alignment films 24A and 24B, the alignment films 24A and 24B will also be collectively referred to as “alignment film”. In addition, in the following description, in a case where it is not necessary to distinguish between the first and second optically anisotropic layers 26A and 26B, the first and second optically anisotropic layers 26A and 26B will also be collectively referred to as “optically anisotropic layer”.

As the support 20, various sheet-shaped materials (films or plate-shaped materials) can be used as long as the support can support the alignment film and the optically anisotropic layer.

As the support 20, the above-described support can be used.

### (Alignment Film)

In the first optically anisotropic member 12, the alignment film 24A is formed on the surface of the support 20. In the second optically anisotropic member 14, the alignment film 24B is formed on the surface of the support 20.

The alignment film 24A is an alignment film for aligning a liquid crystal compound 30 to a predetermined liquid crystal alignment pattern during the formation of the first optically anisotropic layer 26A in the first optically anisotropic member 12. The alignment film 24B is an alignment film for aligning a liquid crystal compound 30 to a predetermined liquid crystal alignment pattern during the formation of the second optically anisotropic layer 26B in the second optically anisotropic member 14.

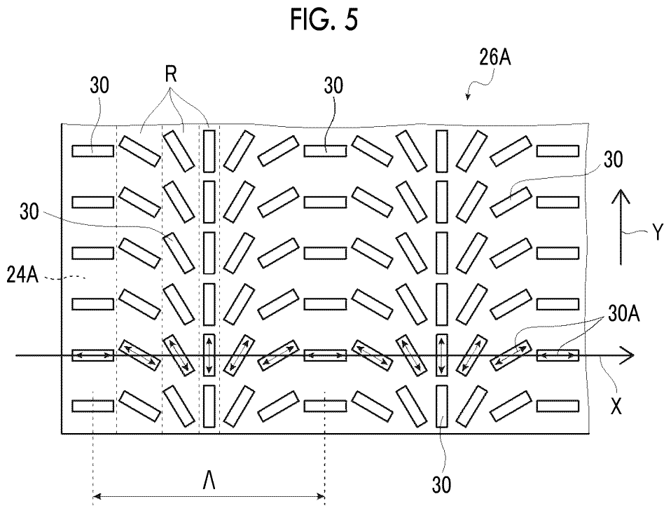

As will be described later, in the optical element 10 according to the embodiment of the present invention, the optically anisotropic layer has a liquid crystal alignment pattern in which an orientation of an optical axis 30A (see FIG. 5) derived from the liquid crystal compound 30 changes while continuously rotating in one in-plane direction (arrow X direction described later). Accordingly, the alignment film of each of the optically anisotropic members is formed such that the optically anisotropic layer can form the liquid crystal alignment pattern.

In the optical element according to the embodiment of the present invention, in a case where a length over which the orientation of the optical axis 30A rotates by 180° in the one direction in which the orientation of the optical axis 30A changes while continuously rotating in the liquid crystal alignment pattern is set as a single period (rotation period of the optical axis), at least one of the optically anisotropic layers has a length of the single period different from that of the other optically anisotropic layer. In the optical element 10 shown in FIG. 3, a single period (single period AA) of the liquid crystal alignment pattern in the first optically anisotropic layer 26A is shorter than a single period (single period AB) of the liquid crystal alignment pattern in the second optically anisotropic layer 26B.

In the following description, “the orientation of the optical axis 30A rotates” will also be simply referred to as “the optical axis 30A rotates”.

As the alignment film, various known films can be used.

Examples of the alignment film include a rubbed film formed of an organic compound such as a polymer, an obliquely deposited film formed of an inorganic compound, a film having a microgroove, and a film formed by lamination of Langmuir-Blodgett (LB) films formed with a Langmuir-Blodgett's method using an organic compound such as @-tricosanoic acid, dioctadecylmethylammonium chloride, or methyl stearate.

The alignment film formed by a rubbing treatment can be formed by rubbing a surface of a polymer layer with paper or fabric in a given direction multiple times.

Preferred examples of the material used for the alignment film include a material for forming polyimide, polyvinyl alcohol, a polymer having a polymerizable group described in JP1997-152509A (JP-H9-152509A), and an alignment film described in JP2005-97377A, JP2005-99228A, and JP2005-128503A.

In the optical element 10 according to the embodiment of the present invention, the alignment film can be suitably used as a so-called photo-alignment film obtained by irradiating a photo-alignable material with polarized light or non-polarized light. That is, in the optical element 10 according to the embodiment of the present invention, a photo-alignment film which is formed by applying a photo-alignment material onto the support 20 is suitably used as the alignment film.

The irradiation of polarized light can be performed in a direction perpendicular or oblique to the photo-alignment film, and the irradiation of non-polarized light can be performed in a direction oblique to the photo-alignment film.

Preferable examples of the photo-alignment material used in the photo-alignment film which can be used in the present invention include: an azo compound described in JP2006-285197A, JP2007-76839A, JP2007-138138A, JP2007-94071A, JP2007-121721A, JP2007-140465A, JP2007-156439A, JP2007-133184A, JP2009-109831A, JP3883848B, and JP4151746B; an aromatic ester compound described in JP2002-229039A; a maleimide-and/or alkenyl-substituted nadiimide compound having a photo-alignable unit described in JP2002-265541A and JP2002-317013A; a photocrosslinking silane derivative described in JP4205195B and JP4205198B, a photocrosslinking polyimide, a photocrosslinking polyamide, or a photocrosslinking ester described in JP2003-520878A, JP2004-529220A, and JP4162850B; and a photodimerizable compound, in particular, a cinnamate compound, a chalcone compound, or a coumarin compound described in JP1997-118717A (JP-H9-118717A), JP1998-506420A (JP-H10-506420A), JP2003-505561A, WO2010/150748A, JP2013-177561A, and JP2014-12823A.

Among these, an azo compound, a photocrosslinking polyimide, a photocrosslinking polyamide, a photocrosslinking ester, a cinnamate compound, or a chalcone compound is suitability used.

A thickness of the alignment film is not particularly limited. The thickness with which a required alignment function can be obtained may be appropriately set depending on the material for forming the alignment film.

The thickness of the alignment film is preferably 0.01 to 5 μm and more preferably 0.05 to 2 μm.

A method for forming the alignment film is not limited, and various known methods can be used depending on the material for forming the alignment film. Examples thereof include a method including: applying the alignment film to a surface of the support 20; drying the applied alignment film; and exposing the alignment film to laser light to form an alignment pattern.

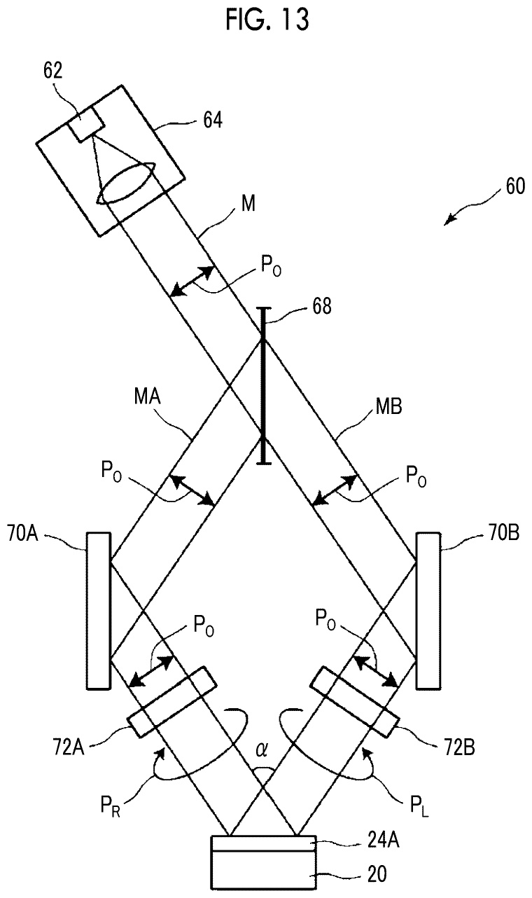

FIG. 13 conceptually shows an example of an exposure device which exposes the alignment film to form an alignment pattern. In the example shown in FIG. 13, for example, the exposure of the alignment film 24A in the first optically anisotropic member 12 is shown, but the alignment film 24B in the second optically anisotropic member 14 can also form the alignment pattern with the same exposure device.

An exposure device 60 shown in FIG. 13 includes a light source 64 including a laser 62, a λ/2 plate (not shown) which changes a polarization direction of a laser light M emitted from the laser 62, a beam splitter 68 which splits the laser light M emitted from the laser 62 and passing through the λ/2 plate (not shown) into two rays MA and MB, mirrors 70A and 70B which are each disposed on an optical path of the splitted two rays MA and MB, and λ/4 plates 72A and 72B.

Although not shown in the drawing, the light source 64 includes a polarizing plate and emits a linearly polarized light P₀. The λ/4 plates 72A and 72B have optical axes orthogonal to each other. The 24 plate 72A converts the linearly polarized light P₀ (ray MA) into dextrorotatory circularly polarized light P_{R}, and the 24 plate 72B converts the linearly polarized light P₀ (ray MB) into levorotatory circularly polarized light P_{L}.

The support 20 including the alignment film 24A on which the alignment pattern is not yet formed is disposed at an exposed portion, the two rays MA and MB intersect and interfere each other on the alignment film 24A, and the alignment film 24A is irradiated with and exposed to the interference light.

Due to the interference at this time, the polarization state of light with which the alignment film 24A is irradiated periodically changes according to interference fringes. As a result, in the alignment film 24A, an alignment pattern in which the alignment state periodically changes can be obtained.

In the exposure device 60, by changing an intersecting angle a between the two rays MA and MB, a period of the alignment pattern can be adjusted. That is, by adjusting the intersecting angle a in the exposure device 60, in the alignment pattern in which the optical axis 30A derived from the liquid crystal compound 30 continuously rotates in the one direction, the length of single period (single period A) over which the optical axis 30A rotates by 180° in the one direction in which the optical axis 30A rotates can be adjusted.

By forming the optically anisotropic layer on the alignment film having the alignment pattern in which the alignment state periodically changes, as described below, the first optically anisotropic layer 26A having the liquid crystal alignment pattern in which the optical axis 30A derived from the liquid crystal compound 30 continuously rotates in the one direction can be formed.

In addition, by rotating the optical axes of the λ/4 plates 72A and 72B by 90°, respectively, the rotation direction of the optical axis 30A can be reversed.

In the optical element according to the embodiment of the present invention, the alignment film is provided as a preferred aspect and is not an essential configuration requirement.

For example, the following configuration can also be adopted, in which, by forming the alignment pattern on the support 20 using a method of rubbing the support 20, a method of processing the support 20 with laser light or the like, or the like, the first optically anisotropic layer 26A and the like have the liquid crystal alignment pattern in which the orientation of the optical axis 30A derived from the liquid crystal compound 30 changes rotationally in at least one in-plane direction.

### <<Optically Anisotropic Layer>>

In the first optically anisotropic member 12, the first optically anisotropic layer 26A is formed on the surface of the alignment film 24A. In the second optically anisotropic member 14, the second optically anisotropic layer 26B is formed on the surface of the alignment film 24B.

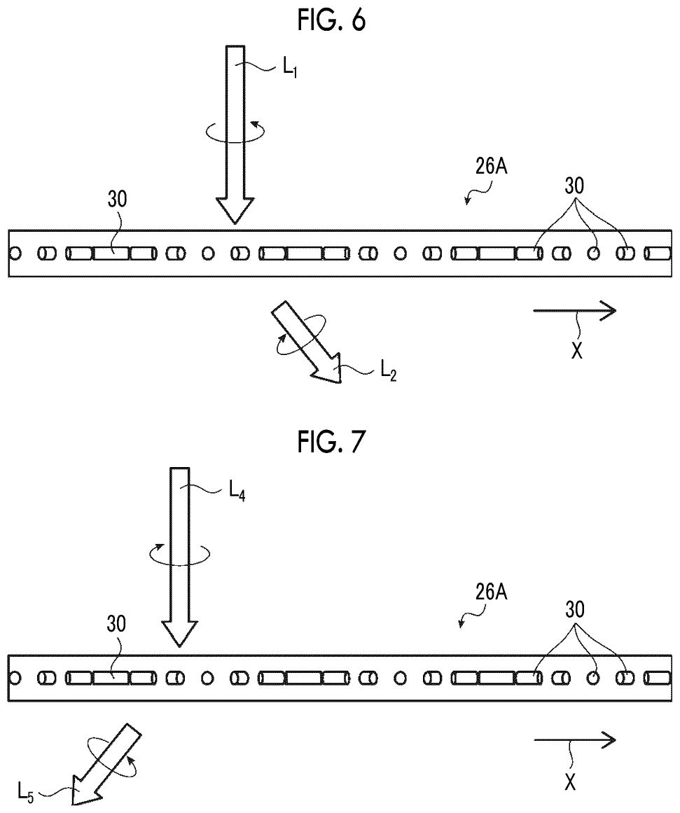

In FIG. 3 (and FIGS. 6 to 8 described later), in order to simplify the drawing and to clarify the configuration of the optical element 10, only liquid crystal compounds 30 (liquid crystal compound molecules) on the surface of the alignment film in the first optically anisotropic layer 26A and the second optically anisotropic layer 26B are shown. However, as conceptually shown in FIG. 4 showing the first optically anisotropic layer 26A, the first optically anisotropic layer 26A and the second optically anisotropic layer 26B have a structure in which the aligned liquid crystal compounds 30 are stacked as in an optically anisotropic layer which is formed of a typical composition containing a liquid crystal compound.

As described above, in the optical element 10 according to the embodiment of the present invention, the optically anisotropic layer (the first optically anisotropic layer 26A and the second optically anisotropic layer 26B) is formed of the composition containing a liquid crystal compound.

In a case where a value of an in-plane retardation is set as λ/2, the optically anisotropic layer has a function as a general λ/2 plate, that is, a function of imparting a phase difference of a half wavelength, that is, 180° to two linearly polarized light components which are included in light incident into the optically anisotropic layer and are orthogonal to each other.

The optically anisotropic layer has the liquid crystal alignment pattern in which the orientation of the optical axis derived from the liquid crystal compound changes while continuously rotating in one direction indicated by arrow X in a plane of the optically anisotropic layer.

The optical axis 30A derived from the liquid crystal compound 30 is an axis having the highest refractive index in the liquid crystal compound 30, that is, a so-called slow axis. For example, in a case where the liquid crystal compound 30 is a rod-like liquid crystal compound, the optical axis 30A is along a major axis direction of the rod shape.

In the following description, “one direction indicated by the arrow X” will also be simply referred to as “arrow X direction”. In addition, in the following description, the optical axis 30A derived from the liquid crystal compound 30 will also be referred to as “optical axis 30A of the liquid crystal compound 30” or “optical axis 30A”.

In the optically anisotropic layer, the liquid crystal compound 30 is two-dimensionally aligned in a plane parallel to the arrow X direction and a Y direction orthogonal to the arrow X direction. In FIGS. 3 and 4 and FIGS. 6 to 8 described later, the Y direction is a direction orthogonal to the paper plane. FIG. 5 conceptually shows a plan view of the first optically anisotropic layer 26A.

The plan view is a view in a case where the optical element 10 is seen from the top in FIG. 3, that is, a view in a case where the optical element 10 is seen from a thickness direction (=laminating direction of the respective layers (films)). In other words, the plan view is a view in a case where the first optically anisotropic layer 26A is seen from a direction orthogonal to the main surface.

In addition, in FIG. 5, in order to clarify the configuration of the optical element 10 according to the embodiment of the present invention, only the liquid crystal compounds 30 on the surface of the alignment film 24A are shown as in FIG. 3. However, as described above, the first optically anisotropic layer 26A has a structure in which the liquid crystal compounds 30 are stacked in the thickness direction from the liquid crystal compounds 30 on the surface of the alignment film 24A as shown in FIG. 4.

In FIG. 5, the first optically anisotropic layer 26A will be described as a representative example; but the second optically anisotropic layer 26B basically has the same configuration and the same effect as the first optically anisotropic layer 26A, except that the length (single period A) of the single period of the liquid crystal alignment pattern differs as described later.

The rotation directions of the orientations of the optical axes 30A in the first optically anisotropic layer 26A and the second optically anisotropic layer 26B are opposite to each other. That is, in a case where the rotation of the orientation of the optical axis 30A in the first optically anisotropic layer 26A is clockwise, the rotation of the orientation of the optical axis 30A in the second optically anisotropic layer is counterclockwise.

The first optically anisotropic layer 26A has a liquid crystal alignment pattern in which the orientation of the optical axis 30A derived from the liquid crystal compound 30 changes while continuously rotating in the arrow X direction in a plane of the first optically anisotropic layer 26A.

Specifically, the “orientation of the optical axis 30A of the liquid crystal compound 30 changes while continuously rotating in the arrow X direction (predetermined one direction)” means that an angle between the optical axis 30A of the liquid crystal compound 30, which is arranged in the arrow X direction, and the arrow X direction varies depending on positions in the arrow X direction, and the angle between the optical axis 30A and the arrow X direction sequentially changes from θ to θ+180° or to θ−180° in the arrow X direction.

A difference between the angles of the optical axes 30A of the liquid crystal compounds 30 adjacent to each other in the arrow X direction is preferably 45° or less, more preferably 15° or less, and still more preferably less than 15°.

Meanwhile, regarding the liquid crystal compound 30 forming the first optically anisotropic layer 26A, the liquid crystal compounds 30 in which the orientations of the optical axes 30A are the same as one another are arranged at equal intervals in the Y direction orthogonal to the arrow X direction, that is, the Y direction orthogonal to one direction in which the optical axes 30A continuously rotate.

In other words, regarding the liquid crystal compound 30 forming the first optically anisotropic layer 26A, in the liquid crystal compounds 30 arranged in the Y direction, angles between the orientations of the optical axes 30A and the arrow X direction are the same.

In the optical element 10 according to the embodiment of the present invention, in such a liquid crystal alignment pattern of the liquid crystal compound 30, the length (distance) over which the optical axis 30A of the liquid crystal compound 30 rotates by 180° in the arrow X direction in which the direction of the optical axis 30A changes rotationally in a plane is defined as a length A of the single period in the liquid crystal alignment pattern. In other words, the length of the single period in the liquid crystal alignment pattern is defined as the distance between θ and θ+180° that is a range of the angle between the optical axis 30A of the liquid crystal compound 30 and the arrow X direction.

That is, in the arrow X direction, a distance between centers of two liquid crystal compounds 30 having the same angle with respect to the arrow X direction is set as the length Λ of the single period. Specifically, as shown in FIG. 5, the distance between the centers of two liquid crystal compounds 30 in which the arrow X direction and the direction of the optical axis 30A coincide with each other in the arrow X direction is set as the length Λ of the single period. In the description below, the length Λ of the single period is also referred to as “single period Λ”.

In addition, in the following description, in order to distinguish between the single periods Λ of the respective optically anisotropic layers, the single period Λ of the first optically anisotropic layer 26A will also be referred to as “Λ_{A}”, and the single period Λ of the second optically anisotropic layer 26B will also be referred to as “Λ_{B}”.

In the liquid crystal alignment pattern of the optically anisotropic layer in the optical element 10 according to the embodiment of the present invention, the single period Λ is repeated in the arrow X direction, that is, in the one direction in which the orientation of the optical axis 30A changes while continuously rotating.

As described above, in the optically anisotropic layer, the liquid crystal compounds arranged in the Y direction have the same angle between the optical axis 30A and the arrow X direction (one direction in which the orientation of the optical axis of the liquid crystal compound 30 rotates). A region where the liquid crystal compounds 30 in which the angles between the optical axes 30A and the arrow X direction are the same are arranged in the Y direction will be referred to as a region R.

In this case, it is preferable that an in-plane retardation (Re) value of each of the regions R is a half wavelength, that is, λ/2. The in-plane retardation is calculated from a product of a difference in refractive index Δn due to refractive index anisotropy of the region R and a thickness of the optically anisotropic layer. Here, a difference in refractive index due to the refractive index anisotropy of the regions R in the optically anisotropic layer is defined by a difference between a refractive index of a direction of an in-plane slow axis of the region R and a refractive index of a direction orthogonal to the direction of the slow axis. That is, the difference Δn in refractive index due to the refractive index anisotropy of the regions R is the same as a difference between a refractive index of the liquid crystal compound 30 in the direction of the optical axis 30A and a refractive index of the liquid crystal compound 30 in a direction perpendicular to the optical axis 30A in a plane of the region R. That is, the above-described difference in refractive index Δn is the same as the difference in refractive index of the liquid crystal compound.

In a case where circularly polarized light is incident into the optically anisotropic layer (the first optically anisotropic layer 26A and the second optically anisotropic layer 26B), the light is refracted such that the direction of the circularly polarized light is converted. This action is conceptually shown in FIG. 6 using the first optically anisotropic layer 26A. In the first optically anisotropic layer 26A, a product of the difference in refractive index of the liquid crystal compound and the thickness of the optically anisotropic layer is set to λ/2.

As shown in FIG. 6, in a case where the value of the product of the difference in refractive index of the liquid crystal compound of the first optically anisotropic layer 26A and the thickness of the optically anisotropic layer is λ/2 and an incidence ray L₁ as levorotatory circularly polarized light is incident into the first optically anisotropic layer 26A, the incidence ray L₁ is transmitted through the first optically anisotropic layer 26A to be imparted with a retardation of 180°, and a transmitted ray L₂ is converted into dextrorotatory circularly polarized light.

On the other hand, as conceptually shown in FIG. 7, in a case where the value of the product of the difference in refractive index of the liquid crystal compound of the first optically anisotropic layer 26A and the thickness of the optically anisotropic layer is λ/2 and an incidence ray L₄ as dextrorotatory circularly polarized light is incident into the first optically anisotropic layer 26A, the incidence ray L₄ is transmitted through the first optically anisotropic layer 26A to be imparted with a retardation of 180°, and a transmitted ray L₅ is converted into levorotatory circularly polarized light.

In the first optically anisotropic layer 26A, it is preferable that the in-plane retardation value of the plurality of the regions R is a half wavelength, and it is preferable that an in-plane retardation Re(550)=Δn₅₅₀×d of the plurality of the regions R of the first optically anisotropic layer 26A with respect to an incidence ray having a wavelength of 550 nm is in a range defined by the following expression (1). Here, Δn₅₅₀ is a difference in refractive index due to the refractive index anisotropy of the region R in a case where the wavelength of the incidence ray is 550 nm, and d represents a thickness of the first optically anisotropic layer 26A.

$$200 nm \leq Δ {n}_{550} \times d \leq 350 nm \qquad ( 1 )$$

That is, in a case where the “in-plane retardation Re(550)=Δn₅₅₀×d” of the plurality of the regions R of the first optically anisotropic layer 26A satisfies the expression (1), a sufficient amount of circularly polarized light components of light which has been incident into the first optically anisotropic layer 26A can be converted into circularly polarized light traveling in a direction tilted in a forward or backward direction with respect to the arrow X direction. It is more preferable that the in-plane retardation Re(550)=Δn₅₅₀×d is 225 nm≤Δn₅₅₀×d≤340 nm, and it is still more preferable to be 250 nm≤Δn₅₅₀×d≤330 nm.

The expression (1) is a range with respect to the incidence ray having a wavelength of 550 nm, but an in-plane retardation Re(λ)=Δn_{λ}×d of the plurality of the regions R of the optically anisotropic layer with respect to an incidence ray having a wavelength of 2 nm is preferably in a range defined by the following expression (1-2), and can be appropriately set.

$$0 \text{.7} λ nm \leq Δ {n}_{λ} \times d \leq 1.3 λ nm \qquad ( 1 ‐ 2 )$$

In addition, a value of the in-plane retardation of the plurality of the regions R of the first optically anisotropic layer 26A in a range outside the range of the expression (1) can also be used. Specifically, by adopting Δn₅₅₀×d<200 nm or 350 nm<Δn₅₅₀×d, light can be classified into light which travels in the same direction as a traveling direction of the incidence ray and light which travels in a direction different from a traveling direction of the incidence ray. In a case where Δn₅₅₀×d approaches 0 nm or 550 nm, the light component traveling in the same direction as the traveling direction of the incidence ray increases, and the light component traveling in a direction different from the traveling direction of the incidence ray decreases.

Furthermore, it is preferable that an in-plane retardation Re(450)=Δn₄₅₀×d of each of the regions R of the first optically anisotropic layer 26A with respect to an incidence ray having a wavelength of 450 nm and an in-plane retardation Re(550)=Δn₅₅₀×d of each of the regions R of the first optically anisotropic layer 26A with respect to an incidence ray having a wavelength of 550 nm satisfy the following expression (2). Here, Δn₄₅₀ represents a difference in refractive index due to the refractive index anisotropy of the region R in a case where the wavelength of the incidence ray is 450 nm.

$$( Δ {n}_{450} \times d ) / ( Δ {n}_{550} \times d ) < 1. \qquad ( 2 )$$

The expression (2) represents that the liquid crystal compound 30 contained in the first optically anisotropic layer 26A has reverse dispersibility. That is, by satisfying the expression (2), the first optically anisotropic layer 26A can respond to incident light having a wide wavelength range.

Here, by changing the single period A of the liquid crystal alignment pattern formed in the first optically anisotropic layer 26A, refraction angles of the transmitted rays L₂ and L₅ can be adjusted. Specifically, as the single period A of the liquid crystal alignment pattern decreases, light transmitted through the liquid crystal compounds 30 adjacent to each other more strongly interfere with each other, so that the transmitted rays L₂ and L₅ can be more largely refracted.

In addition, the refraction angles of the transmitted rays L₂ and Ls with respect to the incidence rays L₁ and L₄ vary depending on the wavelengths of the incidence rays L₁ and L₄ (the transmitted rays L₂ and L₅). Specifically, as the wavelength of incidence light increases, the transmitted rays are largely refracted. That is, in a case where the incidence light is red light, green light, and blue light, the red light is refracted to the highest degree, and the blue light is refracted to the lowest degree.

Furthermore, by reversing a rotation direction of the optical axis 30A of the liquid crystal compound 30 which rotates in the arrow X direction, a refraction direction of the transmitted ray can be reversed.

The optically anisotropic layer includes a cured layer of a liquid crystal composition containing a rod-like liquid crystal compound or a disk-like liquid crystal compound, and has a liquid crystal alignment pattern in which an optical axis of the rod-like liquid crystal compound or an optical axis of the disk-like liquid crystal compound is aligned as described above.

The optically anisotropic layer including the cured layer of the liquid crystal composition can be obtained by forming the alignment film on the support 20, coating the alignment film with the liquid crystal composition, and curing the liquid crystal composition. The optically anisotropic layer functions as a so-called λ/2 plate, but in the present invention, an aspect in which a laminate integrally including the support 20 and the alignment film functions as the λ/2 plate is included.

The liquid crystal composition for forming the optically anisotropic layer contains a rod-like liquid crystal compound or a disk-like liquid crystal compound, and may further contain other components such as a leveling agent, an alignment control agent, a polymerization initiator, and an alignment assistant.

In addition, it is preferable that the optically anisotropic layer has a wide range for the wavelength of incident light, and is formed of a liquid crystal material having a reverse birefringence index dispersion. In addition, it is also preferable that the optically anisotropic layer can be made to have a substantially wide range for the wavelength of incidence light by imparting a torsion component to the liquid crystal composition or by laminating different retardation layers. For example, in the optically anisotropic layer, a method of realizing a λ/2 plate having a wide-range pattern by laminating two liquid crystal layers having different twisted directions is described in, for example, JP2014-089476A and can be preferably used in the present invention.

### —Rod-Like Liquid Crystal Compound—

As the rod-like liquid crystal compound, azomethines, azoxys, cyano biphenyls, cyanophenyl esters, benzoic acid esters, cyclohexane carboxylic acid phenyl esters, cyanophenyl cyclohexanes, cyano-substituted phenyl pyrimidines, alkoxy-substituted phenyl pyrimidines, phenyl dioxanes, tolanes, and alkenylcyclohexylbenzonitriles are preferably used. In addition to the above-described low-molecular-weight liquid crystal molecules, a high-molecular-weight liquid crystal molecular can also be used.

It is preferable that the alignment of the rod-like liquid crystal compound is fixed by polymerization, and examples of the polymerizable rod-like liquid crystal compound include compounds described in Makromol. Chem., (1989), Vol. 190, p. 2255, Advanced Materials (1993), Vol. 5, p. 107, U.S. Pat. No. 4,683,327A, U.S. Pat. No. 5,622,648A, U.S. Pat. No. 5,770,107A, WO1995/22586A, WO1995/24455A, WO1997/00600A, WO1998/23580A, WO1998/52905A, JP1989-272551A (JP-H1-272551A), JP1994-16616A (JP-H6-16616A), JP1995-110469A (JP-H7-110469A), JP1999-80081A (JP-H11-80081A), and JP2001-64627A. Furthermore, as the rod-like liquid crystal compound, for example, compounds described in JP1999-513019A (JP-H11-513019A) and JP2007-279688A can also be preferably used.

### —Disk-Like Liquid Crystal Compound—

As the disk-like liquid crystal compound, for example, compounds described in JP2007-108732A, JP2010-244038A, and the like can be preferably used.

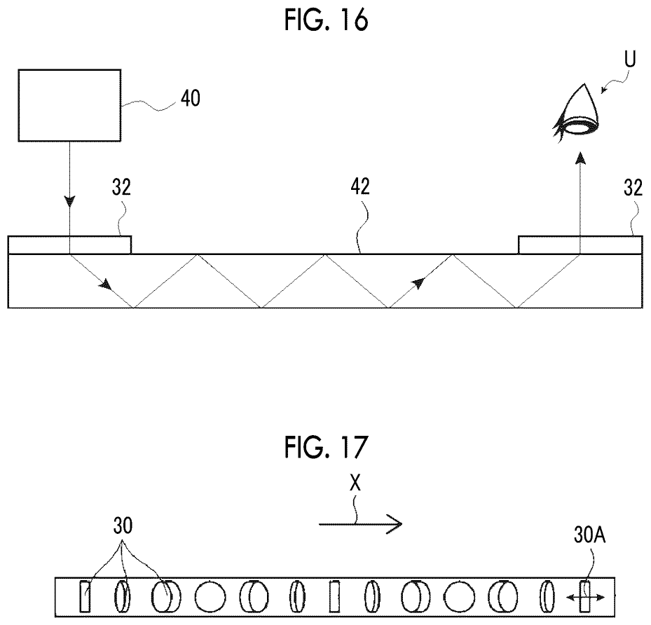

In a case where a disk-like liquid crystal compound is used in the optically anisotropic layer, the liquid crystal compound 30 rises in the thickness direction in the optically anisotropic layer, and the optical axis 30A derived from the liquid crystal compound is defined as an axis perpendicular to a disc plane, that is, a so-called fast axis (see FIG. 17).

### <Wavelength Selective Phase Difference Plate>

In the optical element 10 according to the embodiment of the present invention, the wavelength selective phase difference plate 18G is provided between the first optically anisotropic member 12 and the second optically anisotropic member 14.

In the optical element according to the embodiment of the present invention, the wavelength selective phase difference plate is a member which converts circularly polarized light in a specific wavelength range into circularly polarized light having an opposite turning direction. In the optical element according to the embodiment of the present invention, it is preferable that the λ/4 plates are provided on both sides of the wavelength selective phase difference plate as the other layers described above.

In the optical element of the example shown in the drawing, the wavelength selective phase difference plate 18G selectively converts green circularly polarized light into circularly polarized light having an opposite turning direction, converts green dextrorotatory circularly polarized light into green levorotatory circularly polarized light, converts green levorotatory circularly polarized light into green dextrorotatory circularly polarized light, and allows transmission (passage) of the other light in a state where a turning direction thereof is maintained.

In other words, the wavelength selective phase difference plate shifts only a phase in a specific wavelength range by π. The wavelength selective phase difference plate will also be referred to as, for example, a λ/2 plate which acts only in a specific wavelength range.

The wavelength selective phase difference plate is as described above.

### <Action of Optical Element>

As described above, the optically anisotropic layer which is formed of the composition containing a liquid crystal compound and has the liquid crystal alignment pattern in which the direction of the optical axis 30A rotates in the arrow X direction refracts circularly polarized light, in which a refraction angle varies depending on the wavelength of light. Specifically, as the wavelength of light increases, the refraction angle increases. Accordingly, for example, in a case where the incidence light is red light, green light, and blue light, the red light is refracted to the highest degree, and the blue light is refracted to the lowest degree.

Therefore, for example, in a light guide plate of AR glasses, in a case where the optical element which includes the optically anisotropic layer having the above-described liquid crystal alignment pattern in which the orientation of the optical axis 30A rotates is used as a diffraction element for incidence and emission of light into the light guide plate, in the case of a full color image, an image having a so-called color shift in which reflection directions of red light, green light, and blue light are different from each other and a red image, a green image, and a blue image do not match each other is observed.

Here, for example, as described in Bernard C. Kress et al., Towards the Ultimate Mixed Reality Experience: HoloLens Display Architecture Choices, SID 2017 DIGEST, pp. 127 to 131, the color shift can be eliminated by providing a light guide plate corresponding to each of a red image, a green image, and a blue image and laminating three light guide plates. However, in the configuration, the light guide plate is thick and heavy as a whole, and the configuration is also complicated.

On the other hand, in the optical element according to the embodiment of the present invention, a plurality of optically anisotropic layers are arranged, the wavelength selective phase difference plate is disposed between at least one pair of two optically anisotropic layers adjacent to each other among the arranged optically anisotropic layers, the optically anisotropic layer has the liquid crystal alignment pattern in which the orientation of the optical axis derived from the liquid crystal compound rotates in one direction, and a single period in the liquid crystal alignment pattern of at least one optically anisotropic layer is different from that of the other optically anisotropic layers.

With the optical element according to the embodiment of the present invention, the wavelength dependence of the refraction angle of light is significantly reduced, light components having different wavelengths can be refracted to be transmitted and emitted substantially in the same direction. Therefore, by using the optical element according to the embodiment of the present invention (for example, an optical element 32 described later) as a diffraction element for incidence of light from the light guide plate and/or as a diffraction element for emission of light into the light guide plate, for example, in AR glasses, a red image, a green image, and a blue image can be propagated by one light guide plate without the occurrence of a color shift, and as a result, an appropriate image can be displayed to a user.

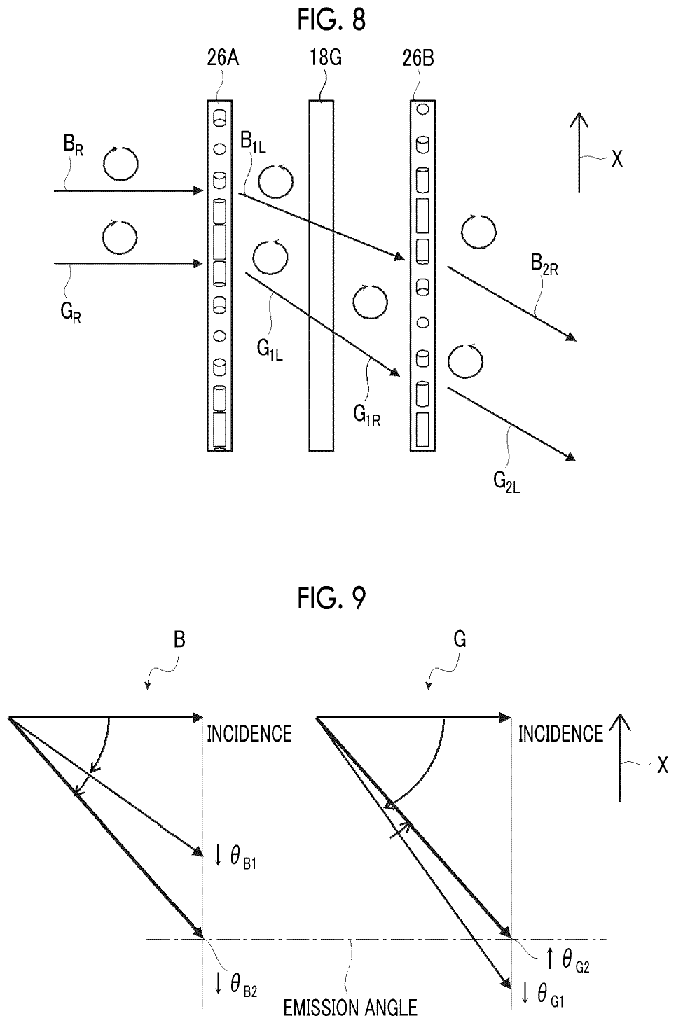

Hereinafter, the action of the optical element 10 will be described in detail with reference to the conceptual diagrams of FIGS. 8 and 9.

In the optical element according to the embodiment of the present invention, basically, only the optically anisotropic layer and the wavelength selective phase difference plate exhibit an optical action. Therefore, in order to simplify the drawing and to clarify the configuration and the effect, in FIG. 8 (and FIG. 11 described later), only the first optically anisotropic layer 26A and the second optically anisotropic layer 26B in the first optically anisotropic member 12 and the second optically anisotropic member 14 are shown, and the members shown in the drawing are spaced from each other in the arrangement direction.

As described above, in the optical element 10, the wavelength selective phase difference plate 18G which converts a turning direction of green circularly polarized light into an opposite direction is provided between the first optically anisotropic member 12 including the first optically anisotropic layer 26A and the second optically anisotropic member 14 including the second optically anisotropic layer 26B.

For example, the optical element 10 refracts incidence light to be transmitted in a predetermined direction, the incidence light including blue circularly polarized light and green circularly polarized light. In FIG. 8, the incidence light is dextrorotatory circularly polarized light, but even in a case where the incidence light is levorotatory circularly polarized light, the effect is the same except that the refraction direction is reversed.

In the optical element 10, in a case where green dextrorotatory circularly polarized light G_{R} and blue dextrorotatory circularly polarized light B_{R} (see the incidence ray L₄ in FIG. 7) are incident into the first optically anisotropic layer 26A, as described above, the green dextrorotatory circularly polarized light G_{R} and the blue dextrorotatory circularly polarized light B_{R} are refracted at a predetermined angle in a direction opposite to the arrow X direction with respect to the incidence direction, and are converted into green levorotatory circularly polarized light GIL and blue levorotatory circularly polarized light B_{1L} (see the transmitted ray L₅ in FIG. 7).

Here, as described above, since an angle of refraction of the first optically anisotropic layer 26A is larger for the green light having a longer wavelength, as shown in FIG. 9, an angle θ_{G1} of green light (G) is larger than an angle θ_{B1} of blue light (B) with respect to the incidence light. In addition, regarding the single period Λ of the optically anisotropic layer, since the single period Λ_{A} of the first optically anisotropic layer 26A is shorter, the refraction angle of each light transmitted through the first optically anisotropic layer 26A is larger than that of light transmitted through the second optically anisotropic layer 26B.

The green levorotatory circularly polarized light G_{1L} and the blue levorotatory circularly polarized light B_{1L}, which are transmitted through the first optically anisotropic layer 26A, are then incident into the wavelength selective phase difference plate 18G.

As described above, the wavelength selective phase difference plate 18G converts only the green circularly polarized light into circularly polarized light having an opposite turning direction, and allows transmission (passage) of the other light in a state where a turning direction thereof is maintained.

Accordingly, in a case where the green levorotatory circularly polarized light G_{1L} and the blue levorotatory circularly polarized light B_{1L} are incident into and transmitted through the wavelength selective phase difference plate 18G, the blue levorotatory circularly polarized light B_{1L} is transmitted as it is. On the other hand, the green levorotatory circularly polarized light G_{1L} is converted into green dextrorotatory circularly polarized light G_{1R}.

The green dextrorotatory circularly polarized light G_{1R} and the blue levorotatory circularly polarized light B_{1L}, which are transmitted through the wavelength selective phase difference plate 18G, are then incident into the second optically anisotropic layer 26B.

In the same manner, the green dextrorotatory circularly polarized light G_{1R} and the blue levorotatory circularly polarized light B_{1L}, which are incident into the second optically anisotropic layer 26B, are also refracted and converted into circularly polarized light having an opposite turning direction such that green levorotatory circularly polarized light G_{2L} and blue dextrorotatory circularly polarized light B_{2R} are emitted.

Here, turning directions of the green dextrorotatory circularly polarized light G_{1R} and the blue levorotatory circularly polarized light B_{1L}, which are incident into the second optically anisotropic layer 26B, are opposite to each other. In addition, as described above, the rotation directions of the optical axes 30A of the liquid crystal compounds 30 in the first optically anisotropic layer 26A and the second optically anisotropic layer 26B are opposite to each other.

Therefore, as shown in FIGS. 8 and 9, the blue levorotatory circularly polarized light B_{2L} is further refracted in a direction opposite to the arrow X direction, and emitted at an angle 0B2 with respect to the incidence light (the blue dextrorotatory circularly polarized light BR) as shown on the left side of FIG. 9.

On the other hand, the turning direction of the green dextrorotatory circularly polarized light G_{1R} is opposite to that of blue light. Therefore, as shown on the right side of FIG. 9, in the second optically anisotropic layer 26B, the light is refracted in the direction indicated by the arrow X which is opposite to that of the first optically anisotropic layer 26A, such that refraction returns to the original state. As a result, the green levorotatory circularly polarized light G_{2L} is emitted at an angle 0G2 which is smaller than the first angle θ_{G1} with respect to the incidence light (the green dextrorotatory circularly polarized light GR), and is almost the same as the angle 0B2 of the blue levorotatory circularly polarized light B_{2L}.

In this way, in the optical element 10 according to the embodiment of the present invention, green light having a long wavelength and large refraction by the optically anisotropic layer is refracted in a direction opposite to the arrow X direction in the first optically anisotropic layer 26A and then refracted in the arrow X direction in the second optically anisotropic layer 26B, such that refraction returns to the original state. On the other hand, blue light having a short wavelength and small refraction by the optically anisotropic layer is refracted in a direction opposite to the arrow X direction in the first optically anisotropic layer 26A and the second optically anisotropic layer 26B.

That is, in the optical element 10, in accordance with the magnitude of refraction by the optically anisotropic layer depending on the wavelength, light having large refraction and a long wavelength is initially refracted and then secondly refracted in an opposite direction, such that refraction returns to the original state. On the other hand, light having small refraction and a short wavelength is secondly refracted in the same direction as that the direction in which the light is initially refracted. As a result, the refraction angle θ_{G2} of green light and the refraction angle θ_{B2} of blue light with respect to the incidence light can be made to be very close to each other.

Therefore, in the optical element 10 according to the embodiment of the present invention, the incident blue light and green light can be refracted at substantially the same angle and emitted substantially in the same direction.

As described above, the refraction angles of light by the first optically anisotropic layer 26A and the second optically anisotropic layer 26B increase as the wavelength of light increases.

In addition, the refraction angles of light by the first optically anisotropic layer 26A and the second optically anisotropic layer 26B increase as the length of the single period A over which the orientation of optical axis 30A rotates by 180° in the arrow X direction in the liquid crystal alignment pattern decreases. In the optical element 10, for example, as shown in FIG. 3, the single period Λ_{A} of the liquid crystal alignment pattern in the first optically anisotropic layer 26A is shorter than the single period AB of the liquid crystal alignment pattern in the second optically anisotropic layer 26B. That is, in the first optically anisotropic layer 26A on the light incidence side, the light is largely refracted.

Accordingly, by adjusting the single period Λ of the liquid crystal alignment pattern with respect to the wavelength of light as a target, emission directions of light components having different wavelengths can be suitably made to be the same.

In a case where light components having two wavelength ranges are targets as in the optical element 10 of the example shown in the drawing, a designed wavelength of light having a longer wavelength is denoted by λa, a designed wavelength of light having a shorter wavelength is denoted by λb (λa>λb), the single period of the liquid crystal alignment pattern in the first optically anisotropic layer is denoted by λ1, and the single period of the liquid crystal alignment pattern in the second optically anisotropic layer is denoted by λ2, emission directions of the light components having two wavelength ranges can be made to be substantially the same by satisfying the following expression.

$${Λ}_{2} = [ ( λ a + λb ) / ( λ a - λ b ) ] {Λ}_{1}$$

In the expression, any one of the first optically anisotropic layer 26A or the second optically anisotropic layer 26B may be the first layer.

In consideration of this point, in the present invention, it is preferable that the following expression is satisfied in the optical element 10 in which the light components having two wavelengths (wavelength ranges) are targets.

$$0.6 * \{ [ ( λ a + λ b ) / ( λ a - λ b ) ] {Λ}_{1} \} \leq {Λ}_{2} \leq 3. * \{ [ ( λ a + λ b ) / ( λ a - λ b ) ] {Λ}_{1} \}$$

As a result, by significantly reducing the wavelength dependence of refraction, emission directions of the light components having two wavelength ranges can be made to be substantially the same.

In addition, in the present invention, for the light components having two wavelengths (wavelength ranges) as targets, it is more preferable that the optical element 10 satisfies the following expression,

$$0.7 * \{ [ ( λ a + λ b ) / ( λ a - λ b ) ] {Λ}_{1} \} \leq {Λ}_{2} \leq 1.8 * \{ [ ( λ a + λ b ) / ( λ a - λ b ) ] {Λ}_{1} \} ;$$

it is still more preferable to satisfy the following expression,

$$0.8 * \{ [ ( λ a + λ b ) / ( λ a - λ b ) ] {Λ}_{1} \} \leq {Λ}_{2} \leq 1.3 * \{ [ ( λ a + λ b ) / ( λ a - λ b ) ] {Λ}_{1} \} ;$$

it is particularly preferable to satisfy the following expression,

$$0.9 * \{ [ ( λ a + λ b ) / ( λ a - λ b ) ] {Λ}_{1} \} \leq {Λ}_{2} \leq 1.15 * \{ [ ( λ a + λ b ) / ( λ a - λ b ) ] {Λ}_{1} \} .$$

### Second Aspect of Optical Element

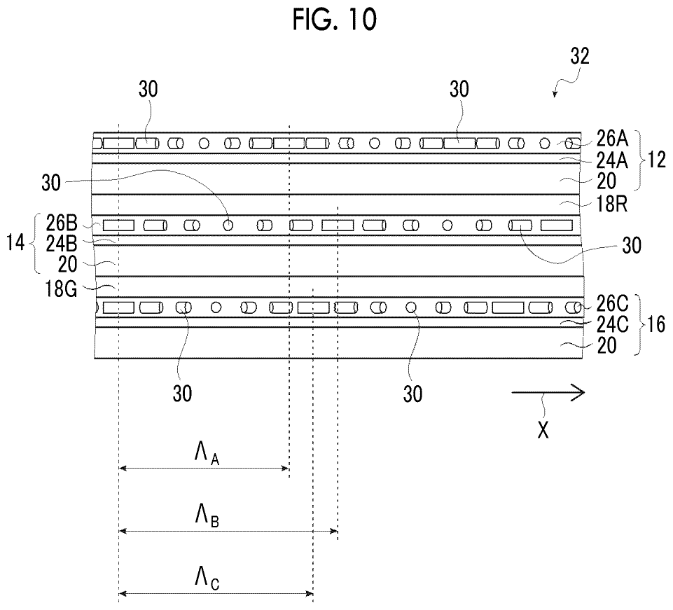

In the above-described optical element 10, the light components having two wavelength ranges (designed wavelengths), including green light and blue light, are targets; but the optical element according to the embodiment of the present invention is not limited thereto, and incidence light including light components having three or more wavelength ranges may be refracted and emitted. FIG. 10 shows an example of the optical element.

In an optical element 32 shown in FIG. 10, the same members as those of the optical element 10 shown in FIG. 1 are widely used, so that the same members are represented by the same reference numerals, and different members will be mainly described below.

The optical element 32 shown in FIG. 10 further includes a third optically anisotropic member 16 and a wavelength selective phase difference plate 18R, in addition to the first optically anisotropic member 12, the second optically anisotropic member 14, and the wavelength selective phase difference plate 18G of the above-described optical element 10.

The third optically anisotropic member 16 has the same configuration as that of the first optically anisotropic member 12 or the like, and includes a support 20, an alignment film 24C, and a third optically anisotropic layer 26C. The alignment film 24C and the third optically anisotropic layer 26C have the same configurations as those of the alignment film 24a and the first optically anisotropic layer 26A described above, except for the single period A.

In addition, the wavelength selective phase difference plate 18R selectively converts red circularly polarized light into circularly polarized light having an opposite turning direction, converts red dextrorotatory circularly polarized light into red levorotatory circularly polarized light, converts red levorotatory circularly polarized light into red dextrorotatory circularly polarized light, and allows transmission of the other light as it is.

In the optical element 32, rotation directions of optical axes 30A of liquid crystal compounds 30 of the first optically anisotropic layer 26A and the third optically anisotropic layer 26C in the arrow X direction are the same as each other, and a rotation direction of an optical axis 30A of a liquid crystal compound 30 of the second optically anisotropic layer 26B in the arrow X direction is opposite to the rotation directions of the other two optically anisotropic layers.

In addition, in the optical element 32, regarding the length of the single period κ, over which the optical axis 30A of the liquid crystal compound 30 rotates by 180° in the arrow X direction in the liquid crystal alignment pattern, the single period Λ_{A} of the first optically anisotropic layer 26A is the shortest, and the single period AB of the second optically anisotropic layer 26B is the longest. In the optical element 32, the first optically anisotropic member 12 side is the light incidence side. That is, in the optical element 32, light is refracted to the highest degree in the first optically anisotropic layer 26A on the light incidence side.

Furthermore, in the optical element 32, the wavelength selective phase difference plate 18R which selectively converts a turning direction of red circularly polarized light is disposed between the first optically anisotropic member 12 (the first optically anisotropic layer 26A) and the second optically anisotropic member 14 (the second optically anisotropic layer 26B). In addition, in the optical element 32, the wavelength selective phase difference plate 18G which selectively converts a turning direction of green circularly polarized light is disposed between the second optically anisotropic member 14 and the third optically anisotropic member 16 (the third optically anisotropic layer 26C).

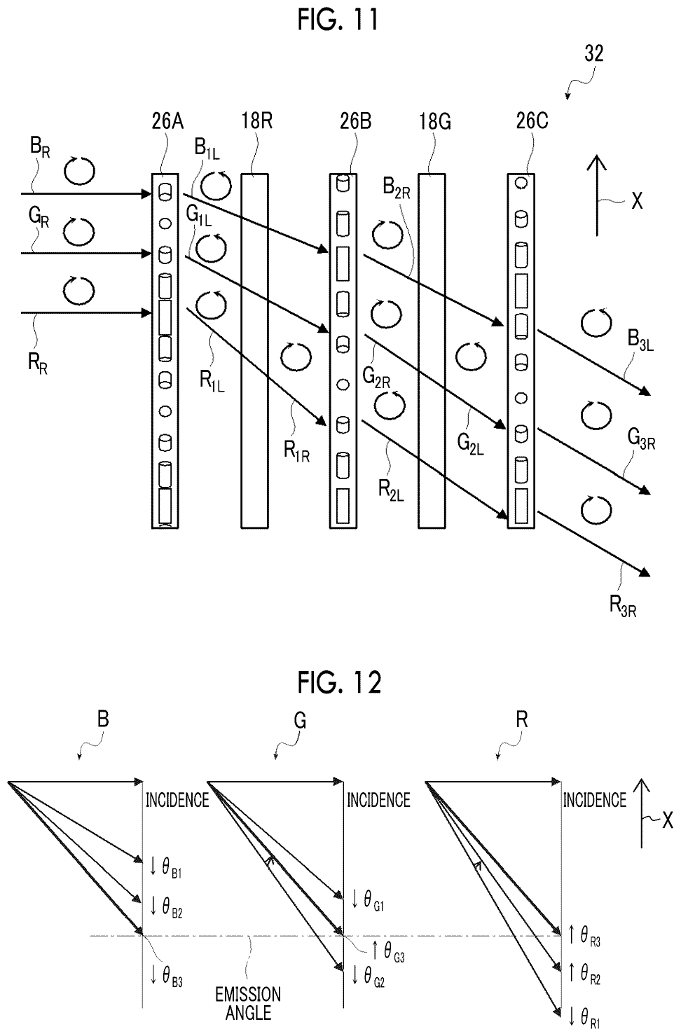

Hereinafter, the action of the optical element 32 will be described in detail with reference to FIGS. 11 and 12.

For example, the optical element 32 refracts incidence light to be transmitted in a predetermined direction, the incidence light including red circularly polarized light, green circularly polarized light, and blue circularly polarized light. In FIG. 11, same as in FIG. 8 described above, the incidence light is dextrorotatory circularly polarized light, but even in a case where the incidence light is levorotatory circularly polarized light, the effect is the same except that the refraction direction is reversed.

In the optical element 10, in a case where red dextrorotatory circularly polarized light R_{R}, green dextrorotatory circularly polarized light G_{R}, and blue dextrorotatory circularly polarized light B_{R} (see the incidence ray L₄ in FIG. 7) are incident into the first optically anisotropic layer 26A, as described above, the red dextrorotatory circularly polarized light R_{R}, the green dextrorotatory circularly polarized light G_{R}, and the blue dextrorotatory circularly polarized light B_{R} are refracted at a predetermined angle in a direction opposite to the arrow X direction with respect to the incidence direction, and are converted into red levorotatory circularly polarized light R_{1L}, green levorotatory circularly polarized light G_{1L}, and blue levorotatory circularly polarized light B_{1L} (see the transmitted ray L₅ in FIG. 7).

Here, as described above, regarding the refraction angle by the first optically anisotropic layer 26A, the angle of red light having the longest wavelength is the largest, and the angle of blue light having the shortest wavelength is the smallest. Accordingly, regarding the refraction angle with respect to the incidence light, as shown in FIG. 12, an angle θ_{R1} of red light (R) is the largest, an angle θ_{G1} of green light (G) is intermediate, and an angle θ_{B1} of blue light (B) is the smallest. Regarding the single period Λ of the optically anisotropic layer, since the single period Λ_{A} of the first optically anisotropic layer 26A is the shortest, the refraction angle of each light is the largest in a case of light transmitted through the first optically anisotropic layer 26A.

The red levorotatory circularly polarized light R_{1L}, the green levorotatory circularly polarized light G_{1L}, and the blue levorotatory circularly polarized light B_{1L}, which are transmitted through the first optically anisotropic layer 26A, are then incident into the wavelength selective phase difference plate 18R.

As described above, the wavelength selective phase difference plate 18R converts only the red circularly polarized light into circularly polarized light having an opposite turning direction, and allows transmission (passage) of the other light as it is.

Accordingly, in a case where the red levorotatory circularly polarized light R_{1L}, the green levorotatory circularly polarized light G_{1L}, and the blue levorotatory circularly polarized light B_{1L} are incident into and transmitted through the wavelength selective phase difference plate 18R, the green levorotatory circularly polarized light G_{1L} and the blue levorotatory circularly polarized light B_{1L} are transmitted as they are. On the other hand, the red levorotatory circularly polarized light R_{1L} is converted into red dextrorotatory circularly polarized light R_{1R}.

The red dextrorotatory circularly polarized light R_{1R}, the green levorotatory circularly polarized light G_{1L}, and the blue levorotatory circularly polarized light B_{1L}, which are transmitted through the wavelength selective phase difference plate 18R, are then incident into the second optically anisotropic layer 26B.

In the same manner, the red dextrorotatory circularly polarized light R_{1R}, the green levorotatory circularly polarized light G_{1L}, and the blue levorotatory circularly polarized light B_{1L}, which are incident into the second optically anisotropic layer 26B, are also refracted and converted into circularly polarized light having an opposite turning direction such that red levorotatory circularly polarized light R_{2L}, green dextrorotatory circularly polarized light G_{2R}, and blue dextrorotatory circularly polarized light B_{2R} are emitted.

Here, the green light and the blue light incident into the second optically anisotropic layer 26B are levorotatory circularly polarized light. On the other hand, the red light incident into the second optically anisotropic layer 26B is dextrorotatory circularly polarized light in which a direction of circularly polarized light is converted by the wavelength selective phase difference plate 18R and different from that of the green light and the blue light.

In addition, as described above, the rotation directions of the optical axes 30A of the liquid crystal compounds 30 in the first optically anisotropic layer 26A and the second optically anisotropic layer 26B are opposite to each other.

Therefore, as shown in FIGS. 11 and 12, the green levorotatory circularly polarized light G_{2L} and the blue levorotatory circularly polarized light B_{2L} incident into the second optically anisotropic layer 26B are further refracted in a direction opposite to the arrow X direction, and are emitted at an angle θ_{G2} and an angle θ_{B2} with respect to the incidence light (the green dextrorotatory circularly polarized light G_{R} and the blue dextrorotatory circularly polarized light B_{R}) as shown in FIG. 12.

On the other hand, the red dextrorotatory circularly polarized light R_{1R} having a direction of circularly polarized light opposite to that of circularly polarized light incident into the second optically anisotropic layer 26B is refracted in the arrow X direction which is opposite to that of the first optically anisotropic layer 26A, such that refraction returns to the original state as shown on the right side of FIG. 12. As a result, the red levorotatory circularly polarized light R_{2L} emitted from the second optically anisotropic layer 26B is emitted at an angle θ_{R2} which is smaller than the angle θ_{R1} with respect to the incidence light (the red dextrorotatory circularly polarized light RR).

Regarding the single period Λ of the optically anisotropic layer, since the single period Λ_{B} of the second optically anisotropic layer 26B is the largest, the refraction angle of each light is the shortest in a case of light transmitted through the second optically anisotropic layer 26B.

The red levorotatory circularly polarized light R_{2L}, the green dextrorotatory circularly polarized light G_{2R}, and the blue dextrorotatory circularly polarized light B_{2R}, which are transmitted through the second optically anisotropic layer 26B, are then incident into the wavelength selective phase difference plate 18G.

As described above, the wavelength selective phase difference plate 18G converts only the green circularly polarized light into circularly polarized light having an opposite turning direction, and allows transmission of the other light as it is.

Accordingly, in a case where the red levorotatory circularly polarized light R_{2L}, the green dextrorotatory circularly polarized light G_{2R}, and the blue dextrorotatory circularly polarized light B_{2R} are incident into and transmitted through the wavelength selective phase difference plate 18G, the red levorotatory circularly polarized light R_{2L} and the blue dextrorotatory circularly polarized light B_{2R} are transmitted as they are. On the other hand, the green dextrorotatory circularly polarized light G_{2R} is converted into green levorotatory circularly polarized light G_{2L}.

The red levorotatory circularly polarized light R_{2L}, the green levorotatory circularly polarized light G_{2L}, and the blue dextrorotatory circularly polarized light B_{2R}, which are transmitted through the wavelength selective phase difference plate 18G, are then incident into the third optically anisotropic layer 26C.

In the same manner, the red levorotatory circularly polarized light R_{2L}, the green levorotatory circularly polarized light G_{2L}, and the blue dextrorotatory circularly polarized light B_{2R}, which are incident into the third optically anisotropic layer 26C, are also refracted and converted into circularly polarized light having an opposite turning direction such that red dextrorotatory circularly polarized light R_{3R}, green dextrorotatory circularly polarized light G3R, and blue levorotatory circularly polarized light B_{3L} are emitted.

Here, the blue light incident into the third optically anisotropic layer 26C is the blue dextrorotatory circularly polarized light B_{2R}. In addition, since the direction of circularly polarized light of the red light is previously converted by the wavelength selective phase difference plate 18R, the red light incident into the third optically anisotropic layer 26C is the red levorotatory circularly polarized light R_{2L} having a direction of circularly polarized light which is different from that of blue light. Furthermore, the green light incident into the third optically anisotropic layer 26C is the green levorotatory circularly polarized light G_{2L} having a direction of circularly polarized light, which is converted by the wavelength selective phase difference plate 18G.

That is, the blue light incident into the third optically anisotropic layer 26C is dextrorotatory circularly polarized light, and the red light and the green light incident into the third optically anisotropic layer 26C are levorotatory circularly polarized light having a direction of circularly polarized light, which is converted by the wavelength selective phase difference plate.

In addition, as described above, the rotation directions of the optical axes 30A of the liquid crystal compounds 30 in the second optically anisotropic layer 26B and the third optically anisotropic layer 26C are opposite to each other.

Therefore, as shown in FIGS. 11 and 12, the blue dextrorotatory circularly polarized light B_{2R} incident in the third optically anisotropic layer 26C is further refracted in a direction opposite to the arrow X direction, and emitted at an angle θ_{B3} with respect to the incidence light (the blue dextrorotatory circularly polarized light BR) as shown in FIG. 12.

On the other hand, in a case where the red levorotatory circularly polarized light R_{2L} having an opposite direction of circularly polarized light is incident into the third optically anisotropic layer 26C, the red levorotatory circularly polarized light R_{2L} is further refracted to return to the arrow X direction. As a result, the red dextrorotatory circularly polarized light R_{3R} emitted from the third optically anisotropic layer 26C is emitted at an angle θ_{R3} which is smaller than the angle θ_{R2} with respect to the incidence light (the red dextrorotatory circularly polarized light R_{R}).

Similarly, in a case where the green levorotatory circularly polarized light G_{2L} having a circular polarization opposite to that of the blue light is incident into the third optically anisotropic layer 26C, as shown in the center of FIG. 11, the green levorotatory circularly polarized light G_{2L} is refracted to return to the arrow X in a direction opposite to the previous direction. As a result, the green dextrorotatory circularly polarized light G_{3R} emitted from the third optically anisotropic layer 26C is emitted at an angle θ_{G3} which is smaller than the angle θ_{G2} with respect to the incidence light (the green dextrorotatory circularly polarized light G_{R}).

That is, in the optical element 32, the red light having the longest wavelength and the largest refraction by the optically anisotropic layer is refracted in a direction opposite to the arrow X direction by the first optically anisotropic layer 26A, and then refracted twice in a direction opposite to the arrow X direction by the second optically anisotropic layer 26B and the third optically anisotropic layer 26C.

In addition, the green light having the second longest wavelength and the second largest refraction by the optically anisotropic layer is refracted in a direction opposite to the arrow X direction by the first optically anisotropic layer 26A and the second optically anisotropic layer 26B, and then refracted once in the opposite arrow X direction by the third optically anisotropic layer 26C.

Furthermore, the blue light having the shortest wavelength and the smallest refraction by the optically anisotropic layer is refracted three times in a direction opposite the opposite arrow X direction by the first optically anisotropic layer 26A, the second optically anisotropic layer 26B, and the third optically anisotropic layer 26C.

In this way, in the optical element 32 according to the embodiment of the present invention, initially, all the light components are largely refracted in the same direction. Thereafter, in accordance with the magnitude of refraction by the optically anisotropic layer depending on the wavelength, the light having the longest wavelength is refracted the most multiple times so as to return to a direction opposite to the initial refraction direction. As the wavelength decreases, the number of times of refraction which returns to the direction opposite to the initial refraction direction is reduced. Regarding the light having the shortest wavelength, the number of times of refraction which returns to the direction opposite to the initial refraction direction is the smallest. As a result, the refraction angle θ_{R3} of red light, the refraction angle θ_{G3} of green light, and the refraction angle θ_{B3} of blue light with respect to the incidence light can be made to be very close to each other.

Therefore, in the optical element 32 according to the embodiment of the present invention, the incident red light, blue light, and green light can be refracted at substantially the same angle and emitted substantially in the same direction.

In a case where light components having three wavelength ranges are targets as in the optical element 32 of the example shown in the drawing, a designed wavelength of light having the longest wavelength is denoted by λa, a designed wavelength of light having the intermediate wavelength is denoted by λb, a designed wavelength of light having the shortest wavelength is denoted by λc (λa>λb>λc), the single period of the liquid crystal alignment pattern in the first optically anisotropic layer is denoted by Λ₁, the single period of the liquid crystal alignment pattern in the second optically anisotropic layer is denoted by Λ₂, and the single period of the liquid crystal alignment pattern in the third optically anisotropic layer is denoted by Λ₃, emission directions of light components having two wavelength ranges can be made to be substantially the same by satisfying the following expressions.

$$\begin{matrix}{Λ}_{2} = [ ( λ a + λ c ) λ b / ( λ a - λ b ) λ c ] {Λ}_{1} , \\ {Λ}_{3} = [ ( λ a + λ c ) λ b / ( λ b - λc ) λ a ] {Λ}_{1}\end{matrix}$$

In the expression, any one of the first optically anisotropic layer 26A or the third optically anisotropic layer 26C may be the first layer.

In consideration of this point, in the present invention, it is preferable that at least one of the following expressions is satisfied in the optical element 32 in which the light components having three wavelengths (wavelength ranges) are targets, and it is more preferable to satisfy both the following two expressions.

$$\begin{matrix}0.6 * [ ( λ a + λ c ) λ b / ( λ a - λ b ) ] λ c ] {Λ}_{1} \leq {Λ}_{2} \leq 3. * \{ [ ( λ a + λ c ) λ b / ( λ a - λ b ) λ c ] {Λ}_{1} \} \\ 0.6 * [ ( λ a + λ c ) λ b / ( λ b - λ c ) ] λ a ] {Λ}_{1} \leq {Λ}_{3} \leq 3. * \{ [ ( λ a + λ c ) λ b / ( λ b - λ c ) λ a ] {Λ}_{1} \}\end{matrix}$$

As a result, by significantly reducing the wavelength dependence of refraction, emission directions of the light components having two wavelength ranges can be made to be substantially the same.

In addition, in the present invention, for the light components having three wavelengths (wavelength ranges) as targets, it is more preferable that the optical element 32 satisfies the following two expressions,

$$\begin{matrix}0.7 * [ ( λ a + λ c ) λ b / ( λ a - λ b ) ] λ c ] {Λ}_{1} \leq {Λ}_{2} \leq 1.8 * \{ [ ( λ a + λ c ) λ b / ( λ a - λ b ) λ c ] {Λ}_{1} \} , \\ 0.7 * [ ( λ a + λ c ) λ b / ( λ b - λ c ) ] λ a ] {Λ}_{1} \leq {Λ}_{3} \leq 1.8 * \{ [ ( λ a + λ c ) λ b / ( λ b - λ c ) λ a ] {Λ}_{1} \} ;\end{matrix}$$

it is still more preferable to satisfy the following two expressions,

$$\begin{matrix}0.8 * [ ( λ a + λ c ) λ b / ( λ a - λ b ) λ c ] {Λ}_{1} \leq {Λ}_{2} \leq 1.3 * \{ [ ( λ a + λ c ) λ b / ( λ a - λ b ) λ c ] {Λ}_{1} \} , \\ 0.8 * [ ( λ a + λ c ) λ b / ( λ b - λ c ) λ a ] {Λ}_{1} \leq {Λ}_{3} \leq 1.3 * \{ [ ( λ a + λ c ) λ b / ( λ b - λ c ) λ a ] {Λ}_{1} \} ;\end{matrix}$$

and
it is particularly preferable to satisfy the following two expressions,

$$\begin{matrix}0.9 * [ ( λ a + λ c ) λ b / ( λ a - λ b ) λ c ] {Λ}_{1} \leq {Λ}_{2} \leq 1.15 * \{ [ ( λ a + λ c ) λ b / ( λ a - λ b ) λ c ] {Λ}_{1} \} \\ 0.9 * [ ( λ a + λ c ) λ b / ( λ b - λ c ) λ a ] {Λ}_{1} \leq {Λ}_{3} \leq 1.15 * \{ [ ( λ a + λ c ) λ b / ( λ b - λ c ) λ a ] {Λ}_{1} \} .\end{matrix}$$

In the optical element according to the embodiment of the present invention, as described above, a plurality of optically anisotropic layers are arranged, and depending on the wavelength of light, light having a long wavelength and large refraction by the optically anisotropic layer is refracted in a direction opposite to the initial optically anisotropic layer a large number of times. As a result, light components having different wavelengths can be refracted substantially at the same angle substantially in the same direction.

Therefore, in a case where the optical element according to the embodiment of the present invention includes a plurality of wavelength selective phase difference plates, as in the optical element 32 shown in FIGS. 10 and 11, in the wavelength selective phase difference plates, it is preferable that a wavelength range of light having a turning direction of circularly polarized light which is converted into an opposite turning direction gradually becomes shorter in the arrangement direction of the optically anisotropic layers.

In addition, in the optical element according to the embodiment of the present invention, in a case where the refraction by the initial optically anisotropic layer is set to be large, the light is gradually refracted subsequently in the same direction and the refraction gradually returns to the original state in the opposite direction, and thus the refraction of each light is easily controlled and is easily made to be uniform. In consideration of this point, as in the optical element 32 shown in FIGS. 10 and 11, it is preferable that the single period Λ in the liquid crystal alignment pattern of the optically anisotropic layer positioned at the most distant position in the arrangement direction is the shortest. That is, it is preferable that the refraction by the optically anisotropic layer positioned at the most distant position in the arrangement direction is the largest.

In the optical element according to the embodiment of the present invention, the single period Λ in the liquid crystal alignment pattern of the optically anisotropic layer may gradually increase in the arrangement direction of the optically anisotropic layers. Alternatively, as in the optical element 32 shown in FIGS. 10 and 11, a change in the single period Λ in the liquid crystal alignment pattern of the optically anisotropic layer may be irregular in the arrangement direction of the optically anisotropic layers; for example, a configuration in which an optically anisotropic layer having an intermediate length of the single period Λ in the liquid crystal alignment pattern is provided between an optically anisotropic layer having the longest single period Λ in the liquid crystal alignment pattern and an optically anisotropic layer having the shortest single period Λ in the liquid crystal alignment pattern. That is, in the optical element according to the embodiment of the present invention, the single period Λ in the liquid crystal alignment pattern of each optically anisotropic layer may be appropriately set depending on the wavelength of light and the refractive index of the optically anisotropic layer.

In a case where the optical element according to the embodiment of the present invention includes a plurality of wavelength selective phase difference plates, basically, the optically anisotropic layers and the wavelength selective phase difference plates are alternately arranged as in the optical element 32 shown in FIGS. 10 and 11. In this case, it is preferable that the number of the wavelength selective phase difference plates is less than the number of the optically anisotropic layers by one.

However, the present invention is not limited to the configuration, and for example, a plurality of optically anisotropic layers may be continuously arranged such that the light continuously refracted by the plurality of optically anisotropic layers is incident into the wavelength selective phase difference plate.

In addition, a plurality of wavelength selective phase difference plates may be arranged between two optically anisotropic layers. However, in a case where a plurality of wavelength selective phase difference plates which convert circularly polarized light having the same wavelength range into circularly polarized light having an opposite turning direction are arranged between two optically anisotropic layers, it is preferable that the number of the wavelength selective phase difference plates is an odd number.

In the optical element according to the embodiment of the present invention, optically anisotropic layers having the same single period Λ of the liquid crystal alignment pattern may be present.

However, from the viewpoint that refraction, that is, emission angles of light components having a plurality of wavelength ranges can be easily made to be uniform, it is preferable that all the optically anisotropic layers have different single periods A of the liquid crystal alignment patterns.

In the optical element according to the embodiment of the present invention, the single period Λ in the alignment pattern of the optically anisotropic layer is not particularly limited and may be appropriately set depending on the application of the optical element and the like.

The optical element according to the embodiment of the present invention may include a wavelength selective phase difference plate which selectively converts circularly polarized light having the shortest designed wavelength into circularly polarized light having an opposite turning direction. For example, a third wavelength selective phase difference plate B which selectively converts blue circularly polarized light into circularly polarized light having an opposite turning direction may be disposed behind the third optically anisotropic layer 26C (on the downstream side in a traveling direction of the light).

As described above, the third wavelength selective phase difference plate B converts only the blue circularly polarized light into circularly polarized light having an opposite turning direction, and allows transmission of the other light as it is.

Accordingly, in a case where the red dextrorotatory circularly polarized light R_{3R}, the green dextrorotatory circularly polarized light G_{3R}, and the blue levorotatory circularly polarized light B_{3L} are incident into and transmitted through the third wavelength selective phase difference plate B, the red dextrorotatory circularly polarized light R_{3R} and the green dextrorotatory circularly polarized light G_{3R} are transmitted as they are. On the other hand, the blue levorotatory circularly polarized light B_{3L} is converted into blue dextrorotatory circularly polarized light B_{3R}.

As a result, circularly polarized light components of blue light, green light, and red light, emitted from the optical element, can be made to have the same turning direction.

Here, the optical element according to the embodiment of the present invention can be suitably used as, for example, a diffraction element which refracts light displayed by a display to be introduced into a light guide plate or a diffraction element which refracts light propagated in a light guide plate to be emitted to an observation position by a user from the light guide plate in AR glasses. In particular, the optical element 32 which can handle with a full color image can be suitably used as a diffraction element in AR glasses.

In this case, in order to totally reflect light from the light guide plate, it is necessary to refract light to be introduced into the light guide plate at a large angle to some degree with respect to incidence light. In addition, in order to reliably emit light propagated in the light guide plate, it is necessary to refract light at a large angle to some degree with respect to the incidence light.

In addition, as described above, regarding a transmission angle of the light through the optically anisotropic layer, the angle of transmitted light with respect to the incidence light can be increased by reducing the single period Λ in the liquid crystal alignment pattern.

In consideration of this point, the single period Λ in the liquid crystal alignment pattern of the optically anisotropic layer is preferably 50 μm or less, more preferably 10 μm or less, and still more preferably 3 μm or less.

In consideration of the accuracy of the liquid crystal alignment pattern, and the like, the single period Λ in the liquid crystal alignment pattern of the optically anisotropic layer is preferably 0.1 μm or more.

In the optical elements shown in FIGS. 3 to 12, the optical axis 30A of the liquid crystal compound 30 in the liquid crystal alignment pattern of the optically anisotropic layer continuously rotates only in the arrow X direction.

However, the present invention is not limited thereto, and various configurations can be used as long as the optical axis 30A of the liquid crystal compound 30 in the optically anisotropic layer continuously rotates in one direction.

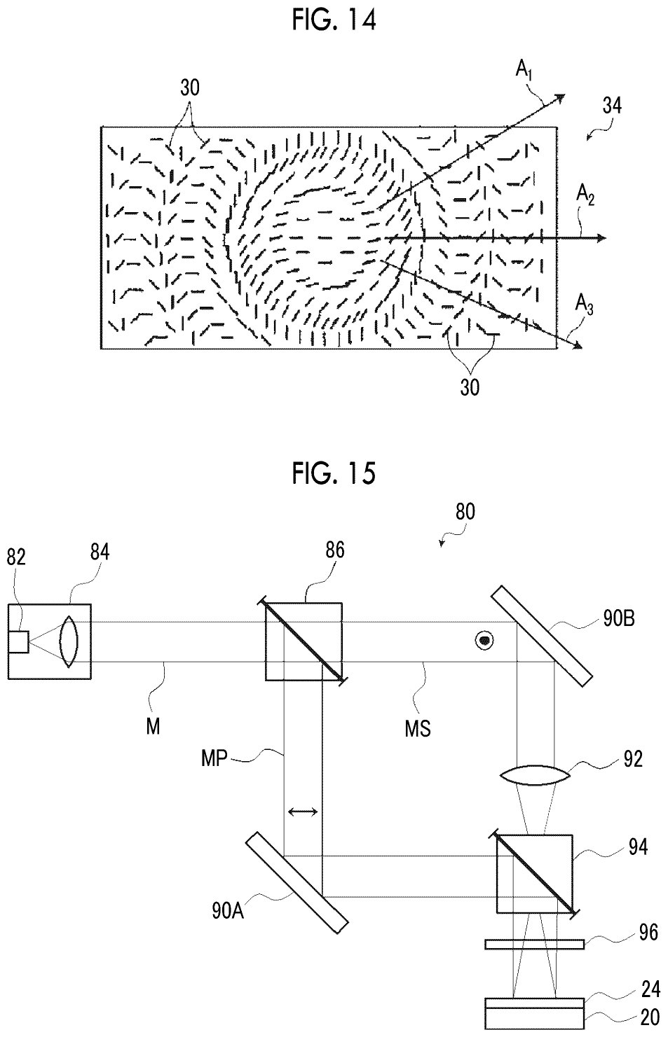

Examples thereof include an optically anisotropic layer 34 conceptually shown in a plan view of FIG. 14, in which a liquid crystal alignment pattern is a concentric circular pattern having a concentric circular shape where one in-plane direction in which the orientation of the optical axis of the liquid crystal compound 30 changes while continuously rotating moves from an inner side toward an outer side. In other words, the liquid crystal alignment pattern of the optically anisotropic layer 34 shown in FIG. 14 is a liquid crystal alignment pattern which has the one direction in which the orientation of the optical axis of the liquid crystal compound 30 changes while continuously rotating, in a radial shape from the center of the optically anisotropic layer 34.

FIG. 14 shows only the liquid crystal compound 30 in the surface of the alignment film as in FIG. 6; but as shown in FIG. 4, the optically anisotropic layer 34 has the structure in which the liquid crystal compound 30 in the surface of the alignment film is stacked as described above.

Furthermore, in FIG. 14, only one optically anisotropic layer 34 is shown, but the optical element according to the embodiment of the present invention includes a plurality of optically anisotropic layers and includes the wavelength selective phase difference plate between at least one pair of the two optically anisotropic layers as described above. Accordingly, even in a case where the optical element includes the optically anisotropic layer having the concentric circular liquid crystal alignment pattern, for example, as in the optical element 32 shown in FIG. 10, the optical element has a configuration in which a first optically anisotropic layer, a wavelength selective phase difference plate which converts red circularly polarized light, a second optically anisotropic layer, a wavelength selective phase difference plate which converts green circularly polarized light, and a third optically anisotropic layer are arranged.

In the optically anisotropic layer 34 shown in FIG. 14, the optical axis (not shown) of the liquid crystal compound 30 is a longitudinal direction of the liquid crystal compound 30.

In the optically anisotropic layer 34, the orientation of the optical axis of the liquid crystal compound 30 changes while continuously rotating in a direction in which a large number of optical axes move to the outer side from the center of the optically anisotropic layer 34, such as the direction indicated by the arrow A1, the direction indicated by the arrow A2, and the direction indicated by the arrow A3.

In circularly polarized light incident into the optically anisotropic layer 34 having the liquid crystal alignment pattern, the absolute phase changes depending on individual local regions having different orientations of optical axes of the liquid crystal compound 30. In this case, the amount of change in absolute phase varies depending on the orientations of the optical axes of the liquid crystal compound 30 into which circularly polarized light is incident.

In this way, in the optically anisotropic layer 34 having the concentric circular liquid crystal alignment pattern, that is, the liquid crystal alignment pattern in which the optical axis changes rotationally in a radial shape, transmission of incidence light can be allowed as diverging light or converging light depending on the rotation direction of the optical axis of the liquid crystal compound 30 and the direction of circularly polarized light to be incident.

That is, by setting the liquid crystal alignment pattern of the optically anisotropic layer in a concentric circular shape, the optical element according to the embodiment of the present invention exhibits, for example, a function as a convex lens or a concave lens.

Here, in a case where the liquid crystal alignment pattern of the optically anisotropic layer is concentric circular such that the optical element functions as a convex lens, it is preferable that the length of the single period Λ over which the optical axis rotates 180° in the liquid crystal alignment pattern gradually decreases from the center of the optically anisotropic layer 34 toward the outer direction of the one direction in which the optical axis continuously rotates.

As described above, the refraction angle of light with respect to an incidence direction increases as the length of the single period Λ in the liquid crystal alignment pattern decreases. Accordingly, the length of the single period Λ in the liquid crystal alignment pattern gradually decreases from the center of the optically anisotropic layer 34 toward the outer direction of the one direction in which the optical axis continuously rotates. As a result, the light gathering power of the optically anisotropic layer 34 can be improved, and the performance as a convex lens can be improved.

In the present invention, depending on the application of the optical element such as a concave lens, it is preferable that the length of the single period Λ over which the optical axis rotates by 180° in the liquid crystal alignment pattern gradually decreases from the center of the optically anisotropic layer 34 toward the outer direction of the one direction by reversing the direction in which the optical axis continuously rotates.

As described above, the refraction angle of light with respect to an incidence direction increases as the length of the single period Λ in the liquid crystal alignment pattern decreases. Accordingly, the length of the single period Λ in the liquid crystal alignment pattern gradually decreases from the center of the optically anisotropic layer 34 toward the outer direction of the one direction in which the optical axis continuously rotates. As a result, the light diverging power of the optically anisotropic layer 34 can be improved, and the performance as a concave lens can be improved.

In the present invention, for example, in a case where the optical element is used as a concave lens, it is preferable that the turning direction of incident circularly polarized light is reversed.

In the present invention, in a case where the optical element is to function as a convex lens or a concave lens, it is preferable that the optical element satisfies the following expression.

$$Φ ( r ) = ( π / λ ) [ {( {r}^{2} + {f}^{2} )}^{1 / 2} - f ]$$

Here, r represents a distance from the center of a concentric circle and is represented by an expression “r=(x²+y²)^{1/2}”. x and y represent in-plane positions, and (x,y)=(0,0) represents the center of the concentric circle. Φ(r) represents an angle of the optical axis at the distance r from the center, λ represents a wavelength, and f represents a designed focal length.

In the present invention, conversely, the length of the single period Λ in the concentric circular liquid crystal alignment pattern may gradually increase from the center of the optically anisotropic layer 34 toward the outer direction of the one direction in which the optical axis continuously rotates.

Furthermore, depending on the uses of the optical element such as a case where it is desired to provide a light amount distribution in the transmitted light, a configuration in which regions having partially different lengths of the single periods A in the one direction in which the optical axis continuously rotates are provided can also be used instead of the configuration in which the length of the single period Λ gradually changes in the one direction in which the optical axis continuously rotates.

Furthermore, the optical element according to the embodiment of the present invention may include an optically anisotropic layer in which the single period Λ is uniform over the entire surface, and an optically anisotropic layer in which regions having different lengths of the single periods A are provided. This point is also applicable to a configuration in which the optical axis continuously rotates only in the one in-plane direction as shown in FIG. 3.

FIG. 15 conceptually shows an example of an exposure device which forms the concentric circular alignment pattern in the alignment film (for example, the alignment film 24A, the alignment film 24B, and the alignment film 24C).

An exposure device 80 includes a light source 84 which includes a laser 82, a polarization beam splitter 86 which splits a laser light M emitted from the laser 82 into an S-polarized light MS and a P-polarized light MP, a mirror 90A which is disposed on an optical path of the P-polarized light MP and a mirror 90B which is disposed on an optical path of the S-polarized light MS, a lens 92 which is disposed on the optical path of the S-polarized light MS, a polarization beam splitter 94, and a λ/4 plate 96.

The P-polarized light MP which is split by the polarization beam splitter 86 is reflected from the mirror 90A to be incident into the polarization beam splitter 94. On the other hand, the S-polarized light MS which is split by the polarization beam splitter 86 is reflected from the mirror 90B and is condensed by the lens 92 to be incident into the polarization beam splitter 94.

The P polarized light MP and the S polarized light MS are combined by the polarization beam splitter 94, are converted into dextrorotatory circularly polarized light and levorotatory circularly polarized light by the λ/4 plate 96 depending on the polarization direction, and are incident into the alignment film 24 on the support 20.

Due to interference between the dextrorotatory circularly polarized light and the levorotatory circularly polarized light, the polarization state of light with which the alignment film 24 is irradiated periodically changes according to interference fringes. An intersecting angle between dextrorotatory circularly polarized light and levorotatory circularly polarized light changes from the inside to the outside of the concentric circle, so that an exposure pattern in which the pitch changes from the inner side toward the outer side can be obtained. As a result, in the alignment film 24, a concentric circular alignment pattern in which the alignment state periodically changes can be obtained.

In the exposure device 80, the single period Λ of the liquid crystal alignment pattern in which the optical axis of the liquid crystal compound 30 continuously rotates by 180° in the one direction can be controlled by changing a focal power of the lens 92 (F number of the lens 92), the focal length of the lens 92, the distance between the lens 92 and the alignment film 24, and the like.

In addition, by adjusting the focal power of the lens 92 (F number of the lens 92), the length Λ of the single period of the liquid crystal alignment pattern in which the optical axis continuously rotates in the one direction can be changed.

Specifically, the length A of the single period in the liquid crystal alignment pattern in which the optical axis continuously rotates in the one direction can be changed depending on a light spread angle at which light is spread by the lens 92 due to interference with parallel light. More specifically, in a case where the focal power of the lens 92 is decreased, the light is close to the parallel light, so that the length A of the single period in the liquid crystal alignment pattern is gradually decreased from the inner side toward the outer side, and the F-number is increased. Conversely, in a case where the focal power of the lens 92 is stronger, the length A of the single period in the liquid crystal alignment pattern rapidly decreases from the inner side toward the outer side, and the F number is decreased.

In this way, the configuration of changing the length of the single period Λ over which the optical axis rotates 180° in the one direction in which the optical axis continuously rotates can also be used in the configuration shown in FIGS. 3 to 12 in which the optical axis 30A of the liquid crystal compound 30 continuously rotates only in the one direction of the arrow X direction.

For example, by gradually decreasing the single period Λ of the liquid crystal alignment pattern in arrow X direction, an optical element which transmits light so as to be condensed can be obtained. In addition, by reversing the direction over which the optical axis in the liquid crystal alignment pattern rotates 180°, an optical element which transmits light so as to be diffused only in arrow X direction can be obtained. By reversing the turning direction of incident circularly polarized light, an optical element which allows transmission of light to be diffused only in the arrow X direction can be obtained.

Furthermore, depending on the uses of the optical element such as a case where it is desired to provide a light amount distribution in the transmitted light, a configuration in which regions having partially different lengths of the single periods Λ in arrow X direction are provided can also be used instead of the configuration in which the length of the single period Λ gradually changes in arrow X direction. For example, as a method of partially changing the single period Λ, a method of scanning and exposing the photo-alignment film to be patterned while freely changing a polarization direction of laser light to be condensed can be used.

The optical element according to the embodiment of the present invention can be used for various uses where transmission of light in a direction different from an incidence direction is allowed, for example, an optical path changing member, a light condensing element, a light diffusing element to a predetermined direction, a diffraction element, or the like in an optical device.

In a preferred example, as conceptually shown in FIG. 16, the optical element can be used as a diffraction element which is provided to be spaced from a light guide plate 42 such that, in the above-described AR glasses, light (projection image) emitted from a display 40 is guided to the light guide plate 42 at a sufficient angle for total reflection and the light propagated in the light guide plate 42 is emitted from the light guide plate 42 to an observation position by a user U in the AR glasses. FIG. 16 shows the optical element 32 shown in FIG. 10 corresponding to a full color image, but for example, in a case where a two-color image is displayed in the AR glasses, the optical element 10 shown in FIG. 3 can also be suitably used.

As described above, in the optical element according to the embodiment of the present invention, the angle dependence of the refraction angle during transmission is small, so that red light, green light, and blue light emitted from the display 40 can be refracted in the same direction. Therefore, with one light guide plate 42, even in a case where red image, green image, and blue image are propagated, a full color image having no color shift can be emitted from the light guide plate to the observation position by the user U in the AR glasses. Accordingly, in a light guide element using the optical element according to the embodiment of the present invention, the light guide plate of the AR glasses can be made thin and light as a whole, and the configuration of the AR glasses can be simplified.

The light guide element according to the embodiment of the present invention is not limited to the configuration in which two optical elements according to the embodiment of the present invention spaced from each other are provided in the light guide plate 42 as shown in FIG. 16, and a configuration may be adopted in which only one optical element according to the embodiment of the present invention is provided in the light guide plate 42 for introduction or extraction of light into or from the light guide plate 42.

In the above-described examples, the optical element according to the embodiment of the present invention is used as the optical element which includes two or three optically anisotropic layers and allows transmission of two light components including green light and blue light or three light components including red light, green light, and blue light to refract the light components; but the present invention is not limited thereto, and various configurations can be used.

For example, the optical element according to the embodiment of the present invention may have a configuration in which three optically anisotropic layers and two wavelength selective phase difference plates are provided as in FIG. 1, and transmission of not only two light components selected from red light, green light, and blue light but also infrared light or ultraviolet light is allowed to refract the light components. Alternatively, the optical element according to the embodiment of the present invention may have a configuration in which four or five (or six or more) optically anisotropic layers and three or four (the number of optically anisotropic layers-one) wavelength selective phase difference plates are provided, and infrared light and/or ultraviolet light is transmitted and refracted in addition to the red light, green light, and blue light. Alternatively, the optical element according to the embodiment of the present invention may have a configuration in which two optically anisotropic layers and one wavelength selective phase difference plate are provided as in FIG. 1, and transmission of red light and blue light or transmission of red light and green light is allowed to refract the light components, or a configuration in which not only one light component selected from red light, green light, and blue light but also infrared light and ultraviolet light are refracted to be transmitted. In addition, the optical element according to the embodiment of the present invention may have a configuration in which infrared light and/or ultraviolet light is refracted to be transmitted.

### EXAMPLES

Hereinafter, the present invention will be described in more detail with reference to Examples.

The materials, the amounts of materials used, the proportions, the treatment details, the treatment procedure, and the like shown in Examples below may be modified as appropriate as long as the modifications do not depart from the spirit of the present invention. Therefore, the scope of the present invention should not be construed as being limited to Examples shown below.

### Comparative Example 1

### <Production of Wavelength Selective Phase Difference Plate>

### (Support)

A glass substrate was used as a support.

### (Formation of Alignment Film)

The following coating liquid for forming an alignment film was applied onto the support by spin coating. The support on which the coating film of the alignment film-forming coating liquid was formed was dried using a hot plate at 60° C. for 60 seconds. As a result, an alignment film was formed.

Alignment film-forming coating liquid

| | |
|---|---|
| Material A for photo-alignment | 1.00 part by mass |
| Water | 16.00 parts by mass |
| Butoxyethanol | 42.00 parts by mass |
| Propylene glycol monomethyl ether | 42.00 parts by mass |

-Material A for photo-alignment-

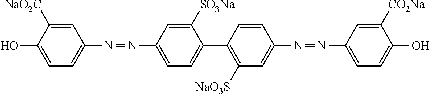

### (Exposure of Alignment Film)

The obtained alignment film was exposed to polarized ultraviolet rays (50 mJ/cm², using an ultra-high pressure mercury lamp) to form an alignment film P-1.

### (Production of Wavelength Plate A1)

As a composition of a rod-like liquid crystal compound forming a wavelength plate, the following composition A-1 was prepared.

Composition A-1

| | |
|---|---|
| Rod-like liquid crystal compound L-1 | 100.00 parts by mass |
| Photopolymerization initiator B | 1.00 part by mass |
| Surfactant F1 shown below | 0.057 parts by mass |
| Surfactant F2 shown below | 0.143 parts by mass |
| Methyl ethyl ketone | 161.5 parts by mass |
| Cyclohexanone | 28.5 parts by mass |

Rod-like liquid crystal compound L-1 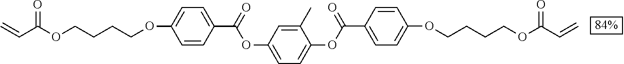 [SMILES: C=CC(=O)OCCCCOc1ccc(C(=O)Oc2ccc(OC(=O)c3ccc(OCCCCOC(=O)C=C)cc3)c(C)c2)cc1] 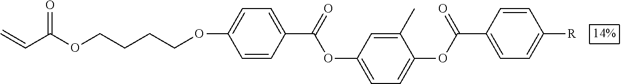 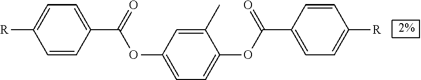 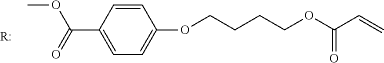
Photopolymerization initiator B 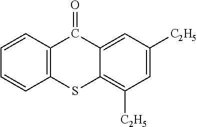 [SMILES: CCc1cc(CC)c2sc3ccccc3c(=O)c2c1]
Surfactant F1 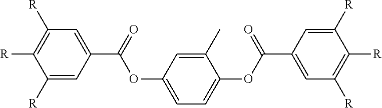 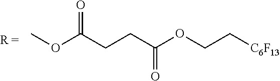
Surfactant F2

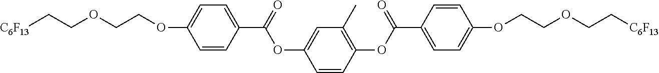

A wavelength plate was formed by applying the above-described composition A-1 onto the alignment film P-1.

The coated film was heated on a hot plate at 110° C. Thereafter, alignment of the rod-like liquid crystal compound was fixed by irradiating the coated film with light from a metal halide lamp at 100° C., an illuminance of 80 mW/cm², and an irradiation amount of 500mJ/cm² in a low oxygen atmosphere (100 ppm or less). In this manner, a wavelength plate A1 was obtained.

Re(725) of the obtained wavelength plate A1 at a wavelength λ=725 nm was 725 nm. In addition, an Nz factor of the produced wavelength plate A1 was 1.0 at 550 nm. Re(725) was measured using Axoscan manufactured by Axometrix, Inc., and the Nz factor was measured by changing an incidence angle in a plane parallel to a slow axis and a fast axis of the wavelength plate by+40° (in increments of) 5°. (Production of wavelength plate A2)

A wavelength plate A2 was obtained in the same manner as in the production of the wavelength plate A1, except that the film thickness of the coating film of the composition A-1was changed.

Re(725) of the obtained wavelength plate A2 at a wavelength λ=725 nm was 1,450nm. In addition, an Nz factor of the produced wavelength plate A2 was 1.0 at 550 nm. The wavelength plate A1 and the wavelength plate A2 were laminated so as to have a layer configuration shown in Table 2 below. In addition, during the lamination, the layers were sequentially laminated after peeling off the support and the alignment film. As a result, a first wavelength selective phase difference plate which converted green linearly polarized light into linearly polarized light orthogonal to the linearly polarized light and did not change a phase of linearly polarized light in other wavelength ranges was produced.

The angles shown in Table 2 are angles of the slow axis orientation with respect to the vibration direction of the linearly polarized light, and in a case of being viewed from a side opposite to the incident side of the incident linearly polarized light, clockwise rotation is indicated as a negative value and counterclockwise rotation is indicated as a positive value. The same applies to tables showing the configuration of the wavelength selective phase difference plate in Examples and Comparative Examples.

TABLE 2

| | | Wavelength | | | Slow axis | |
|---|---|---|---|---|---|---|
| Layer | Wavelength | λ | Re(λ) | | orientation | |
| number | plate | [nm] | [nm] | Re(450)/Re(550) | [°] | Nz factor |
| 1 | A1 | 725 | 725 | 1.09 | −45 | 1.0 |
| 2 | A2 | 725 | 1450 | 1.09 | 77 | 1.0 |
| 3 | A2 | 725 | 1450 | 1.09 | −80 | 1.0 |

### Example 1

### <Production of Wavelength Selective Phase Difference Plate>

### (Formation of Alignment Film)

An alignment film P-1 was formed on the support in the same manner as in Comparative Example 1.

### (Production of Wavelength Plate B1)

An optically anisotropic layer B1-1 was produced in the same manner as in the production of the wavelength plate A1 of Comparative Example 1, except that the film thickness of the coating film of the rod-like liquid crystal compound was adjusted. Re(725) of the obtained optically anisotropic layer B1-1 at a wavelength λ=725 nm was 362.5 nm. In addition, an Nz factor of the produced optically anisotropic layer B1-1 was 1.0 at 550 nm.

In addition, as a composition of a disk-like liquid crystal forming a wavelength plate B1, the following composition B-1 was prepared.

Composition B-1

| | |
|---|---|
| Disk-like liquid crystal (A) shown below | 80 parts by mass |
| Disk-like liquid crystal (B) shown below | 20 parts by mass |
| Polymerizable monomer E1 | 10 parts by mass |
| Surfactant F4 | 0.3 parts by mass |
| Photopolymerization initiator (manufactured by BASF, IRGACURE 907) | 3 parts by mass |
| Methyl ethyl ketone | 290 parts by mass |
| Cyclohexanone | 50 parts by mass |

Disk-like liquid crystal (A) 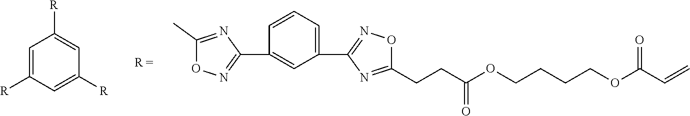
Disk-like liquid crystal (B) 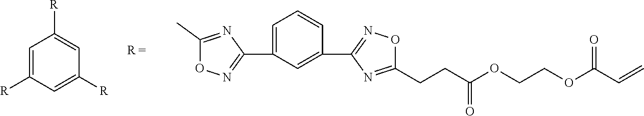
Polymerizable monomer E1 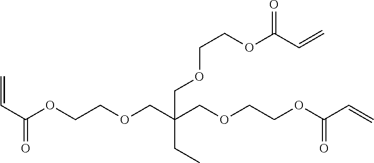 [SMILES: C=CC(=O)OCCOCC(CC)(COCCOC(=O)C=C)COCCOC(=O)C=C]
Surfactant F4 (the symbol assigned to each repeating unit indicatess a mass-based content of each repeating unit)

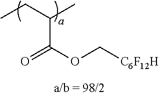

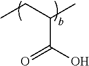

The wavelength plate B1 was formed by applying the above-described composition B-1 onto the optically anisotropic layer B1-1.

Specifically, the surface of the optically anisotropic layer B1-1 was subjected to a corona treatment at a discharge amount of 150 W·min/m², and then the composition B-1 was applied onto the surface subjected to the corona treatment. Subsequently, the coating film was dried at 70° C. for 2 minutes, the solvent was vaporized, and then the coating film was heat-aged at 115° C. for 3 minutes. Thereafter, the coating film was held at 45° C. and then irradiated with ultraviolet rays (300 mJ/cm²) using a metal halide lamp in a nitrogen atmosphere for curing, thereby fixing the alignment of the disk-like liquid crystal compound.

In this manner, the wavelength plate B1 was obtained.

Re(725) of the obtained wavelength plate B1 at a wavelength λ=725 nm was 725 nm. In addition, an Nz factor of the produced wavelength plate B1 was 0.5 at 550 nm.

In addition, Re(725) of the optically anisotropic layer B1-2, which was formed of the composition B-1 containing a disk-like liquid crystal compound on the optically anisotropic layer B1-1, at a wavelength λ=725 nm was 362.5 nm. In addition, an Nz factor of the produced optically anisotropic layer B1-2 was 0 at 550 nm.

### (Production of Wavelength Plate B2)

An optically anisotropic layer B2-1 formed of a rod-like liquid crystal compound, an optically anisotropic layer B2-2 formed of a disk-like liquid crystal compound, and a wavelength plate B2 which was a laminate of the optically anisotropic layers were obtained in the same manner as in the production of the wavelength plate B1, except that the film thicknesses of the coating films of the rod-like liquid crystal compound and the disk-like liquid crystal compound were changed.

Re(725) of the obtained optically anisotropic layer B2-1 at a wavelength λ=725 nm was 725 nm. In addition, an Nz factor of the produced optically anisotropic layer B2-1 was 1.0 at 550 nm.

Re(725) of the obtained optically anisotropic layer B2-2 at a wavelength λ=725 nm was 725 nm. In addition, an Nz factor of the produced optically anisotropic layer B2-2 was 0.

Re(725) of the obtained wavelength plate B2 at a wavelength λ=725 nm was 1,450 nm. In addition, an Nz factor of the produced wavelength plate B2 was 0.5 at 550 nm.

The wavelength plate B1 and the wavelength plate B2 were laminated so as to have a layer configuration shown in Table 3 below. In addition, during the lamination, the layers were sequentially laminated after peeling off the support and the alignment film. As a result, a second wavelength selective phase difference plate which converted green linearly polarized light into linearly polarized light orthogonal to the linearly polarized light and did not change a phase of linearly polarized light in other wavelength ranges was produced.

TABLE 3

| | Optically | Wavelength | | | Slow axis | | |
|---|---|---|---|---|---|---|---|
| Layer | anisotropic | λ | Re(λ) | | orientation | | Total Nz |
| number | layer | [nm] | [nm] | Re(450)/Re(550) | [°] | Nz factor | factor |
| 1 | B1-1 | 725 | 362.5 | 1.09 | −45 | 1.0 | 0.5 |
| | B1-2 | 725 | 362.5 | 1.09 | −45 | 0.0 | |
| 2 | B2-1 | 725 | 725 | 1.09 | 77 | 1.0 | 0.5 |
| | B2-2 | 725 | 725 | 1.09 | 77 | 0.0 | |
| 3 | B2-1 | 725 | 725 | 1.09 | −80 | 1.0 | 0.5 |
| | B2-2 | 725 | 725 | 1.09 | −80 | 0.0 | |

### Comparative Example 2

### <Production of Wavelength Selective Phase Difference Plate>

Wavelength plates C1 and C2 were produced in the same manner as in the production of the wavelength selective phase difference plate of Comparative Example 1, except that the film thickness of the coating film of the rod-like liquid crystal compound was adjusted.

Re(490) of the obtained wavelength plate C1 at a wavelength λ=490 nm was 490 nm. In addition, an Nz factor of the produced wavelength plate C1 was 1.0 at 650 nm.

Re(490) of the obtained wavelength plate C2 at a wavelength λ=490 nm was 980 nm. In addition, an Nz factor of the produced wavelength plate C2 was 1.0 at 650 nm.

The wavelength plate C1 and the wavelength plate C2 were laminated so as to have a layer configuration shown in Table 4 below. In addition, during the lamination, the layers were sequentially laminated after peeling off the support and the alignment film. As a result, a third wavelength selective phase difference plate which converted red linearly polarized light into linearly polarized light orthogonal to the linearly polarized light and did not change a phase of linearly polarized light in other wavelength ranges was produced.

TABLE 4

| | | Wavelength | | | Slow axis | |
|---|---|---|---|---|---|---|
| Layer | Wavelength | λ | Re(λ) | | orientation | |
| number | plate | [nm] | [nm] | Re(450)/Re(550) | [°] | Nz factor |
| 1 | C1 | 490 | 490 | 1.09 | 45 | 1.0 |
| 2 | C2 | 490 | 980 | 1.09 | −13 | 1.0 |
| 3 | C2 | 490 | 980 | 1.09 | 10 | 1.0 |

### Example 2

### <Production of Wavelength Selective Phase Difference Plate>

Optically anisotropic layers D1-1 and D1-2 were sequentially produced in the same manner as in the production of the wavelength selective phase difference plate of Example 1, except that the film thicknesses of the coating films of the rod-like liquid crystal compound and the disk-like liquid crystal compound were adjusted, thereby obtaining a wavelength plate D1. In addition, optically anisotropic layers D2-1 and D2-2 were sequentially produced to obtain a wavelength plate D2.

Re(490) of the obtained optically anisotropic layer D1-1 at a wavelength λ=490 nm was 245 nm. In addition, an Nz factor of the produced optically anisotropic layer D1-1 was 1.0 at 650 nm.

Re(490) of the obtained optically anisotropic layer D1-2 at a wavelength λ=490 nm was 245 nm. In addition, an Nz factor of the produced optically anisotropic layer D1-2 was 0 at 650 nm.

Re(490) of the obtained wavelength plate D1 at a wavelength λ=490 nm was 490 nm. In addition, an Nz factor of the produced wavelength D1 was 0.5 at 650 nm.

Re(490) of the obtained optically anisotropic layer D2-1 at a wavelength λ=490 nm was 490 nm. In addition, an Nz factor of the produced optically anisotropic layer D2-1 was 1.0 at 650 nm.

Re(490) of the obtained optically anisotropic layer D2-2 at a wavelength λ=490 nm was 490 nm. In addition, an Nz factor of the produced optically anisotropic layer D2-2 was 0 at 650 nm.

Re(490) of the obtained wavelength plate D2 at a wavelength λ=490 nm was 980 nm. In addition, an Nz factor of the produced wavelength D2 was 0.5 at 650 nm.

The wavelength plate D1 and the wavelength plate D2 were laminated so as to have a layer configuration shown in Table 5 below. In addition, during the lamination, the layers were sequentially laminated after peeling off the support and the alignment film. As a result, a fourth wavelength selective phase difference plate which converted red linearly polarized light into linearly polarized light orthogonal to the linearly polarized light and did not change a phase of linearly polarized light in other wavelength ranges was produced.

TABLE 5

| | Optically | Wavelength | | | Slow axis | | |
|---|---|---|---|---|---|---|---|
| Layer | anisotropic | λ | Re(λ) | | orientation | | Total Nz |
| number | layer | [nm] | [nm] | Re(450)/Re(550) | [°] | Nz factor | factor |
| 1 | D1-1 | 490 | 245 | 1.09 | 45 | 1.0 | 0.5 |
| | D1-2 | 490 | 245 | 1.09 | 45 | 0.0 | |
| 2 | D2-1 | 490 | 490 | 1.09 | −13 | 1.0 | 0.5 |
| | D2-2 | 490 | 490 | 1.09 | −13 | 0.0 | |
| 3 | D2-1 | 490 | 490 | 1.09 | 10 | 1.0 | 0.5 |
| | D2-2 | 490 | 490 | 1.09 | 10 | 0.0 | |

### Comparative Example 3

### <Production of Wavelength Selective Phase Difference Plate>

The wavelength plate A1 and the wavelength plate A2 produced in Comparative Example 1 were laminated so as to have a layer configuration shown in Table 6 below. In addition, during the lamination, the layers were sequentially laminated after peeling off the support and the alignment film. As a result, a fifth wavelength selective phase difference plate which converted green linearly polarized light into linearly polarized light orthogonal to the linearly polarized light and did not change a phase of linearly polarized light in other wavelength ranges was produced.

TABLE 6

| | | Wavelength | | | Slow axis | |
|---|---|---|---|---|---|---|
| Layer | Wavelength | λ | Re(λ) | | orientation | |
| number | plate | [nm] | [nm] | Re(450)/Re(550) | [°] | Nz factor |
| 1 | A1 | 725 | 725 | 1.09 | −45 | 1.0 |
| 2 | A2 | 725 | 1450 | 1.09 | 74 | 1.0 |
| 3 | A2 | 725 | 1450 | 1.09 | −76 | 1.0 |
| 4 | A2 | 725 | 1450 | 1.09 | 86 | 1.0 |
| 5 | A2 | 725 | 1450 | 1.09 | −82 | 1.0 |
| 6 | A2 | 725 | 1450 | 1.09 | 90 | 1.0 |
| 7 | A2 | 725 | 1450 | 1.09 | −84 | 1.0 |
| 8 | A2 | 725 | 1450 | 1.09 | −89 | 1.0 |
| 9 | A2 | 725 | 1450 | 1.09 | −85 | 1.0 |

### Example 3

### <Production of Wavelength Selective Phase Difference Plate>

The wavelength plate B1 and the wavelength plate B2 produced in Example 1 were laminated so as to have a layer configuration shown in Table 7 below. In addition, during the lamination, the layers were sequentially laminated after peeling off the support and the alignment film. As a result, a sixth wavelength selective phase difference plate which converted green linearly polarized light into linearly polarized light orthogonal to the linearly polarized light and did not change a phase of linearly polarized light in other wavelength ranges was produced.

TABLE 7

| | Optically | Wavelength | | | Slow axis | | |
|---|---|---|---|---|---|---|---|
| Layer | anisotropic | λ | Re(λ) | | orientation | | Total Nz |
| number | layer | [nm] | [nm] | Re(450)/Re(550) | [°] | Nz factor | factor |
| 1 | B1-1 | 725 | 362.5 | 1.09 | −45 | 1.0 | 0.5 |
| | B1-2 | 725 | 362.5 | 1.09 | −45 | 0.0 | |
| 2 | B2-1 | 725 | 725 | 1.09 | 74 | 1.0 | 0.5 |
| | B2-2 | 725 | 725 | 1.09 | 74 | 0.0 | |
| 3 | B2-1 | 725 | 725 | 1.09 | −76 | 1.0 | 0.5 |
| | B2-2 | 725 | 725 | 1.09 | −76 | 0.0 | |
| 4 | B2-1 | 725 | 725 | 1.09 | 86 | 1.0 | 0.5 |
| | B2-2 | 725 | 725 | 1.09 | 86 | 0.0 | |
| 5 | B2-1 | 725 | 725 | 1.09 | −82 | 1.0 | 0.5 |
| | B2-2 | 725 | 725 | 1.09 | −82 | 0.0 | |
| 6 | B2-1 | 725 | 725 | 1.09 | 90 | 1.0 | 0.5 |
| | B2-2 | 725 | 725 | 1.09 | 90 | 0.0 | |
| 7 | B2-1 | 725 | 725 | 1.09 | −84 | 1.0 | 0.5 |
| | B2-2 | 725 | 725 | 1.09 | −84 | 0.0 | |
| 8 | B2-1 | 725 | 725 | 1.09 | −89 | 1.0 | 0.5 |
| | B2-2 | 725 | 725 | 1.09 | −89 | 0.0 | |
| 9 | B2-1 | 725 | 725 | 1.09 | −85 | 1.0 | 0.5 |
| | B2-2 | 725 | 725 | 1.09 | −85 | 0.0 | |

### Comparative Example 4

### <Production of Wavelength Selective Phase Difference Plate>

The wavelength plate Cl and the wavelength plate C2 produced in Comparative Example 2 were laminated so as to have a layer configuration shown in Table 8 below. In addition, during the lamination, the layers were sequentially laminated after peeling off the support and the alignment film. As a result, a seventh wavelength selective phase difference plate which converted red linearly polarized light into linearly polarized light orthogonal to the linearly polarized light and did not change a phase of linearly polarized light in other wavelength ranges was produced.

TABLE 8

| | | Wavelength | | | Slow axis | |
|---|---|---|---|---|---|---|
| Layer | Wavelength | λ | Re(λ) | | orientation | |
| number | plate | [nm] | [nm] | Re(450)/Re(550) | [°] | Nz factor |
| 1 | C1 | 490 | 490 | 1.09 | 45 | 1.0 |
| 2 | C2 | 490 | 980 | 1.09 | −16 | 1.0 |
| 3 | C2 | 490 | 980 | 1.09 | 15 | 1.0 |
| 4 | C2 | 490 | 980 | 1.09 | −4 | 1.0 |
| 5 | C2 | 490 | 980 | 1.09 | 9 | 1.0 |
| 6 | C2 | 490 | 980 | 1.09 | 0 | 1.0 |
| 7 | C2 | 490 | 980 | 1.09 | 6 | 1.0 |
| 8 | C2 | 490 | 980 | 1.09 | 2 | 1.0 |
| 9 | C2 | 490 | 980 | 1.09 | 5 | 1.0 |

### Example 4

### <Production of Wavelength Selective Phase Difference Plate>

The wavelength plate D1 and the wavelength plate D2 produced in Example 2 were laminated so as to have a layer configuration shown in Table 9 below. In addition, during the lamination, the layers were sequentially laminated after peeling off the support and the alignment film. As a result, an eighth wavelength selective phase difference plate which converted red linearly polarized light into linearly polarized light orthogonal to the linearly polarized light and did not change a phase of linearly polarized light in other wavelength ranges was produced.

TABLE 9

| | Optically | Wavelength | | | Slow axis | | |
|---|---|---|---|---|---|---|---|
| Layer | anisotropic | λ | Re(λ) | | orientation | | Total Nz |
| number | layer | [nm] | [nm] | Re(450)/Re(550) | [°] | Nz factor | factor |
| 1 | D1-1 | 490 | 245 | 1.09 | 45 | 1.0 | 0.5 |
| | D1-2 | 490 | 245 | 1.09 | 45 | 0.0 | |
| 2 | D2-1 | 490 | 490 | 1.09 | −16 | 1.0 | 0.5 |
| | D2-2 | 490 | 490 | 1.09 | −16 | 0.0 | |
| 3 | D2-1 | 490 | 490 | 1.09 | 15 | 1.0 | 0.5 |
| | D2-2 | 490 | 490 | 1.09 | 15 | 0.0 | |
| 4 | D2-1 | 490 | 490 | 1.09 | −4 | 1.0 | 0.5 |
| | D2-2 | 490 | 490 | 1.09 | −4 | 0.0 | |
| 5 | D2-1 | 490 | 490 | 1.09 | 9 | 1.0 | 0.5 |
| | D2-2 | 490 | 490 | 1.09 | 9 | 0.0 | |
| 6 | D2-1 | 490 | 490 | 1.09 | 0 | 1.0 | 0.5 |
| | D2-2 | 490 | 490 | 1.09 | 0 | 0.0 | |
| 7 | D2-1 | 490 | 490 | 1.09 | 6 | 1.0 | 0.5 |
| | D2-2 | 490 | 490 | 1.09 | 6 | 0.0 | |
| 8 | D2-1 | 490 | 490 | 1.09 | 2 | 1.0 | 0.5 |
| | D2-2 | 490 | 490 | 1.09 | 2 | 0.0 | |
| 9 | D2-1 | 490 | 490 | 1.09 | 5 | 1.0 | 0.5 |
| | D2-2 | 490 | 490 | 1.09 | 5 | 0.0 | |

### Evaluation of Wavelength Selective Phase Difference Plate

The produced wavelength selective phase difference plates of Examples and Comparative Examples were interposed between two linearly polarizing plates, and phase difference properties with respect to linearly polarized light were evaluated. The two linearly polarizing plates were disposed such that transmission axes were orthogonal to each other, and linearly polarized light having an azimuthal angle of 0° was incident on the first retardation layer of the wavelength selective phase difference plate.

In the above-described arrangement, first, unpolarized light was incident from the front surface (direction with an angle of 0° with respect to the normal line) of the wavelength selective phase difference plate arranged between the linearly polarizing plates, and an intensity of emitted light was measured with a photodetector. In addition, the orientation of only the wavelength selective phase difference plate disposed between the linearly polarizing plates was adjusted such that the linearly polarized light was incident into the wavelength selective phase difference plate at an azimuthal angle of 0° and a polar angle of 40°, and an intensity of emitted light was measured with a photodetector in the same manner.

In a case where the intensity of emitted light from the wavelength selective phase difference plate disposed between the above-described linearly polarizing plates was denoted by Iout, and the intensity of emitted light in a state in which the transmission axes of the two linearly polarizing plates were arranged in parallel and the wavelength selective phase difference plate was removed was denoted by Ipara, a transmittance was calculated from the following expression.

$$Transmittance = Iout / Ipara$$

As the transmittance of light having a certain wavelength is higher, the wavelength selective phase difference plate functions as a λ/2 phase difference plate; and as the transmittance is lower, the wavelength selective phase difference plate does not function as a λ/2 phase difference plate.

Light having wavelengths of 450 nm, 532 nm, and 650 nm was incident on the wavelength selective phase difference plates produced in Comparative Examples 1 to 4 and Examples 1 to 4, and the transmittance (phase difference properties with respect to linearly polarized light) at each wavelength was evaluated.

In a case where light was incident from the front surface, the wavelength selective phase difference plates of Comparative Example 1 and Example 1 had a high transmittance (≥80%) at a wavelength of 532 nm and had an equivalent λ/2 phase difference function. In addition, the transmittance at wavelengths of 450 nm and 650 nm was low (≤10%), and the phase difference function was almost not exhibited. That is, it was confirmed that the wavelength selective phase difference plates of Comparative Example 1 and Example 1 functioned as the wavelength selective phase difference plate in a case where light was incident from the front direction.

In a case where light was incident at a polar angle of 40°, the wavelength selective phase difference plate of Example 1 had a high transmittance at a wavelength of 532 nm and an excellent λ/2 phase difference function, as compared with the wavelength selective phase difference plate of Comparative Example 1. In addition, at wavelengths of 450 nm and 650 nm, the wavelength selective phase difference plate of Example 1 had a low transmittance and excellent wavelength selectivity as compared with the wavelength selective phase difference plate of Comparative Example 1. That is, it was confirmed that the wavelength selective phase difference plate of Example 1 had a small difference between the phase difference generated in a case where light was incident from the front direction and the phase difference generated in a case where light was incident from the oblique direction.

In a case where light was incident from the front surface, the wavelength selective phase difference plates of Comparative Example 2 and Example 2 had a high transmittance (>80%) at a wavelength of 650 nm and had an equivalent λ/2 phase difference function. In addition, the transmittance at wavelengths of 450 nm and 532 nm was low (≤10%), and the phase difference function was almost not exhibited. That is, it was confirmed that the wavelength selective phase difference plates of Comparative Example 1 and Example 1 functioned as the wavelength selective phase difference plate in a case where light was incident from the front direction.

In a case where light was incident at an oblique angle of 40°, the wavelength selective phase difference plate of Example 2 had a high transmittance at a wavelength of 650 nm and an excellent λ/2 phase difference function, as compared with the wavelength selective phase difference plate of Comparative Example 2. In addition, at wavelengths of 450 nm and 532 nm, the wavelength selective phase difference plate of Example 2 had a low transmittance and excellent wavelength selectivity as compared with the wavelength selective phase difference plate of Comparative Example 2. That is, it was confirmed that the wavelength selective phase difference plate of Example 2 had a small difference between the phase difference generated in a case where light was incident from the front direction and the phase difference generated in a case where light was incident from the oblique direction.

In a case where light was incident from the front surface, the wavelength selective phase difference plates of Comparative Example 3 and Example 3 had a high transmittance (≥80%) at a wavelength of 532 nm and had an equivalent λ/2 phase difference function. In addition, the transmittance at wavelengths of 450 nm and 650 nm was low (≤10%), and the phase difference function was almost not exhibited. That is, it was confirmed that the wavelength selective phase difference plates of Comparative Example 3 and Example 3functioned as the wavelength selective phase difference plate in a case where light was incident from the front direction.

In a case where light was incident at an oblique angle of 40°, the wavelength selective phase difference plate of Example 3 had a high transmittance at a wavelength of 532 nm and an excellent λ/2 phase difference function, as compared with the wavelength selective phase difference plate of Comparative Example 3. In addition, at wavelengths of 450 nm and 650 nm, the wavelength selective phase difference plate of Example 3 had a low transmittance and excellent wavelength selectivity as compared with the wavelength selective phase difference plate of Comparative Example 3. That is, it was confirmed that the wavelength selective phase difference plate of Example 3 had a small difference between the phase difference generated in a case where light was incident from the front direction and the phase difference generated in a case where light was incident from the oblique direction.

In addition, a spectrum (wavelength of 400 nm to 700 nm) of the transmittance in a case where light was incident from the front surface was measured for the wavelength selective phase difference plates produced in Example 1 and Example 3. The wavelength selective phase difference plate of Example 3 had a high transmittance in green light (wavelength of 500 nm to 570 nm) and had an excellent λ/2 phase difference function as compared with the wavelength selective phase difference plate of Example 1.

In a case where light was incident from the front surface, the wavelength selective phase difference plates of Comparative Example 4 and Example 4 had a high transmittance (>80%) at a wavelength of 650 nm and had an equivalent λ/2 phase difference function. In addition, the transmittance at wavelengths of 450 nm and 532 nm was low (≤10%), and the phase difference function was almost not exhibited. That is, it was confirmed that the wavelength selective phase difference plates of Comparative Example 4 and Example 4functioned as the wavelength selective phase difference plate in a case where light was incident from the front direction.

In a case where light was incident at an oblique angle of 40°, the wavelength selective phase difference plate of Example 4 had a high transmittance at a wavelength of 650 nm and an excellent λ/2 phase difference function, as compared with Comparative Example 4. In addition, at wavelengths of 450 nm and 532 nm, the wavelength selective phase difference plate of Example 4 had a low transmittance and excellent wavelength selectivity as compared with Comparative Example 4. That is, it was confirmed that the wavelength selective phase difference plate of Example 4 had a small difference between the phase difference generated in a case where light was incident from the front direction and the phase difference generated in a case where light was incident from the oblique direction.

In addition, a spectrum (wavelength of 400 nm to 700 nm) of the transmittance in a case where light was incident from the front surface was measured for the wavelength selective phase difference plates produced in Example 2 and Example 4. The wavelength selective phase difference plate of Example 4 had a high transmittance in red light (wavelength of 620 nm to 690 nm) and had an excellent λ/2 phase difference function as compared with Example 2.

### Comparative Example 11

### <Production of Wavelength Selective Phase Difference Plate for Circularly Polarized Light>

s(Production of λ/4 Plate)

As a liquid crystal composition forming a λ/4 plate, the following composition C-1 was prepared.

Composition C-1

| | |
|---|---|
| Liquid crystal compound L-2 | 42.00 parts by mass |
| Liquid crystal compound L-3 | 42.00 parts by mass |
| Liquid crystal compound L-4 | 16.00 parts by mass |
| Polymerization initiator PI-1 | 0.50 parts by mass |
| Surfactant G-1 | 0.20 parts by mass |
| Methyl ethyl ketone | 176.00 parts by mass |
| Cyclopentanone | 44.00 parts by mass |

Liquid crystal compound L-2 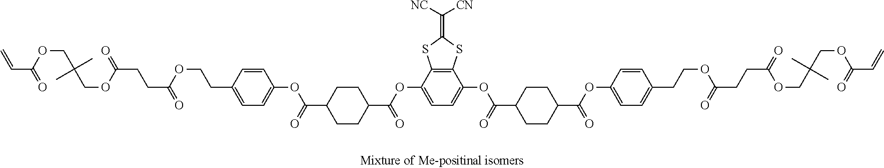 [SMILES: C=CC(=O)OCC(C)(C)COC(=O)CCC(=O)OCCc1ccc(OC(=O)C2CCC(C(=O)Oc3ccc(OC(=O)C4CCC(C(=O)Oc5ccc(CCOC(=O)CCC(=O)OCC(C)(C)COC(=O)C=C)cc5)CC4)c4c3SC(=C(C#N)C#N)S4)CC2)cc1]
Liquid crystal compound L-3 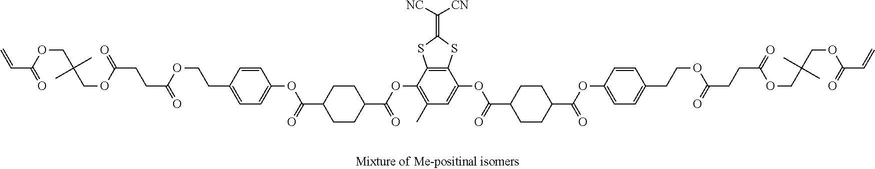 [SMILES: C=CC(=O)OCC(C)(C)COC(=O)CCC(=O)OCCc1ccc(OC(=O)C2CCC(C(=O)Oc3cc(C)c(OC(=O)C4CCC(C(=O)Oc5ccc(CCOC(=O)CCC(=O)OCC(C)(C)COC(=O)C=C)cc5)CC4)c4c3SC(=C(C#N)C#N)S4)CC2)cc1]
Liquid crystal compound L-4 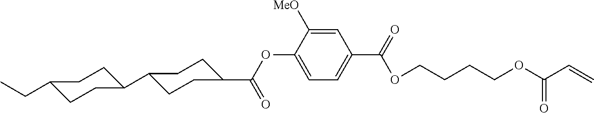 [SMILES: C=CC(=O)OCCCCOC(=O)c1ccc(OC(=O)C2CCC(C3CCC(CC)CC3)CC2)c(OC)c1]
Polymerization initiator PI-1 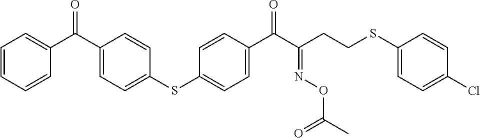 [SMILES: CC(=O)O/N=C(\CCSc1ccc(Cl)cc1)C(=O)c1ccc(Sc2ccc(C(=O)c3ccccc3)cc2)cc1]
Surfactant G-1 (the symbol assigned to each repeating unit indicates a mass-based content of each repeating unit)

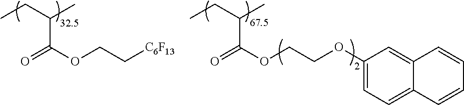

An optically anisotropic layer QA in which the alignment direction of the reverse dispersion liquid crystal compound was fixed was formed by the following procedure.

The optically anisotropic layer QA was formed by applying the above-described composition C-1 onto the above-described alignment film P-1. The coated film was heated using a hot plate at 100° C., cooled to 65° C., and then irradiated with ultraviolet rays having a wavelength of 365 nm at an irradiation amount of 500 mJ/cm² using a high-pressure mercury lamp in a nitrogen atmosphere. As a result, the alignment of the liquid crystal compound was fixed.

In this manner, the optically anisotropic layer QA was obtained. The obtained optically anisotropic layer QA had Re(550) of 138 nm and Re(450)/Re(550) of 0.86.

In addition, as an optically anisotropic layer QC, a layer in which the alignment direction of the reverse dispersion liquid crystal compound was fixed was formed by the following procedure.

The optically anisotropic layer QC was formed by applying the following composition D-1 onto the optically anisotropic layer QA. The coated film was heated using a hot plate at 70° C., cooled to 65° C., and then irradiated with ultraviolet rays having a wavelength of 365 nm at an irradiation amount of 500 mJ/cm² using a high-pressure mercury lamp in a nitrogen atmosphere. As a result, the alignment of the liquid crystal compound was fixed. In this manner, a λ/4 plate was obtained.

The obtained optically anisotropic layer QC had a thickness-direction retardation Rth (550) of −69 nm.

Composition D-1

| | |
|---|---|
| Liquid crystal compound L-1 shown below | 34.00 parts by mass |
| Liquid crystal compound L-2 shown above | 44.00 parts by mass |
| Liquid crystal compound L-3 shown above | 22.00 parts by mass |
| Polymerization initiator PI-1 shown above | 1.50 parts by mass |
| Surfactant T-2 shown below | 0.40 parts by mass |
| Surfactant T-3 shown below | 0.20 parts by mass |
| Compound S-1 shown below | 0.50 parts by mass |
| Compound M-1 shown below | 14.00 parts by mass |
| Methyl ethyl ketone | 248.00 parts by mass |

Liquid crystal compound L-1 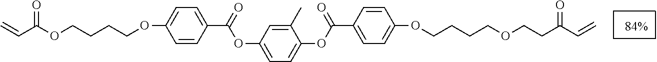 [SMILES: C=CC(=O)CCOCCCCOc1ccc(C(=O)Oc2ccc(OC(=O)c3ccc(OCCCCOC(=O)C=C)cc3)cc2C)cc1] 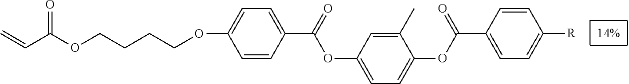 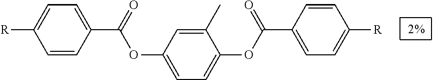 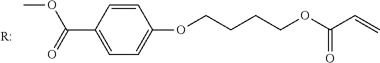
Surfactant T-2 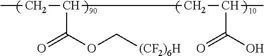
Surfactant T-3 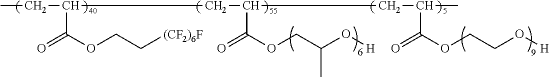
Compound S-1 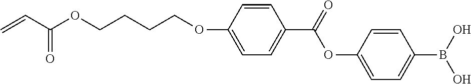 [SMILES: C=CC(=O)OCCCCOc1ccc(C(=O)Oc2ccc(B(O)O)cc2)cc1]
Compound M-1

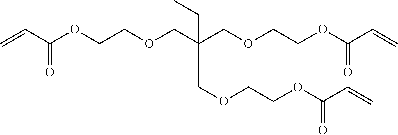 [SMILES: C=CC(=O)OCCOCC(CC)(COCCOC(=O)C=C)COCCOC(=O)C=C]

The 24 plate produced above, the third wavelength selective phase difference plate produced in Comparative Example 2, and the first wavelength selective phase difference plate produced in Comparative Example 1 were respectively laminated to have a layer configuration shown in Tables 10 and 11 below. In addition, during the lamination, the layers were sequentially laminated after peeling off the support and the alignment film. As a result, a wavelength selective phase difference plate R1 which converted red circularly polarized light into circularly polarized light having an opposite turning direction opposite and did not change a phase of circularly polarized light in other wavelength ranges, and a wavelength selective phase difference plate G1 which converted green circularly polarized light into circularly polarized light having an opposite turning direction and did not change a phase of circularly polarized light in other wavelength ranges were produced.

TABLE 10

| | Wavelength | Re(λ) | Re(450)/ | Slow axis |
|---|---|---|---|---|
| | λ [nm] | [nm] | Re(550) | orientation [°] |
| λ/4 plate | 550 | 138 | 0.86 | −45 |

Third wavelength selective phase difference
plate produced in Comparative Example 2

| | | | | |
|---|---|---|---|---|
| λ/4 plate | 550 | 138 | 0.86 | 45 |

TABLE 11

| | Wavelength | Re(λ) | Re(450)/ | Slow axis |
|---|---|---|---|---|
| | λ [nm] | [nm] | Re(550) | orientation [°] |
| λ/4 plate | 550 | 138 | 0.86 | 45 |

First wavelength selective phase difference
plate produced in Comparative Example 1

| | | | | |
|---|---|---|---|---|
| λ/4 plate | 550 | 138 | 0.86 | −45 |

### <Production of First Optically Anisotropic Member>

### (Formation of Alignment Film)

An alignment film was formed on the support in the same manner as in Comparative Example 1. The exposure of the alignment film was performed by the following procedure.

### ((Exposure of Alignment Film)

The alignment film was exposed using the exposure device shown in FIG. 15 to form an alignment film PG-1 having an alignment pattern.

In the exposure device, a laser which emitted laser light having a wavelength (355 nm) was used as the laser. An exposure amount of the interference light was set to 1,000 mJ/cm².

### (Formation of Optically Anisotropic Layer)

As a liquid crystal composition forming a first optically anisotropic layer, the following composition E-1 was prepared.

Composition E-1

| | |
|---|---|
| Liquid crystal compound L-1 shown above | 10.00 parts by mass |
| Liquid crystal compound L-5 shown below | 90.00 parts by mass |
| Chiral agent C1 | 0.69 parts by mass |
| Polymerization initiator (manufactured by BASF, Irgacure OXE01) | 1.00 part by mass |
| Surfactant F2 shown above | 0.30 parts by mass |
| Methyl ethyl ketone | 550.00 parts by mass |
| Cyclopentanone | 550.00 parts by mass |

Liquid crystal compound L-5 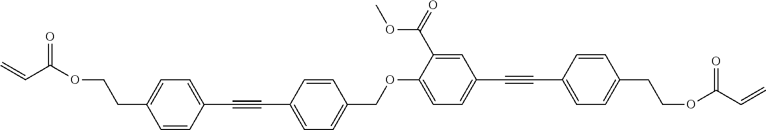 [SMILES: C=CC(=O)OCCc1ccc(C#Cc2ccc(COc3ccc(C#Cc4ccc(CCOC(=O)C=C)cc4)cc3C(=O)OC)cc2)cc1]
Chiral agent C1

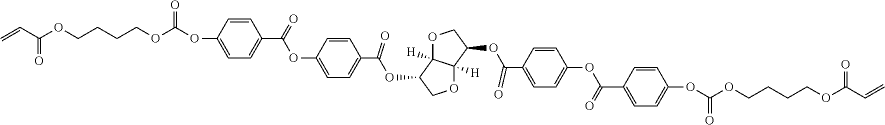 [SMILES: C=CC(=O)OCCCCOC(=O)Oc1ccc(C(=O)Oc2ccc(C(=O)O[C@H]3CO[C@H]4[C@@H]3OC[C@H]4OC(=O)c3ccc(OC(=O)c4ccc(OC(=O)OCCCCOC(=O)C=C)cc4)cc3)cc2)cc1]

An optically anisotropic layer was formed by applying the composition E-1 onto the alignment film PG-1 in multiple layers. The application in multiple layers refers to repetition of processes including producing a first liquid crystal immobilized layer by applying the first layer-forming composition E-1 onto the alignment film, heating the composition E-1, and irradiating the composition E-1 with ultraviolet light for curing; and producing a second or subsequent liquid crystal immobilized layer by applying the second or subsequent layer-forming composition E-1 onto the formed liquid crystal immobilized layer, heating the composition E-1, and irradiating the composition E-1 with ultraviolet light for curing as described above. Even in a case where the liquid crystal layer was formed by the application of the multiple layers such that the total thickness of the optically anisotropic layer was large, the alignment direction of the alignment film was preserved from a lower surface of the optically anisotropic layer to an upper surface thereof.

Regarding a first layer, the above-described composition E-1 was applied onto the alignment film PG-1 to form a coating film, the coating film was heated to 80° C. on a hot plate, the coating film was irradiated with ultraviolet rays having a wavelength of 365 nm at an irradiation amount of 300 mJ/cm² using a high-pressure mercury lamp in a nitrogen atmosphere, thereby fixing the alignment of the liquid crystal compound to form a liquid crystal immobilized layer.

Regarding the second or subsequent layer, the composition was applied onto the liquid crystal immobilized layer, and heated, and cured with ultraviolet rays under the same conditions as described above to produce a liquid crystal immobilized layer. In this way, by repeating the application multiple times until the total thickness reached a desired film thickness, an optically anisotropic layer was formed, and a liquid crystal diffraction element was produced.

A birefringence index An of the cured layer of the liquid crystal composition E-1 was obtained by applying the liquid crystal composition E-1 onto a support with an alignment film for retardation measurement, which was prepared separately, aligning a director of the liquid crystal compound to be parallel to the base material, irradiating the liquid crystal composition E-1 with ultraviolet rays for immobilization to obtain a liquid crystal immobilized layer (cured layer), and measuring a retardation value and a film thickness of the liquid crystal immobilized layer. An could be calculated by dividing the retardation value by the film thickness. The retardation value was measured by measuring a desired wavelength using Axoscan (manufactured by Axometrix, inc.) and measuring the film thickness using a scanning electron microscope.

In the optically anisotropic layer, Δn₅₅₀×thickness (Re(550)) of the liquid crystals was finally 150 nm, and it was confirmed using a polarization microscope that periodic alignment occurred on the surface. In the liquid crystal alignment pattern of the optically anisotropic layer, a single period over which the optical axis derived from the liquid crystal compound rotated by 180° was 0.8 μm. In addition, in the optically anisotropic layer, a twisted angle of the liquid crystal compound in the thickness direction was 83°. Hereinafter, unless specified otherwise, “Δn₅₅₀×d” and the like were measured in the same manner as described above.

As a liquid crystal composition forming a second optically anisotropic layer, the following composition E-2 was prepared.

Composition E-2

| | | |
|---|---|---|
| Liquid crystal compound L-1 shown above | 10.00 | parts by mass |
| Liquid crystal compound L-5 shown above | 90.00 | parts by mass |
| Chiral agent C1 shown above | 0.03 | parts by mass |
| Polymerization initiator (manufactured | 1.00 | part by mass |
| by BASF, Irgacure OXE01) | | |
| Surfactant F2 shown above | 0.30 | parts by mass |
| Methyl ethyl ketone | 550.00 | parts by mass |
| Cyclopentanone | 550.00 | parts by mass |

A second optically anisotropic layer was formed of the composition E-2 by the same method for the first optically anisotropic layer, except that the film thickness of the optically anisotropic layer was adjusted.

In the optically anisotropic layer, Δn₅₅₀×thickness (Re(550)) of the liquid crystals was finally 335 nm, and it was confirmed using a polarization microscope that periodic alignment occurred on the surface. In the liquid crystal alignment pattern of the optically anisotropic layer, a single period over which the optical axis derived from the liquid crystal compound rotated by 180° was 0.8 μm. In addition, in the optically anisotropic layer, a twisted angle of the liquid crystal compound in the thickness direction was 8°.

As a liquid crystal composition forming a third optically anisotropic layer, the following composition E-3 was prepared.

Composition E-3

| | | |
|---|---|---|
| Liquid crystal compound L-1 shown above | 10.00 | parts by mass |
| Liquid crystal compound L-5 shown above | 90.00 | parts by mass |
| Chiral agent C2 shown below | 0.60 | parts by mass |
| Polymerization initiator (manufactured | 1.00 | part by mass |
| by BASF, Irgacure OXE01) | | |
| Surfactant F2 shown above | 0.30 | parts by mass |
| Methyl ethyl ketone | 550.00 | parts by mass |
| Cyclopentanone | 550.00 | parts by mass |

A third optically anisotropic layer was formed of the composition E-3 by the same method for the first optically anisotropic layer, except that the film thickness of the optically anisotropic layer was adjusted.

In the optically anisotropic layer, Δn₅₅₀×thickness (Re(550)) of the liquid crystals was finally 170 nm, and it was confirmed using a polarization microscope that periodic alignment occurred on the surface. In the liquid crystal alignment pattern of the optically anisotropic layer, a single period over which the optical axis derived from the liquid crystal compound rotated by 180° was 0.8 μm. In addition, in the optically anisotropic layer, a twisted angle of the liquid crystal compound in the thickness direction was −78°. In this way, a first optically anisotropic member including a first liquid crystal diffraction element Al was produced.

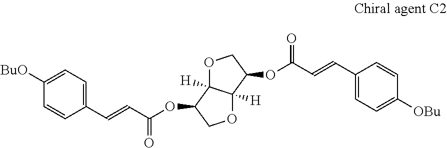

### <Production of Second Optically Anisotropic Member>

### (Formation of Alignment Film)

An alignment film was formed in the same manner as in Comparative Example 1. The exposure of the alignment film was performed by the following procedure.

### (Exposure of Alignment Film)

The alignment film was exposed using the exposure device shown in FIG. 15 to form an alignment film PG-2 having an alignment pattern. In the exposure device, a laser which emitted laser light having a wavelength (355 nm) was used as the laser. An exposure amount of the interference light was set to 1,000 mJ/cm².

A second optically anisotropic member including a second liquid crystal diffraction element A2 was produced by the same procedure as that of the first liquid crystal diffraction element A1, except that the alignment film PG-2 was used and the optically anisotropic layers were adjusted to have the following retardation.

In the produced second liquid crystal diffraction element A2, Δn₅₅₀×thickness (Re(550)) of the first optically anisotropic layer was 150 nm and a twisted angle of the liquid crystal compound in the thickness direction was 83°; Δn₅₅₀×thickness (Re(550)) of the second optically anisotropic layer was 335 nm and a twisted angle of the liquid crystal compound in the thickness direction was 8°; and Δn₅₅₀×thickness (Re(550)) of the third optically anisotropic layer was 170 nm and a twisted angle of the liquid crystal compound in the thickness direction was −78°. In the liquid crystal alignment pattern of the optically anisotropic layer of the liquid crystal diffraction element, a single period over which the optical axis derived from the liquid crystal compound rotated by 180° was 10.0 μm.

### <Production of Third Optically Anisotropic Member>

### (Formation of Alignment Film)

An alignment film was formed on the support in the same manner as in Comparative Example 1. The exposure of the alignment film was performed by the following procedure.

### (Exposure of Alignment Film)

The alignment film was exposed using the exposure device shown in FIG. 15 to form an alignment film PG-3 having an alignment pattern.

In the exposure device, a laser which emitted laser light having a wavelength (355 nm) was used as the laser. An exposure amount of the interference light was set to 1,000 mJ/cm².

A third optically anisotropic member including a third liquid crystal diffraction element A3 was produced by the same procedure as that of the first liquid crystal diffraction element Al, except that the alignment film PG-3 was used and the optically anisotropic layers were adjusted to have the following retardation.

In the produced third liquid crystal diffraction element A3, Δn₅₅₀×thickness (Re(550)) of the first optically anisotropic layer was 150 nm and a twisted angle of the liquid crystal compound in the thickness direction was 83°; Δ₅₅₀×thickness (Re(550)) of the second optically anisotropic layer was 335 nm and a twisted angle of the liquid crystal compound in the thickness direction was 8°; and Δn₅₅₀×thickness (Re(550)) of the third optically anisotropic layer was 170 nm and a twisted angle of the liquid crystal compound in the thickness direction was −78°. In the liquid crystal alignment pattern of the optically anisotropic layer of the liquid crystal diffraction element, a single period over which the optical axis derived from the liquid crystal compound rotated by 180° was 8.9 μm.

The wavelength selective phase difference plate and the liquid crystal diffraction element produced above were laminated so as to have a layer configuration shown in Table 12 below. In addition, during the lamination, the support and the alignment film were peeled off from each optically anisotropic member, and then the wavelength selective phase difference plate and the liquid crystal diffraction element were sequentially laminated. As a result, a liquid crystal diffraction element (optical element) having wavelength selectivity was produced.

TABLE 12

| | Comparative Example 11 |
|---|---|
| First liquid crystal | Liquid crystal diffraction |
| diffraction element | element A1 |
| Wavelength selective | Wavelength selective phase |
| phase difference plate for red | difference plate R1 |
| Second liquid crystal | Liquid crystal diffraction |
| diffraction element | element A2 |
| Wavelength selective | Wavelength selective phase |
| phase difference plate for green | difference plate G1 |
| Second liquid crystal | Liquid crystal diffraction |
| diffraction element | element A3 |

### Example 11

### <Production of Wavelength Selective Phase Difference Plate for Circularly Polarized Light>

The λ/4 plate produced in Comparative Example 11 and the wavelength selective phase difference plates produced in Example 2 and Example 1 were laminated so as to have a layer configuration shown in Tables 13 and 14 below. In addition, during the lamination, the layers were sequentially laminated after peeling off the support and the alignment film. As a result, a wavelength selective phase difference plate R2 which converted red circularly polarized light into circularly polarized light having an opposite turning direction opposite and did not change a phase of circularly polarized light in other wavelength ranges, and a wavelength selective phase difference plate G2 which converted green circularly polarized light into circularly polarized light having an opposite turning direction and did not change a phase of circularly polarized light in other wavelength ranges were produced.

TABLE 13

| | Wavelength | Re(λ) | Re(450)/ | Slow axis |
|---|---|---|---|---|
| | λ [nm] | [nm] | Re(550) | orientation [°] |
| λ/4 plate | 550 | 138 | 0.86 | −45 |

Third wavelength selective phase difference
plate produced in Comparative Example 2

| | | | | |
|---|---|---|---|---|
| λ/4 plate | 550 | 138 | 0.86 | 45 |

TABLE 14

| | Wavelength | Re(λ) | Re(450)/ | Slow axis |
|---|---|---|---|---|
| | λ [nm] | [nm] | Re(550) | orientation [°] |
| λ/4 plate | 550 | 138 | 0.86 | 45 |

First wavelength selective phase difference
plate produced in Comparative Example 1

| | | | | |
|---|---|---|---|---|
| λ/4 plate | 550 | 138 | 0.86 | −45 |

The wavelength selective phase difference plate produced above and the liquid crystal diffraction element produced in Comparative Example 11 were laminated so as to have a layer configuration shown in Table 15 below. In addition, during the lamination, the support and the alignment film were peeled off from each optically anisotropic member, and then the wavelength selective phase difference plate and the liquid crystal diffraction element were sequentially laminated. As a result, a liquid crystal diffraction element (optical element) having wavelength selectivity was produced.

TABLE 15

| | Example 11 |
|---|---|
| First liquid crystal | Liquid crystal diffraction |
| diffraction element | element A1 |
| Wavelength selective phase | Wavelength selective phase |
| difference plate for red | difference plate R2 |
| Second liquid crystal | Liquid crystal diffraction |
| diffraction element | element A2 |
| Wavelength selective phase | Wavelength selective phase |
| difference plate for green | difference plate G2 |
| Second liquid crystal | Liquid crystal diffraction |
| diffraction element | element A3 |

### Comparative Example 12

### <Production of Wavelength Selective Phase Difference Plate for Circularly Polarized Light>

The λ/4 plate produced in Comparative Example 11 and the wavelength selective phase difference plates produced in Comparative Example 4 and Comparative Example 3 were laminated so as to have a layer configuration shown in Tables 16 and 17 below. In addition, during the lamination, the layers were sequentially laminated after peeling off the support and the alignment film. As a result, a wavelength selective phase difference plate R3 which converted red circularly polarized light into circularly polarized light having an opposite turning direction opposite and did not change a phase of circularly polarized light in other wavelength ranges, and a wavelength selective phase difference plate G3 which converted green circularly polarized light into circularly polarized light having an opposite turning direction and did not change a phase of circularly polarized light in other wavelength ranges were produced.

TABLE 16

| | Wavelength | Re(λ) | Re(450)/ | Slow axis |
|---|---|---|---|---|
| | λ [nm] | [nm] | Re(550) | orientation [°] |
| λ/4 plate | 550 | 138 | 0.86 | −45 |

Seventh wavelength selective phase difference
plate produced in Comparative Example 4

| | | | | |
|---|---|---|---|---|
| λ/4 plate | 550 | 138 | 0.86 | 45 |

TABLE 17

| | Wavelength | Re(λ) | Re(450)/ | Slow axis |
|---|---|---|---|---|
| | λ [nm] | [nm] | Re(550) | orientation [°] |
| λ/4 plate | 550 | 138 | 0.86 | 45 |

Fifth wavelength selective phase difference
plate produced in Comparative Example 3

| | | | | |
|---|---|---|---|---|
| λ/4 plate | 550 | 138 | 0.86 | −45 |

The wavelength selective phase difference plate produced above and the liquid crystal diffraction element produced in Comparative Example 11 were laminated so as to have a layer configuration shown in Table 18 below. In addition, during the lamination, the support and the alignment film were peeled off from each optically anisotropic member, and then the wavelength selective phase difference plate and the liquid crystal diffraction element were sequentially laminated. As a result, a liquid crystal diffraction element (optical element) having wavelength selectivity was produced.

TABLE 18

| | Comparative Example 12 |
|---|---|
| First liquid crystal | Liquid crystal diffraction |
| diffraction element | element A1 |
| Wavelength selective phase | Wavelength selective phase |
| difference plate for red | difference plate R3 |
| Second liquid crystal | Liquid crystal diffraction |
| diffraction element | element A2 |
| Wavelength selective phase | Wavelength selective phase |
| difference plate for green | difference plate G3 |
| Second liquid crystal | Liquid crystal diffraction |
| diffraction element | element A3 |

### Example 12

### <Production of Wavelength Selective Phase Difference Plate for Circularly Polarized Light>

The λ/4 plate produced in Comparative Example 11 and the wavelength selective phase difference plates produced in Example 4 and Example 3 were laminated so as to have a layer configuration shown in Tables 19 and 20 below. In addition, during the lamination, the layers were sequentially laminated after peeling off the support and the alignment film. As a result, a wavelength selective phase difference plate R4 which converted red circularly polarized light into circularly polarized light having an opposite turning direction opposite and did not change a phase of circularly polarized light in other wavelength ranges, and a wavelength selective phase difference plate G4 which converted green circularly polarized light into circularly polarized light having an opposite turning direction and did not change a phase of circularly polarized light in other wavelength ranges were produced.

TABLE 19

| | Wavelength | Re(λ) | Re(450)/ | Slow axis |
|---|---|---|---|---|
| | λ [nm] | [nm] | Re(550) | orientation [°] |
| λ/4 plate | 550 | 138 | 0.86 | −45 |

Eighth wavelength selective phase difference
plate produced in Example 4

| | | | | |
|---|---|---|---|---|
| λ/4 plate | 550 | 138 | 0.86 | 45 |

TABLE 20

| | Wavelength | Re(λ) | Re(450)/ | Slow axis |
|---|---|---|---|---|
| | λ [nm] | [nm] | Re(550) | orientation [°] |
| λ/4 plate | 550 | 138 | 0.86 | 45 |

Sixth wavelength selective phase difference
plate produced in Example 3

| | | | | |
|---|---|---|---|---|
| λ/4 plate | 550 | 138 | 0.86 | −45 |

The wavelength selective phase difference plate produced above and the liquid crystal diffraction element produced in Comparative Example 11 were laminated so as to have a layer configuration shown in Table 21 below. In addition, during the lamination, the support and the alignment film were peeled off from each optically anisotropic member, and then the wavelength selective phase difference plate and the liquid crystal diffraction element were sequentially laminated. As a result, a liquid crystal diffraction element (optical element) having wavelength selectivity was produced.

TABLE 21

| | Example 12 |
|---|---|
| First liquid crystal | Liquid crystal diffraction |
| diffraction element | element A1 |
| Wavelength selective phase | Wavelength selective phase |
| difference plate for red | difference plate R4 |
| Second liquid crystal | Liquid crystal diffraction |
| diffraction element | element A2 |
| Wavelength selective phase | Wavelength selective phase |
| difference plate for green | difference plate G4 |
| Second liquid crystal | Liquid crystal diffraction |
| diffraction element | element A3 |

### Evaluation of Wavelength Selective Liquid Crystal Diffraction Element

In a case where light was incident into the produced wavelength selective liquid crystal diffraction element from the front surface (direction with an angle of 0° with respect to the normal line), angles and intensities of transmitted diffracted light of red light, green light, and blue light with respect to incidence light were measured. The angle of transmitted diffracted light is an angle of the transmitted diffracted light with respect to the incidence light in a case where an incidence direction of the incidence light was 0°.

Specifically, laser light having output central wavelengths in a red light range (635 nm), a green light range (532 nm), and a blue light range (450 nm) was caused to be vertically incident into the produced optical element from a position at a distance of 10 cm in the normal direction, and the transmitted diffracted light was captured using a screen disposed at a distance of 100 cm to calculate a transmission angle. In addition, the intensity of the transmitted diffracted light at each wavelength was measured with a photodetector. In the present example, the designed wavelength Na of light having the longest wavelength was 635 nm, the designed wavelength Ab of light having the intermediate wavelength was 532 nm, and the designed wavelength Ac of light having the shortest wavelength was 450 nm.

Laser light was caused to be vertically incident into the circularly polarizing plate B, the circularly polarizing plate G, and the circularly polarizing plate R corresponding to the respective wavelengths to be converted into circularly polarized light, the circularly polarized light was incident into the produced optical element, and the evaluation was performed.

From the average transmission angle θₐᵥₑ of red light, green light, and blue light, and the maximum transmission angle θₘₐₓ and the minimum transmission angle θₘᵢₙ of red light, green light, and blue light, wavelength dependence PE [%] of the diffraction angle of the transmitted diffracted light was calculated according to the following expression. As the PE decreases, the wavelength dependence of the diffraction angle of the transmitted diffracted light is lower.

$$PE [ \% ] = [ ( {θ}_{max} - {θ}_{min} ) / {θ}_{ave} ] \times 100$$

Based on the calculated PE, the wavelength dependence of the diffraction angle of the transmitted diffracted light was evaluated according to the following standard.
AA: PE was 5% or less.
A: PE was more than 5% and 10% or less.
B: PE was more than 10% and 20% or less.
C: PE was more than 20% and 30% or less.
D: PE was more than 30%.

The evaluation of the wavelength dependence of the diffraction of the transmitted diffracted light in the wavelength selective liquid crystal diffraction elements produced in Comparative Examples 11 and 12 and Examples 11 and 12 was all AA.

On the other hand, in the wavelength selective liquid crystal diffraction element of Example 11, the intensity of the transmitted diffracted light was high at any of the wavelengths of 450 nm, 532 nm, and 635 nm, as compared with the wavelength selective liquid crystal diffraction element of Comparative Example 11.

In addition, in the wavelength selective liquid crystal diffraction element of Example 12, the intensity of the transmitted diffracted light was high at any of the wavelengths of 450 nm, 532 nm, and 635 nm, as compared with the wavelength selective liquid crystal diffraction element of Comparative Example 12.

In the above-described evaluation, since the diffraction occurred inside the wavelength selective phase difference plate and the traveling direction of the light was changed, diffracted light was incident from an oblique direction with respect to the normal direction of the surface of the wavelength selective phase difference plate in the wavelength selective liquid crystal diffraction element. Therefore, the fact that the intensity of the transmitted diffracted light was high as described above indicates that, even in a case where the diffracted light was incident on the wavelength selective phase difference plate from an oblique direction, the designed phase difference was generated and the amount of the diffracted light in a desired direction increased.

### Comparative Example 21

### <Production of First Optically Anisotropic Member>

### (Formation of Alignment Film)

An alignment film was formed on the support in the same manner as in Comparative Example 1. The exposure of the alignment film was performed by the following procedure.

### (Exposure of Alignment Film)

The alignment film was exposed using the exposure device shown in FIG. 15 to form an alignment film PL-1 having a concentric circular alignment pattern. In the exposure device, a laser which emitted laser light having a wavelength (355 nm) was used as the laser. An exposure amount of the interference light was set to 1,000 mJ/cm².

A first optically anisotropic member including a first liquid crystal diffraction element LA1 was produced in the same manner as in the first liquid crystal diffraction element A1, except that the alignment film PL-1 was used.

In the produced first liquid crystal diffraction element LA1, Δn₅₅₀×thickness (Re(550)) of the first optically anisotropic layer was 150 nm and a twisted angle of the liquid crystal compound in the thickness direction was 83°; Δn₅₅₀×thickness (Re(550)) of the second optically anisotropic layer was 335 nm and a twisted angle of the liquid crystal compound in the thickness direction was 8°; and Δn₅₅₀×thickness (Re(550)) of the third optically anisotropic layer was 170 nm and a twisted angle of the liquid crystal compound in the thickness direction was −78°. In the liquid crystal alignment pattern of the optically anisotropic layer of the liquid crystal diffraction element, regarding a single period over which the optical axis of the liquid crystal compound rotated by 180°, a single period of a portion at a distance of 5 mm from the center was 1.9 μm; a single period of a portion at a distance of 10 mm from the center was 1.0 μm; a single period of a portion at a distance of 15 mm from the center was 0.8 μm; and the single period decreased toward the outer direction.

### <Production of Second Optically Anisotropic Member>

### (Formation of Alignment Film)

An alignment film was formed on the support in the same manner as in Comparative Example 1. The exposure of the alignment film was performed by the following procedure.

### (Exposure of Alignment Film)

The alignment film was exposed using the exposure device shown in FIG. 15 to form an alignment film PL-2 having a concentric circular alignment pattern. In the exposure device, a laser which emitted laser light having a wavelength (355 nm) was used as the laser. An exposure amount of the interference light was set to 1,000 mJ/cm².

A second optically anisotropic member including a second liquid crystal diffraction element LA2 was produced in the same manner as in the first liquid crystal diffraction element A1, except that the alignment film PL-2 was used.

In the produced second liquid crystal diffraction element LA2, Δn₅₅₀×thickness (Re(550)) of the first optically anisotropic layer was 150 nm and a twisted angle of the liquid crystal compound in the thickness direction was 83°; Δn₅₅₀×thickness (Re(550)) of the second optically anisotropic layer was 335 nm and a twisted angle of the liquid crystal compound in the thickness direction was 8°; and Δn₅₅₀×thickness (Re(550)) of the third optically anisotropic layer was 170 nm and a twisted angle of the liquid crystal compound in the thickness direction was −78°. In the liquid crystal alignment pattern of the optically anisotropic layer of the liquid crystal diffraction element, regarding a single period over which the optical axis of the liquid crystal compound rotated by 180°, a single period of a portion at a distance of 5 mm from the center was 23.4 μm; a single period of a portion at a distance of 10 mm from the center was 13.0 μm; a single period of a portion at a distance of 15 mm from the center was 10.0 μm; and the single period decreased toward the outer direction.

### <Production of Third Optically Anisotropic Member>

### (Formation of Alignment Film)

An alignment film was formed in the same manner as in Comparative Example 1. The alignment film was formed on the support. The exposure of the alignment film was performed by the following procedure.

### (Exposure of Alignment Film)

The alignment film was exposed using the exposure device shown in FIG. 15 to form an alignment film PL-3 having a concentric circular alignment pattern. In the exposure device, a laser which emitted laser light having a wavelength (355 nm) was used as the laser. An exposure amount of the interference light was set to 1,000 mJ/cm².

A third optically anisotropic member including a third liquid crystal diffraction element LA3 was produced in the same manner as in the first liquid crystal diffraction element A1, except that the alignment film PL-3 was used.

In the produced third liquid crystal diffraction element LA3, Δn₅₅₀×thickness (Re(550)) of the first optically anisotropic layer was 150 nm and a twisted angle of the liquid crystal compound in the thickness direction was 83°; Δn₅₅₀×thickness (Re(550)) of the second optically anisotropic layer was 335 nm and a twisted angle of the liquid crystal compound in the thickness direction was 8°; and Δn₅₅₀×thickness (Re(550)) of the third optically anisotropic layer was 170 nm and a twisted angle of the liquid crystal compound in the thickness direction was −78°. In the liquid crystal alignment pattern of the optically anisotropic layer of the liquid crystal diffraction element, regarding a single period over which the optical axis of the liquid crystal compound rotated by 180°, a single period of a portion at a distance of 5 mm from the center was 20.8 μm; a single period of a portion at a distance of 10 mm from the center was 11.6 μm; a single period of a portion at a distance of 15 mm from the center was 8.9 μm; and the single period decreased toward the outer direction.

The wavelength selective phase difference plate produced in Comparative Example 11 and the liquid crystal diffraction element produced above were laminated so as to have a layer configuration shown in Table 22 below. In addition, during the lamination, the support and the alignment film were peeled off from each optically anisotropic member, and then the wavelength selective phase difference plate and the liquid crystal diffraction element were sequentially laminated. As a result, a liquid crystal diffraction element (optical element) having wavelength selectivity was produced.

TABLE 22

| | Comparative Example 21 |
|---|---|
| First liquid crystal | Liquid crystal diffraction |
| diffraction element | element LA1 |
| Wavelength selective phase | Wavelength selective phase |
| difference plate for red | difference plate R1 |
| Second liquid crystal | Liquid crystal diffraction |
| diffraction element | element LA2 |
| Wavelength selective phase | Wavelength selective phase |
| difference plate for green | difference plate G1 |
| Second liquid crystal | Liquid crystal diffraction |
| diffraction element | element LA3 |

### Example 21

The wavelength selective phase difference plate produced in Example 11 and the liquid crystal diffraction element produced in Comparative Example 21 were laminated so as to have a layer configuration shown in Table 23 below. In addition, during the lamination, the support and the alignment film were peeled off from each optically anisotropic member, and then the wavelength selective phase difference plate and the liquid crystal diffraction element were sequentially laminated. As a result, a liquid crystal diffraction element (optical element) having wavelength selectivity was produced.

TABLE 23

| | Example 21 |
|---|---|
| First liquid crystal | Liquid crystal diffraction |
| diffraction element | element LA1 |
| Wavelength selective phase | Wavelength selective phase |
| difference plate for red | difference plate R2 |
| Second liquid crystal | Liquid crystal diffraction |
| diffraction element | element LA2 |
| Wavelength selective phase | Wavelength selective phase |
| difference plate for green | difference plate G2 |
| Second liquid crystal | Liquid crystal diffraction |
| diffraction element | element LA3 |

### Comparative Example 22

The wavelength selective phase difference plate produced in Comparative Example 12 and the liquid crystal diffraction element produced in Comparative Example 21 were laminated so as to have a layer configuration shown in Table 24 below. In addition, during the lamination, the support and the alignment film were peeled off from each optically anisotropic member, and then the wavelength selective phase difference plate and the liquid crystal diffraction element were sequentially laminated. As a result, a liquid crystal diffraction element (optical element) having wavelength selectivity was produced.

TABLE 24

| | Comparative Example 22 |
|---|---|
| First liquid crystal | Liquid crystal diffraction |
| diffraction element | element LA1 |
| Wavelength selective phase | Wavelength selective phase |
| difference plate for red | difference plate R3 |
| Second liquid crystal | Liquid crystal diffraction |
| diffraction element | element LA2 |
| Wavelength selective phase | Wavelength selective phase |
| difference plate for green | difference plate G3 |
| Second liquid crystal | Liquid crystal diffraction |
| diffraction element | element LA3 |

### Example 22

The wavelength selective phase difference plate produced in Example 12 and the liquid crystal diffraction element produced in Comparative Example 21 were laminated so as to have a layer configuration shown in Table 25 below. In addition, during the lamination, the support and the alignment film were peeled off from each optically anisotropic member, and then the wavelength selective phase difference plate and the liquid crystal diffraction element were sequentially laminated. As a result, a liquid crystal diffraction element (optical element) having wavelength selectivity was produced.

TABLE 25

| | Example 22 |
|---|---|
| First liquid crystal | Liquid crystal diffraction |
| diffraction element | element LA1 |
| Wavelength selective phase | Wavelength selective phase |
| difference plate for red | difference plate R4 |
| Second liquid crystal | Liquid crystal diffraction |
| diffraction element | element LA2 |
| Wavelength selective phase | Wavelength selective phase |
| difference plate for green | difference plate G4 |
| Second liquid crystal | Liquid crystal diffraction |
| diffraction element | element LA3 |

### Evaluation of Wavelength Selective Liquid Crystal Diffraction Element

In a case where light was incident into the produced wavelength selective liquid crystal diffraction element from the front surface (direction with an angle of 0° with respect to the normal line), angles and intensities of transmitted diffracted light of red light, green light, and blue light with respect to incidence light were measured. The angle of transmitted diffracted light is an angle of the transmitted diffracted light with respect to the incidence light in a case where an incidence direction of the incidence light was 0°.

The angle of the transmitted diffracted light was measured in the same manner as in the above-described measurement in the wavelength selective liquid crystal diffraction element, and the wavelength dependence PE [%] was calculated. In addition, in the present example, the designed wavelength λa of light having the longest wavelength was 635 nm, the designed wavelength λb of light having the intermediate wavelength was 532 nm, and the designed wavelength λc of light having the shortest wavelength was 450 nm.

In addition, the evaluation was performed by allowing the laser light to be incident at a distance of 5 mm, a distance of 10 mm, and a distance of 15 mm from the center of the wavelength selective diffraction element.

Based on the calculated PE, the wavelength dependence of the diffraction angle of the transmitted diffracted light was evaluated according to the following standard.
AA: PE was 5% or less.
A: PE was more than 5% and 10% or less.
B: PE was more than 10% and 20% or less.
C: PE was more than 20% and 30% or less.
D: PE was more than 30%.

The evaluation of the wavelength dependence of the diffraction of the transmitted diffracted light in the wavelength selective liquid crystal diffraction elements produced in Comparative Examples 21 and 22 and Examples 21 and 22 was all AA.

On the other hand, in the wavelength selective liquid crystal diffraction element of Example 21, at positions at a distance of 10 mm and 15 mm from the center of the liquid crystal diffraction element, a large intensity of light was obtained in the transmitted diffracted light at any of wavelengths of 450 nm, 532 nm, and 635 nm, as compared with the wavelength selective liquid crystal diffraction element of Comparative Example 21.

In addition, in the wavelength selective liquid crystal diffraction element of Example 22, at positions at a distance of 10 mm and 15 mm from the center of the liquid crystal diffraction element, a large intensity of light was obtained in the transmitted diffracted light at any of wavelengths of 450 nm, 532 nm, and 635 nm, as compared with the wavelength selective liquid crystal diffraction element of Comparative Example 22.

In the above-described evaluation, since the diffraction occurred inside the wavelength selective phase difference plate and the traveling direction of the light was changed, diffracted light was incident from an oblique direction with respect to the normal direction of the surface of the wavelength selective phase difference plate in the wavelength selective liquid crystal diffraction element. Therefore, the fact that the intensity of the transmitted diffracted light was high as described above indicates that, even in a case where the diffracted light was incident on the wavelength selective phase difference plate from an oblique direction, the designed phase difference was generated and the amount of the diffracted light in a desired direction increased.

### EXPLANATION OF REFERENCES

10: optical element
12: first optically anisotropic member
14: second optically anisotropic member
16: third optically anisotropic member
18G, 18R, 100: wavelength selective phase difference plate
20: support
24A, 24B, 24C: alignment film
26A: first optically anisotropic layer
26B: second optically anisotropic layer
26C: third optically anisotropic layer
30: liquid crystal compound
30A: optical axis
34: optically anisotropic layer
40: display
42: light guide plate
60, 80: exposure device
62, 82: laser
64, 84: light source
68: beam splitter
70A, 70B, 90A, 90B: mirror
72A, 72B, 96: λ/4 plate
86, 94: polarization beam splitter
92: lens
112: first wavelength plate
114: second wavelength plate
116: third wavelength plate
D1: first in-plane slow axis direction
D2: second in-plane slow axis direction
D3: third in-plane slow axis direction
B_{R}, B_{2R} : blue dextrorotatory circularly polarized light
G_{R}, G_{1R}, G_{2R}, G_{3R}: green dextrorotatory circularly polarized light
R_{R}, R_{1R}, R_{3R}: red dextrorotatory circularly polarized light
B_{1L}, B_{3L}: blue levorotatory circularly polarized light
G_{1L}, G_{2L}: green levorotatory circularly polarized light
R_{1L}, R_{2L}: red levorotatory circularly polarized light
M: laser light
MA, MB: ray
MP: P polarized light
MS: S polarized light
P_{O}: linearly polarized light
P_{R}: dextrorotatory circularly polarized light
PL: levorotatory circularly polarized light
Q1, Q2: absolute phase
E1, E2: equiphase plane
U: user

What is claimed is:

1. A wavelength selective phase difference plate comprising:
a plurality of wavelength plates,
wherein the wavelength selective phase difference plate changes a phase of polarized light in a first wavelength range and does not change a phase of polarized light in a second wavelength range which is different from the first wavelength range,
slow axis orientations of the plurality of wavelength plates are different from each other, and
Nz factors of the plurality of wavelength plates are each more than 0.3 and less than 0.7.

2. The wavelength selective phase difference plate according to claim 1,
wherein each of the plurality of wavelength plates includes at least an optically anisotropic layer A having an Nz factor of more than 0.5 and an optically anisotropic layer B having an Nz factor of less than 0.5, and
an angle formed between a slow axis of the optically anisotropic layer A in an in-plane direction and a slow axis of the optically anisotropic layer B in an in-plane direction is 45° or less.

3. The wavelength selective phase difference plate according to claim 2,
wherein the optically anisotropic layer A is formed of a composition containing a rod-like liquid crystal compound, and
the optically anisotropic layer B is formed of a composition containing a disk-like liquid crystal compound.

4. The wavelength selective phase difference plate according to claim 2,
wherein at least one of the optically anisotropic layer A or the optically anisotropic layer B is a layer formed by fixing an alignment direction of a liquid crystal compound twist-aligned.

5. An optical element comprising:
a plurality of optically anisotropic layers which are formed of a composition containing a liquid crystal compound and have a liquid crystal alignment pattern in which an orientation of an optical axis derived from the liquid crystal compound changes while continuously rotating in at least one in-plane direction; and
the wavelength selective phase difference plate according to claim 1, which is disposed between at least one pair of the plurality of optically anisotropic layers,
wherein rotation directions of orientations of optical axes in the two adjacent optically anisotropic layers are opposite to each other,
the first wavelength region includes a wavelength longer than a wavelength in the second wavelength range,
the wavelength selective phase difference plate converts circularly polarized light in the first wavelength range into circularly polarized light having an opposite turning direction and does not change a phase of circularly polarized light in the second wavelength range, and
in a case where a length over which the orientation of the optical axis rotates by 180° in the one direction in which the orientation of the optical axis changes while continuously rotating in the liquid crystal alignment pattern is set as a single period, at least one of the optically anisotropic layers has a length of the single period different from lengths of the single periods of the other optically anisotropic layers.

6. The wavelength selective phase difference plate according to claim 3,
wherein at least one of the optically anisotropic layer A or the optically anisotropic layer B is a layer formed by fixing an alignment direction of a liquid crystal compound twist-aligned.

7. An optical element comprising:
a plurality of optically anisotropic layers which are formed of a composition containing a liquid crystal compound and have a liquid crystal alignment pattern in which an orientation of an optical axis derived from the liquid crystal compound changes while continuously rotating in at least one in-plane direction; and
the wavelength selective phase difference plate according to claim 2, which is disposed between at least one pair of the plurality of optically anisotropic layers,
wherein rotation directions of orientations of optical axes in the two adjacent optically anisotropic layers are opposite to each other,
the first wavelength region includes a wavelength longer than a wavelength in the second wavelength range,
the wavelength selective phase difference plate converts circularly polarized light in the first wavelength range into circularly polarized light having an opposite turning direction and does not change a phase of circularly polarized light in the second wavelength range, and
in a case where a length over which the orientation of the optical axis rotates by 180° in the one direction in which the orientation of the optical axis changes while continuously rotating in the liquid crystal alignment pattern is set as a single period, at least one of the optically anisotropic layers has a length of the single period different from lengths of the single periods of the other optically anisotropic layers.

8. An optical element comprising:
a plurality of optically anisotropic layers which are formed of a composition containing a liquid crystal compound and have a liquid crystal alignment pattern in which an orientation of an optical axis derived from the liquid crystal compound changes while continuously rotating in at least one in-plane direction; and
the wavelength selective phase difference plate according to claim 3, which is disposed between at least one pair of the plurality of optically anisotropic layers,
wherein rotation directions of orientations of optical axes in the two adjacent optically anisotropic layers are opposite to each other,
the first wavelength region includes a wavelength longer than a wavelength in the second wavelength range,
the wavelength selective phase difference plate converts circularly polarized light in the first wavelength range into circularly polarized light having an opposite turning direction and does not change a phase of circularly polarized light in the second wavelength range, and
in a case where a length over which the orientation of the optical axis rotates by 180° in the one direction in which the orientation of the optical axis changes while continuously rotating in the liquid crystal alignment pattern is set as a single period, at least one of the optically anisotropic layers has a length of the single period different from lengths of the single periods of the other optically anisotropic layers.

9. An optical element comprising:
a plurality of optically anisotropic layers which are formed of a composition containing a liquid crystal compound and have a liquid crystal alignment pattern in which an orientation of an optical axis derived from the liquid crystal compound changes while continuously rotating in at least one in-plane direction; and
the wavelength selective phase difference plate according to claim 4, which is disposed between at least one pair of the plurality of optically anisotropic layers,
wherein rotation directions of orientations of optical axes in the two adjacent optically anisotropic layers are opposite to each other,
the first wavelength region includes a wavelength longer than a wavelength in the second wavelength range,
the wavelength selective phase difference plate converts circularly polarized light in the first wavelength range into circularly polarized light having an opposite turning direction and does not change a phase of circularly polarized light in the second wavelength range, and
in a case where a length over which the orientation of the optical axis rotates by 180° in the one direction in which the orientation of the optical axis changes while continuously rotating in the liquid crystal alignment pattern is set as a single period, at least one of the optically anisotropic layers has a length of the single period different from lengths of the single periods of the other optically anisotropic layers.
